(19) United States
(12) Patent Application Publication
(10) Pub. No.: US 2026/0088620 A1
(43) Pub. Date: Mar. 26, 2026

(54) System for producing clean hydrogen and clean hydrogen derived products using water electrolysis and time correlated renewable power

(71) Applicant: Infinium Technology, LLC, Sacramento, CA (US)

(72) Inventors: Robert Schuetzle, Sacramento, CA (US); Ayesha Choudhury, Westport, CT (US); Elizabeth Myers, Sacramento, CA (US); Solmon Dikran, Sacramento, CA (US); Lacey Trelfa, Anaheim, CA (US)

(21) Appl. No.: 18/831,221

(22) Filed: Sep. 25, 2024

(51) Int. Cl. H02J 3/00; C25B 15/02; G06Q 30/0283; G06Q 50/06

(52) U.S. Cl. CPC H02J 3/004; C25B 15/02; G06Q 30/0283; G06Q 50/06

(57) ABSTRACT

A system for producing clean hydrogen and clean hydrogen derived products using water electrolysis and time correlated renewable power whereby the operation of the electrolysis is optimized for using time correlated renewable power amongst other factors. The system includes a hydrogen production unit that uses an electrolyzer to produce hydrogen from water and electricity, where the electricity is delivered via a connection to the electrical grid and/or behind the meter renewables and whereby a control unit manages the production of hydrogen based on the attributes of the renewable power, including time correlation and other factors. The hydrogen produced from time correlated renewables may be used directly to decarbonize industrial, transportation, or other applications or the hydrogen may be used to produce hydrogen derived products such as ammonia, methanol, transportation fuels (such as sustainable aviation fuel (SAF), diesel, gasoline), LPG, chemicals, or other low carbon products that use hydrogen as an input for the production process.

### FIELD OF THE INVENTION

The present invention provides a system for producing clean or green hydrogen and clean or green hydrogen derived products using electrolysis that is optimized for using time correlated renewable power. The system includes a hydrogen production unit that uses an electrolyzer to produce hydrogen from water and electricity, where the electricity is delivered via a connection to the electrical grid and/or behind the meter renewables and/or via a battery and whereby a control unit manages the production of hydrogen based on the attributes of the renewable power or selects the renewable power to be used based on attributes of the renewable power, including time correlation and other factors. The hydrogen produced from time correlated renewables may be used directly to decarbonize industrial, transportation, or other applications or the hydrogen may be used to produce hydrogen derived products such as ammonia, methanol, transportation fuels such as sustainable aviation fuel (SAF), diesel, gasoline, LPG, chemicals, or other low carbon products that use hydrogen as a feedstock or as an input to the production process.

### BACKGROUND OF THE INVENTION

The United States Inflation Reduction Act (IRA) of 2022 offers significant benefits to produce hydrogen in the United States. One of the major advantages is that the act provides subsidies and tax credits for companies engaged in hydrogen production when the hydrogen production meets certain criteria that demonstrate that the produced hydrogen meets stringent environmental standards.

The US IRA requires temporal matching of renewable power used to generate the clean hydrogen in order to achieve this credit and currently the requirements for the Energy Attribute Certificates (EACs) that are used to demonstrate the time of the hydrogen generation includes temporal matching which may range between one hour and one year, where shorter or longer periods may also apply in the future. Temporal matching (T_{diff}) is defined as the time difference between when the renewable energy is produced and the time when the hydrogen production unit uses this renewable energy, contracted through EACs, for clean hydrogen production. In addition to temporal attributes, EAC may also have attributes that represent the geography where the electricity was generated (i.e. by a specific zone or source).

The hydrogen producer must acquire and retire a qualifying EAC for each unit of electricity used in the electrolysis system in order to qualify for the PTC. A qualifying EAC may be grid connected, direct connected, behind the meter power, or co-located with the hydrogen production facility (that is regardless of whether the underlying source of the qualifying EAC physically supplies electricity through a direct connection to the hydrogen production facility). The qualifying EAC may also come from a behind the meter battery that was physically charged with renewable power or a battery that is front of meter (not directly connected to the hydrogen production facility) also that will be contractually charged with renewable energy. Types of batteries may include lithium ion, lead acid, sodium sulfur, flow batteries, zinc air, nickel iron, solid state, thermal energy storage batteries, or other types of commercially available or emerging battery technologies.

The qualifying EAC must meet certain requirements including incrementality/additionality, temporal matching, and geographical location/deliverability.

The additionality requirement requires the qualifying EACs to represent incremental source electricity, such as electricity from an electricity generating facility that has recently been constructed.

The deliverability requirement requires that qualifying EACs represent electricity that was produced by an electricity generating facility that is in the same region or electricity balancing zone as the relevant hydrogen production facility.

In addition to the US IRA credits for clean hydrogen production, other jurisdictions including United Kingdom (UK) and the European Union (EU) have implemented similarly robust regulations to promote and advance clean hydrogen and clean hydrogen derived products.

The United Kingdom's Renewable Transport Fuel Obligation (RTFO) program and newer program focused on sustainable aviation fuel (SAF) are designed to promote the use of sustainable and environmentally friendly renewable fuels in the transportation sector. The RTFO program and Jet Zero strategy for production and use of Sustainable Aviation Fuel (SAF), incorporated here for reference, set targets for the amount of renewable fuels that fuel suppliers must blend into their transportation fuel products.

Under the RTFO and SAF programs, fuel suppliers who supply more than a certain volume of fossil fuel in the UK per year are obligated to meet a certain percentage of their total fuel sales with renewable fuels, which also include eFuels, or fuels produced from clean hydrogen and waste carbon dioxide.

To qualify as a renewable fuel and contribute towards meeting the RTFO or SAF targets, the renewable energy used for the hydrogen production must also have temporal matching. Like the US IRA 45V program, the RTFO and SAF temporal matching requirements for eFuels state the generation of renewable energy corresponds with the time of consumption. In addition to temporal matching, the renewable power must also meet certain other requirements including additionality and regionality.

In addition to the UK and US programs, the European Union (EU) has been actively implementing the Renewable Fuels of Non-Biological Origin (RFNBOs) or eFuels program as part of its sustainable energy strategy. This program focuses on the production and utilization of eFuels, which are synthetic fuels derived from renewable energy sources. To ensure the effectiveness and environmental benefits of eFuels, there are specific requirements for temporal matching in the EU programs for use of renewable power used in their production. Delegated acts related to RFNBOs (renewable fuels of non-biological origin) are attached as Appendix F.

The EU program recognizes the importance of utilizing excess renewable energy generated during periods of high production but low demand. This surplus energy, which would otherwise be curtailed or wasted, can be harnessed for eFuels production, making the process more economically feasible and environmentally friendly. This energy storage concept helps to store intermittent renewable energy and convert it into high-quality eFuels.

### BRIEF SUMMARY OF THE INVENTION

In some embodiments, the present disclosure is directed to a system for producing hydrogen using electrolysis. The system may include an electrolysis unit configured to receive electricity from a power grid which may be supplied by renewably power projects. The system may further include a data processing unit configured to determine a time correlation (T_{diff}) wherein T_{diff} is the difference in time between when renewable power is produced and when renewable power is used to generate hydrogen. The system may further include a control unit configured to determine the amount of hydrogen to be generated by the electrolysis unit, based on the calculation of at least T_{diff}, wherein T_{diff} is equal to or less than one hour, equal to or less than one day, equal to or less than one week, equal to or less than one month, equal to or less than one quarter, equal to or less than one year, or equal to or less than ten years.

In some embodiments, the system may further determine regionality, where renewable power projects are in the same region as the electrolysis unit used to produce hydrogen.

In some embodiments, the system may further determine temporality, where the difference in the commercial operations date of a renewable power project and the commercial operations date of the electrolysis unit is equal to or less than three years.

In some embodiments, a control unit may determine the amount of hydrogen to be generated by the electrolysis unit based on T_{diff} and one or more of: the availability of electricity, the price of electricity, the location of electricity generation, the type of electricity generation, and the carbon footprint of electricity.

In some embodiments, a control unit may adjust the operation of the electrolysis unit to produce hydrogen during periods of excess renewable electricity supply.

In some embodiments, a control unit may adjust the operation of the electrolysis unit to maximize available incentives.

In some embodiments, the available incentive may come from US IRA hydrogen PTC, the UK RTFO, or the EU RFNBO or its successors and programs in other jurisdictions defining green hydrogen production with similar metrics.

In some embodiments, hydrogen produced by the electrolysis unit may be used to produce eFuels.

In some embodiments, hydrogen produced by the electrolysis unit may be used in transportation, power, chemicals, power generation, plastics, or decarbonization.

In some embodiments, a control unit may maximize profit by calculating the net electricity cost as a function of T_{diff}, incentives, and the price of electricity.

In some embodiments, purchased or generated electricity may be stored in an electricity storage unit.

In some embodiments, a control unit may purchase more electricity than is needed by the system, or it may suggest purchasing more electricity than is needed by the system based on net electricity cost thresholds.

In some embodiments, the present disclosure is directed to a system for producing hydrogen for electrolysis. The system may include an electrolysis unit configured to receive electricity from a power grid which may be supplied by renewably power projects. The system may further include a data processing unit configured to determine a time correlation (T_{diff}) wherein T_{diff} is the difference in time between when renewable power is produced and when renewable power is used to generate hydrogen. The system may further include a control unit configured to select or suggest the electricity be supplied to the electrolysis unit, based on the calculation of at least T_{diff}, wherein T_{diff} is equal to or less than one hour, equal to or less than one day, equal to or less than one week, equal to or less than one month, equal to or less than one quarter, equal to or less than one year, or equal to or less than ten years.

In some embodiments, the system may further determine regionality, where renewable power projects are in the same region as the electrolysis unit used to produce hydrogen.

In some embodiments, the system may further determine temporality, where the difference in the commercial operations date of a renewable power project and the commercial operations date of the electrolysis unit is equal to or less than three years

In some embodiments, a control unit may select renewable power based on T_{diff} and one or more of: the availability of electricity, the price of electricity, the location of electricity generation, the type of electricity generation, and the carbon footprint of electricity.

In some embodiments, a control unit may adjust the operation of the electrolysis unit to produce hydrogen during periods of excess renewable electricity supply.

In some embodiments, a control unit may adjust the operation of the electrolysis unit to maximize available incentives.

In some embodiments, the available incentive may come from US IRA hydrogen PTC, the UK RTFO, or the EU RFNBO or its successors and programs in other jurisdictions defining green hydrogen production with similar metrics.

In some embodiments, hydrogen produced by the electrolysis unit may be used to produce eFuels.

In some embodiments, hydrogen produced by the electrolysis unit may be used in transportation, power, chemicals, power generation, plastics, or decarbonization.

In some embodiments, a control unit may maximize profit by calculating the net electricity cost as a function of T_{diff}, incentives, and the price of electricity.

In some embodiments, purchased or generated electricity may be stored in an electricity storage unit.

In some embodiments, a control unit may purchase more electricity than is needed by the system, or it may suggest purchasing more electricity than is needed by the system based on net electricity cost thresholds.

In some embodiments, the present disclosure is directed to a system for producing time-correlated clean hydrogen. The system may include an electrolysis unit such as a Proton Exchange Membrane electrolysis unit, an Alkaline electrolysis unit, a Solid Oxide Electrolysis Cell unit or an Anion Exchange Membrane unit. The system may further be connected to a power grid, a renewable energy generation unit, or a battery storage unit to supply power to the electrolysis unit. The power grid may be a microgrid, a wide area synchronous grid or a super grid. The renewable energy may be a wind power generation unit, a solar power generation unit, a hydropower generation unit, a geothermal generation unit or a biomass power generation unit. The system may further include a hydrogen conversion unit connected to the electrolysis unit, where the conversion unit may produce diesel, SAF, naphtha, LPG, methanol, other hydrocarbon-based chemicals, or ammonia. The system may further include a data processing unit and connected control unit. The control unit may operate the electrolysis unit based on the calculation of T_{diff} by the data processing unit, wherein T_{diff} is equal to or less than one hour, equal to or less than one day, equal to or less than one week, equal to or less than one month, equal to or less than one quarter, equal to or less than one year, or equal to or less than ten years.

The system (which includes all elements of producing the clean hydrogen or clean hydrogen derived products, from the renewable power production, the grid, hydrogen production unit, electrolysis, DPU, energy or hydrogen storage and any and all other required infrastructure) wherein T_{diff} is the difference in time between when renewable power is produced and when renewable power is used to produce hydrogen; wherein T_{diff} is equal to or less than one hour, equal to or less than one day, equal to or less than one week, equal to or less than one month, equal to or less than one quarter, equal to or less than one year, or equal to or less than ten years.

The system wherein another attribute of the power is the geographical location of the renewable power project and the attribute compares the geographical location of the renewable power project with the location of the hydrogen generation unit to ensure that they are in the same power bidding zone, area, or region and as to meet deliverability/geographical requirements.

The system wherein another attribute of the power is the commercial operations date (COD) being within five years, three years, one year, or occurs after the COD of the hydrogen generation unit and electrolyzer and/or any process that is using the clean hydrogen to produce products such as eFuels, ammonia, methanol, LPG, chemicals or other clean hydrogen derived products.

The system wherein the DPU or control unit selects the renewable power projects based on T_{diff} and one or more of: the availability of electricity, the time of the electricity production, the price of electricity, the location of electricity generation, the type of electricity generation, and the carbon footprint of electricity. These attributes are inputs to the data processing unit that makes decisions based on these attributes. The system wherein the data processing unit determines the time correlation (T_{diff}) by analyzing historical data of the supply and demand of electricity from the selected renewable power projects and these attributes are further inputs to the data processing unit.

The system wherein the data processing unit determines the time correlation (T_{diff}) by analyzing bidding data published by renewable power projects or by generation data reported by low-carbon power projects or by renewable power brokers and/or wherein the data processing unit determines the time correlation (T_{diff}) by analyzing current price data published by renewable power projects or by renewable power brokers. This information constitutes further inputs to the data processing unit.

The system wherein the data processing unit stores the determined time correlation (T_{diff}) in a database accessible by the control unit and uses this information as further inputs to the data processing unit.

The system wherein the control unit adjusts the operation of the electrolysis unit based on the determined time correlation (T_{diff}) to produce hydrogen during periods of excess renewable electricity supply.

The system wherein the control unit accesses the renewable power based on the time correlation (T_{diff}) and/or other renewable power attributes such as geography, COD completion date, or others in order to maximize incentives; wherein the incentives are US IRA hydrogen PTC; UK RTFO; EU RFNBO; and/or other clean hydrogen production or low carbon fuel programs wherein the hydrogen or hydrogen derived products are used in transportation, power, or decarbonization of products or supply chains.

The system wherein the control unit maximizes incentives by minimizing T_{diff}; wherein the control unit maximizes profit by calculating the net electricity cost as a function of T_{diff} incentives and the price of electricity; wherein the control unit adjusts the amount of electricity available to the electrolysis unit based on net electricity cost thresholds.

The system further comprising an electricity storage unit configured to store the purchased electricity; wherein the electricity storage unit comprises at least one of a battery, a; supercapacitor (e.g., electrostatic double-layer capacitors, pseudo-capacitors, hybrid capacitors), a kinetic energy storage system, and a heat energy storage system; a hydrogen storage unit configured to store the produced hydrogen; wherein said hydrogen storage unit configured to store the produced hydrogen in a sorbent or as a liquid organic hydrogen carrier (LOHC); wherein said hydrogen storage unit is configured to store the produced hydrogen in a pressurized tank; wherein stored produced hydrogen is converted into larger organic molecules when the net electrolysis unit electricity costs rise above a threshold. By implementing this strategy, the overall output of downstream products can be maintained, ensuring consistent supply and minimizing disruptions caused by fluctuating production costs.

The system wherein the electrolysis unit sends produced hydrogen to produce methane, ethane, ethylene, propane, propylene, methanol, ammonia, as a hydrogen storage material; wherein said hydrogen storage material is converted into other low carbon products when electrolysis unit electricity costs rise above a threshold.

The system further comprising a hydrogen dispensing unit configured to dispense the stored hydrogen for use in fuel cell applications; wherein the electrolysis unit comprises a proton exchange membrane electrolysis unit; wherein the renewable power projects comprise wind, solar, hydro, nuclear, biomass, geothermal, tidal, thermal, or other suitable renewable, low carbon, or clean power projects; wherein the control unit selects the renewable power projects based on their geographical proximity to the electrolysis unit.

The system wherein the control unit over-contracts or suggests over-contracting renewable power purchases based on net electricity cost thresholds in order to meet higher temporal matching.

The system wherein the control unit selects the renewable power projects based in the same bidding zone, area, or region as the electrolysis unit. The system wherein the control unit selects the renewable power projects based on their additionality as power sources relative to the electrolysis unit. The system wherein the control unit selects the renewable power projects based on their additionality as power sources relative to the electrolysis unit; based in the same bidding zone, area, or region as the electrolysis unit; and based on meeting T_{diff} requirements.

The system for producing hydrogen using electrolysis, comprising: an electrolysis unit configured to demand electricity from a power grid supply; a data processing unit configured to determine a time correlation (T_{diff}) between the supply of electricity from incentive eligible renewable power supplies and the demand for electricity from the electrolysis unit, and then calculating the value of incentives based at least on T_{diff} and the available electrolysis power demand and the available incentive eligible renewable power supplies, and then calculate the net electricity cost; and a control unit configured to purchase electricity when the net electricity cost calculated by the data processing unit is below a set threshold; wherein purchasing electricity comprises bidding to purchase electricity from renewable power projects or from renewable power brokers; wherein excess purchased electricity is stored in batteries, in capacitors, as heat, and/or in the form of excess produced and stored hydrogen.

The system wherein the control unit over-contracts or suggests over-contracting renewable power purchases based on net electricity cost thresholds. The system wherein the control unit selects the renewable power projects based in the same bidding zone, area, or region as the electrolysis unit. The system wherein the control unit selects the renewable power projects based on their additionality as power sources relative to the electrolysis unit. The system wherein the control unit selects the renewable power projects based on their additionality as power sources relative to the electrolysis unit; based in the same bidding zone, area, or region as the electrolysis unit; and based on meeting T_{diff} requirements.

The system for producing hydrogen using electrolysis, comprising: an electrolysis unit configured to demand electricity from a power grid supply; a data processing unit configured to determine a time correlation (T_{diff}) between the supply of electricity from incentive eligible renewable power supplies and the demand for electricity from the electrolysis unit, and then calculate the value of incentives based at least on T_{diff} and the available incentive eligible renewable power supplies, and then calculate the net electricity cost; and a control unit configured to purchase, or suggest purchasing, electricity when the net electricity cost calculated by the data processing unit is below at least one price threshold, wherein the electrolysis unit is underpowered when sufficient electricity cannot be purchased at a net electricity cost below the price threshold; and wherein the electrolysis unit is fully powered when sufficient electricity can be purchased at a net electricity cost below the price threshold; and wherein the electrolysis unit is fully powered, and excess electricity is stored, when excess electricity can be purchased at a net electricity cost below the price threshold.

The system wherein purchasing electricity comprises bidding to purchase electricity from renewable power projects or from renewable power brokers; wherein excess electricity is stored in batteries, in capacitors, as heat, and/or in the form of excess produced and stored hydrogen wherein enough hydrogen is stored to provide the desired quantity of hydrogen to downstream chemical processes; and/or wherein the at least one price threshold comprises at least a fully powered price threshold and an excess electricity price threshold, each having a different value.

The system wherein purchasing electricity comprises bidding to purchase electricity from renewable power projects that have power, EACs/RECs, or other renewable contracts available that maximize incentives based on one or more attributes of the power including temporal matching, COD date, geographic location.

The system wherein the control unit over-contracts, defined as purchasing more from the grid or behind the meter than the nameplate capacity required for clean hydrogen generation and therefore selling any power in excess of the electrolysis equipment needs to the market, or suggests over-contracting renewable power purchases based on net electricity cost thresholds. The system wherein the control unit selects the renewable power projects based in the same bidding zone, area, or region as the electrolysis unit. The system wherein the control unit selects the renewable power projects based on their additionality as power sources relative to the electrolysis unit. The system wherein the control unit selects the renewable power projects based on their additionality as power sources relative to the electrolysis unit; based in the same bidding zone, area, or region as the electrolysis unit; and based on meeting T_{diff} requirements.

The system wherein purchasing and storing renewable energy in excess of the direct need of the hydrogen production unit or when pricing of stored renewable energy is economically advantageous over the production of the clean hydrogen, the DUC system determines to sell back electricity to the grid or other customers.

### BRIEF DESCRIPTION OF THE DRAWINGS

FIG. 1 is a block diagram showing a system 100 for producing green hydrogen using electrolysis.

FIG. 2 is a block diagram showing a system 200 for producing green hydrogen using electrolysis.

FIG. 3 is a block diagram showing a system 300 for producing green hydrogen using electrolysis.

### DETAILED DESCRIPTION OF THE INVENTION

A system for producing green hydrogen that works to optimize incentives by choosing to use time correlated renewable power is needed and is herein described.

Renewable power or renewable energy or low carbon power or low carbon energy, refer to energy sources that are naturally replenished and may be derived from sunlight, wind, water flow, geothermal heat, biomass, or nuclear power. Renewable power is an important aspect of sustainable development and climate change mitigation, as it provides a cleaner and more environmentally friendly alternative to traditional fossil fuels. Unlike fossil fuels, which are finite and contribute to global warming and air pollution, renewable power sources emit little to no greenhouse gases during operation. The utilization of renewable power involves converting the energy from these resources into various forms that can be used for electricity generation, heating, cooling, and transportation. This conversion process typically involves the use of technologies, such as solar panels to capture sunlight and convert it into electricity or wind turbines to harness wind energy.

The electrical grid, also known as the power grid or electricity grid, refers to the interconnected network of transmission lines, substations, transformers, and generating stations that facilitate the distribution and transmission of electricity from power generators to end-users. The electrical grid connects the renewable power source to the hydrogen generation unit and enables delivery of power as well as the environmental attributes, which may be represented as Energy Attribute Certificates (EACs), Renewable Energy Credits (RECs) or other forms or standards used in the industry to contract for renewable power.

The electrical grid is typically divided into three main components: generation, transmission, and distribution. Generation refers to the production of electricity at power plants using various energy sources such as hydroelectric power, solar, wind, nuclear, other. Once generated, electricity is transmitted at high voltages over long distances through transmission lines to substations, where the voltage is reduced for distribution through lower-voltage power lines. The distribution system delivers electricity to end-users, which in the case of hydrogen production is an industrial user. The electrical grid is regulated and managed by electric utility companies and system operators, who work together to ensure a reliable and stable supply of electricity. They monitor and control the flow of electricity, manage power generation, and respond to fluctuations in demand to maintain grid stability. With the increasing adoption of renewable energy sources and advancements in technologies like smart grids, the electrical grid is evolving to become more sustainable, efficient, and resilient. Smart grid technologies integrate digital communication and advanced sensing capabilities to optimize energy distribution, manage peak demand, and support the integration of renewable energy sources into the grid. Types of grids include microgrids, a wide area synchronous grids, super grids, or other types of grid configurations that may be used to deliver power.

Behind-the-meter power refers to electricity that is generated or consumed directly by a source which may or may not have a connection to feed into the grid. It refers to power generation and usage that occurs on the customer's side of the electric meter. This includes any electricity generation facilities, such as on-site renewable energy systems or backup generators, that are installed and operated by the customer to meet their own energy demands. The term “behind-the-meter” implies that these power generation systems are directly connected to the customer's electrical distribution system, providing them with energy independence and potentially reducing their reliance on the utility grid.

A hydrogen generation unit may use behind the meter power systems, including battery storage, or grid connection or a combination of these two to deliver power to the unit for clean hydrogen production.

The green hydrogen production unit includes use of an electrolyzer, where water and renewable energy are used to produce hydrogen and oxygen. Water is fed to the electrolyzer which is powered by renewable electricity.

The data processing unit (DPU) or control unit is a vital component in the effective control and operation of the hydrogen generation unit, including the electrolyzer. The primary function of the DPU is to collect, analyze, and interpret data from various sensors and external and internal inputs, and then provide precise control signals to regulate the electrolyzer's performance as well as any auxiliary equipment required to run the electrolyzer which may include cooling systems, fluid circulation systems, compression systems, power distribution systems, gas purification systems, and other sub-systems enabling safe and efficient operation.

Based on the analyzed data, the DPU can dynamically adjust the voltage and current supplied to the electrolyzer and can control the supporting systems required to keep the electrolyzer operating, ensuring optimal operating conditions. The DPU also monitors the electrolyzer's performance and can detect any deviations or abnormalities. In such cases, the DPU is programmed to trigger alerts or shut down the electrolyzer automatically to respond to the inputs.

Furthermore, the DPU enables communication and integration with other systems, such as a supervisory control and data acquisition (SCADA) system. This allows for centralized monitoring and control of multiple electrolyzers in a large-scale industrial setting. The DPU also facilitates data logging and storage, enabling historical analysis and performance evaluation.

The DPU acts as the brain of the electrolyzer, efficiently processing data from various sensors and providing accurate control signals to maintain optimal performance. Its ability to analyze data in real-time and adjust electrolysis parameters makes it a critical component in maximizing efficiency, ensuring safety, and optimizing the overall performance of the electrolyzer system.

The DPU in the hydrogen production unit uses attribute information from EACs, RECs, or other information provided about the renewable power being used by the hydrogen production unit which may monitor and record (1) the time when the power was generated (to meet temporal matching requirements), (2) a commercial operations date (to meet additionality requirements), (3) the location of the renewable power project (to meet deliverability/geographical location requirements), (4) price information, (5) type of generation (solar/wind/etc.) and (6) other information required to operate the electrolysis unit efficiently (“attributes of renewable power”).

Importantly, the DPU uses the temporal attributes of the renewable power which is the time when the power was generated and this attribute is used to determine a time correlation (T_{diff}) between the supply and demand of electricity from selected renewable power projects and/or storage assets, including both the grid connected power and/or storage and, if available, the direct connected (behind the meter) power and/or storage; and the control unit is configured to select the electricity to be supplied to the electrolysis unit, based on the calculation of at least T_{diff}.

Heat energy storage systems may be advantageous to use with electrolysis. A heat energy storage system using refractory bricks functions by storing thermal energy in the bricks when they are heated and releasing it when needed. Refractory bricks are highly durable and have excellent insulating properties, making them ideal for retaining heat over an extended period.

Initially, the refractory bricks are heated using an external heat source such as a furnace or concentrated solar power system or electric heaters. As the bricks absorb heat, their temperature rises and the thermal energy is stored within the bricks' structure. These bricks are designed to have high thermal conductivity to facilitate efficient heat transfer.

Once the bricks have reached the desired temperature, the external heat source can be turned off, and the heat energy is effectively stored within the bricks. The refractory bricks act as a reservoir, capable of maintaining elevated temperatures for prolonged periods due to their low thermal conductivity. This allows the system to store large amounts of heat energy for later use.

When heat is required, the stored energy can be released by transferring it from the heated bricks to the surrounding medium via conduction. This can be achieved by placing a heat exchange medium in contact with the heated bricks. The heat exchange medium may be a connected to a heat transfer fluid, which carries the released heat energy to a desired application, such as space heating, hot water generation, or industrial processes. The heat exchange medium can also be used to generate steam, which can then be used to produce power.

In this way, the heat energy storage system using refractory bricks provides an efficient and reliable method for storing and utilizing thermal energy. It offers a sustainable and economic alternative to traditional energy storage systems, enabling the utilization of excess heat generated during periods of low energy demand.

Another form of energy storage that can be used with electrolysis are grid scale battery systems. Batteries play a crucial role in storing renewable power at grid scale capacity, addressing one of the key challenges of renewable energy sources-their intermittency. By capturing and storing excess energy generated from renewable sources during periods of low demand, batteries enable the availability of electricity during times of high demand or when renewable energy generation is limited.

At grid scale capacity, batteries are designed to store large amounts of energy. These batteries, often referred to as energy storage systems or battery storage systems, consist of numerous individual battery cells connected together. These cells utilize chemical reactions to convert electrical energy into chemical potential energy, allowing for storage until required.

When renewable energy sources such as wind or solar produce more energy than is immediately demanded by the grid, the excess energy is used to charge the battery storage system. This stored energy can then be discharged back into the grid when demand exceeds supply. The discharge process allows for the conversion of the chemical potential energy back into electrical energy, providing a seamless and reliable power supply.

The use of batteries for grid-scale energy storage offers several advantages. Firstly, it helps to reduce reliance on traditional fossil fuel-based power plants, promoting the integration of clean and renewable energy sources into the grid. Secondly, it enhances grid stability by balancing fluctuations in supply and demand, minimizing the risk of blackouts or grid failures. Additionally, battery storage systems can provide ancillary services to the grid, such as frequency regulation and voltage support, further improving the overall performance and reliability of the electricity network.

All forms of energy storage, including batteries and heat energy storage, can help to achieve higher temporal matching since the power can be stored during times of excess renewable generation, and used when temporal matching is required during low renewable generation therefore improving the percentage of temporally matched power.

The present invention provides a system for producing hydrogen using electrolysis that is optimized for time correlated renewable energy sources and may also use other attributes of the renewable power to optimize production. The system includes a hydrogen production unit that is connected to the grid and a control unit that manages the production of hydrogen based on the availability of renewable energy.

The control unit monitors the grid for renewable energy sources and selects the renewable energy that achieves the optimum combination of (1) the most cost-effective source of energy based on the time of day and the availability of renewable energy and (2) the renewable energy that provides the highest product value through incentives based on the time correlation between the time of production of the renewable energy and time of consumption by the electrolyzer.

The hydrogen production unit includes an electrolysis unit that is connected to a power source, such as a renewable energy source or the grid.

There are several types of electrolyzers that are commonly used to produce hydrogen from water and electricity. Each electrolyzer utilizes a different electrolyte material and operates under specific conditions to efficiently generate hydrogen gas. The most prevalent types of electrolyzers include Proton Exchange Membrane (PEM) electrolyzers, Alkaline electrolyzers, Solid Oxide Electrolysis Cells (SOEC), Anion Exchange Membrane (AEM) electrolyzers, as well as other emerging technologies.

PEM electrolyzers employ a solid polymer electrolyte, typically made of a Perfluorosulfonic Acid (PFSA) membrane. This membrane selectively permits the passage of protons while blocking other species, such as oxygen and water. PEM electrolyzers are known for their fast response time and high efficiency. They are used in various applications, including small-scale hydrogen production and integrated with renewable energy sources.

Alkaline electrolyzers, on the other hand, use a liquid alkaline electrolyte, typically a solution of potassium hydroxide (KOH) or sodium hydroxide (NaOH). These electrolyzers require a metal catalyst, such as nickel or platinum, to enhance the electrode reactions. Alkaline electrolyzers are known for their long service life and high hydrogen purity. They are commonly used for large-scale hydrogen production due to their robustness and relatively lower costs.

SOECs are solid-state electrolyzers that operate at high temperatures (typically around 700-900° C.). They utilize a dense ceramic oxide electrolyte, such as yttria-stabilized zirconia (YSZ), which conducts oxygen ions at elevated temperatures. SOECs can efficiently generate hydrogen by splitting steam or carbon dioxide with the aid of externally supplied heat. The high temperatures required pose challenges related to material degradation and thermal management but offer the advantage of enabling co-electrolysis, enabling simultaneous production of hydrogen and synthesis gas and or the ability to use steam or heat to enhance the efficiency of the electrolyzer.

AEM electrolyzers feature an anion exchange membrane, which selectively conducts hydroxide ions and prevents other species' migration. These electrolyzers can operate at relatively low temperatures and use non-precious metal catalysts, making them a potentially cost-effective alternative to PEM electrolyzers. AEM electrolyzers are still under active development and hold promise for scalable hydrogen production with improved performance and decreased cost.

In addition to these well-established electrolyzer technologies, there are also emerging electrolyzer types, including Photoelectrochemical (PEC) cells and High-Temperature Polymer Electrolyte Membrane (HT-PEM) electrolyzers. PEC cells utilize semiconductor materials that can directly absorb sunlight to drive the water splitting reaction. HT-PEM electrolyzers operate at temperatures between PEM and SOEC electrolyzers, typically in the range of 100-200° C., and utilize special heat-resistant polymer electrolyte membranes.

The choice of electrolyzer technology depends on factors such as desired hydrogen production capacity, operating conditions, efficiency requirements, and cost considerations.

The hydrogen production unit may also include a storage tank for storing the produced hydrogen. The storage tank can be used to store the hydrogen for later use or to transport the hydrogen to another location. The hydrogen may also be stored in the form of C1-C5 organic molecules. Hydrogen may also be stored as ammonia, methanol, liquid fuels, or other hydrogen energy carriers.

Other forms of hydrogen generation may also be used to produce clean hydrogen and these methods include methane pyrolysis, steam reforming with carbon capture, biomass gasification, renewable natural gas (RNG) reforming or sourcing hydrogen from geological sources where purification of the stream may be required to produce hydrogen for use in a process.

The hydrogen generation unit can be used in a variety of applications, including fuel cells, transportation, and power generation. By optimizing the use of renewable energy sources, the system can produce hydrogen more economically and with a lower environmental impact, and also produce maximum time correlation incentives that may be available.

The control unit manages the production of hydrogen based on the availability of the attributes of the renewable energy. The control unit includes a monitoring system that monitors the grid for renewable energy sources, such as solar or wind power. The monitoring system can also predict the availability of renewable energy based on weather patterns and other factors.

The control unit selects the most cost-effective source of energy based on the time of day and the availability of renewable energy and/or contracts in place for specific renewable assets. In addition, the control unit may choose the most appropriate renewable power that maximizes incentives in one or more incentive markets. For example, if solar power is available and most cost effective during the day, the system can prioritize the use of solar power to produce hydrogen during those respective hours. If wind power is available at night, the system can prioritize the use of wind power to produce hydrogen. The control unit can perform automated purchases, or to display a purchasing suggestion to a human user.

The control unit can also be programmed to prioritize the use of renewable energy sources that are time-correlated with the production of hydrogen. For example, if solar power is available during the day and the demand for hydrogen is highest during the day, the system can prioritize the use of solar power to produce hydrogen.

The production of hydrogen from renewable power sources should take place when there is excess renewable energy available, such as during periods of high wind or solar power generation. The hydrogen produced during these times can then be stored and used when there is a demand for it, such as during periods of low renewable energy generation. Alternatively, the electrolyzer unit may be curtailed or shut down during times of high cost or times when a temporal match does not occur.

Additionally, the control system may purchase more electricity than is needed when electricity is inexpensive. In addition to saving electricity costs, this ensures that renewable power supplies are constantly in demand. Over-contracted, or over purchased power may also be stored for later use.

In one embodiment, the system accesses both wind power (when it is available) and solar power (when it is available) and matches the time between when the power is produced and when it is consumed. The system includes a wind turbine and solar panels that are connected to a power grid. The power generated by the wind turbine and solar panels is used to produce hydrogen through electrolysis. The time between when the power is produced and when it is consumed by the electrolyzer is referred to as the temporal differential (T_{diff}). For example, if the wind power is produced at 1 PM the electrolyzer consumes this power at 2 PM T_{diff} equals one hour. This concept is important since certain incentive programs have requirements around a maximum T_{diff} in order to receive the incentive. In this embodiment, the system maximizes the percentage of time that the system meets the incentive requirements for T_{diff}. In this embodiment, the system access solar power from one or more solar projects located in the same bidding zone, area, or region as the electrolyzer project as well as one or more wind projects in the same bidding zone, area, or region. The system works to maximize the percentage of time that the system is able to achieve incentives by meeting the requirements of T_{diff}.

For example, if T_{diff} must be one hour or less to meet an incentive target and the system is buying power over the grid from two solar projects and two wind projects, the system will get feedback from all four of the renewable projects on when and how much power are being generated. The system will calculate how to maximize the percentage of time that the system will achieve the requirements a one hour temporal matching (T_{diff}) thereby maximizing the incentives that the project receives and also likely drawing the least expensive renewable power available at that time. This system also enables the best environmental benefit as it is incentivizing the use of renewable power with a temporal match over fossil power for producing the hydrogen.

In a second embodiment, the system includes a wind turbine that converts wind energy into electrical energy. The electrical energy generated by the wind turbine is stored or fed directly into the power grid. The system also includes solar panels that convert solar energy into electrical energy. The electrical energy generated by the solar panels is stored or fed directly into the power grid. Some embodiments of electricity storage can be in the form of a battery, a supercapacitor, a kinetic energy storage system, and/or a heat energy storage system.

The system is designed to match the time between when the power is produced and when it is consumed (T_{diff}) for use in the electrolyzer. This is achieved by using a control system that monitors the power generated by the wind turbine and solar panels and either (1) has the electrolyzer use the power directly over the grid or (2) store the power in the batteries for use later by the electrolyzer. The system solves for the highest percentage of match of T_{diff} in order to achieve the highest possible incentives. The system also solves for the net cost of electricity through the day, week, season, or year and then uses T_{diff} and other incentives to calculate the net cost of electricity and the best time to buy. The net cost of electricity is the cost paid for electricity, minus the value of incentives received or expected to be received.

The hydrogen produced is stored for later use or can be used immediately to produce liquid fuels, called low carbon products due to the renewable power used in the process. The hydrogen produced is stored in a pressurized tank, in a sorbent, or as a hydrogen storage material, or as methane, ethane, ethylene, propane, propylene, or a liquid organic hydrogen carrier such as toluene, or another energy carrier. Stored hydrogen is converted into low carbon products when the net electrolysis electricity costs rise above a threshold, or when insufficient electricity is available for electrolysis. In this way, electricity can be used in the most advantageous way, even when low carbon product production is at maximum capacity.

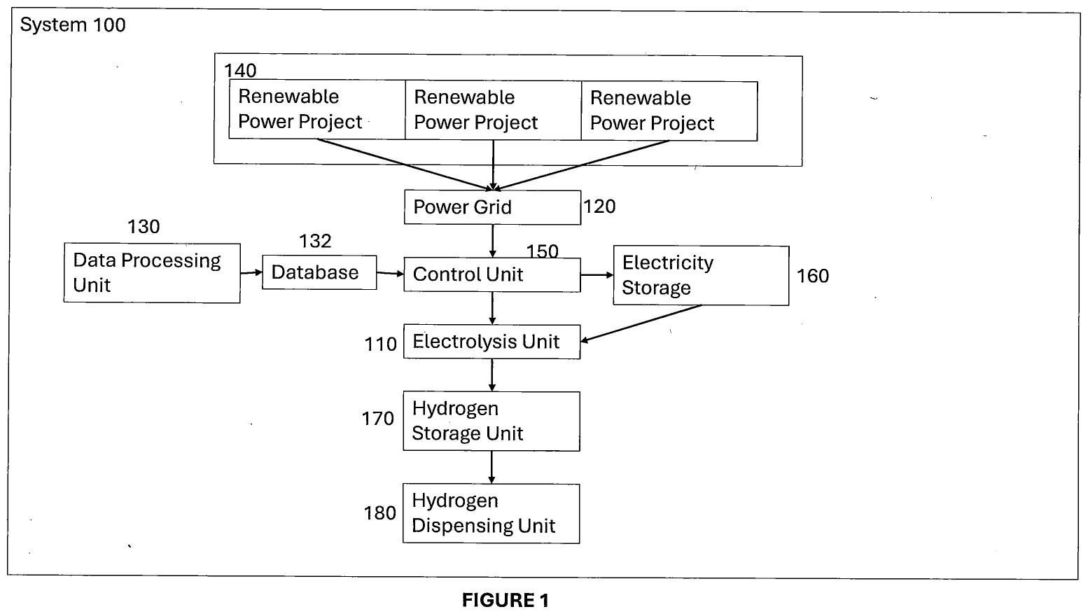

FIG. 1 shows an illustrative block diagram of a system 100 for producing green hydrogen using electrolysis. System 100 includes electrolysis unit 110 configured to receive electricity from power grid 120; renewable power projects 140; data processing unit 130 configured to determine a time correlation (T_{diff}); database 132 configured to store information; control unit 150 configured to select the electricity to be supplied to the electrolysis unit 110, based on the calculation of at least T_{diff}; electricity storage 160; hydrogen storage unit 170; and hydrogen dispensing unit 180.

An embodiment of electrolysis unit 110 may include one of a high-pressure alkaline electrolyzer, a Proton Exchange Membrane (PEM) electrolyzer, a solid oxide electrolyzer, an alkaline exchange membrane (AEM) electrolyzer, a direct methanol fuel cell (DMFC) electrolyzers, or other such electrolyzers that meet the needs of the system.

In some embodiments, renewable power projects 140 may be one or more of wind, solar, hydro, nuclear, biomass, geothermal, tidal, thermal, or other suitable renewable, low carbon, or clean electricity production facility. Renewable power projects 140 are a portion of power grid 120. In some embodiments, power grid 120 may contain electricity produced by non-renewable power projects.

T_{diff} is the difference in time between when renewable power is produced and when renewable power is used to produce hydrogen by electrolysis unit 110. Preferably, T_{diff} is equal to or less than one hour, equal to or less than one day, equal to or less than one week, equal to or less than one month, equal to or less than one quarter, equal to or less than one year, or equal to or less than ten years. Certain T_{diff} thresholds qualify hydrogen producers for electricity cost incentives for using renewable power. These incentives may apply to renewable power projects 140 in the same bidding zone, area, or region as electrolysis unit 110.

In some embodiments, control unit 150 selects one of renewable power projects 140 based on at least T_{diff} and available T_{diff} incentives. Control unit 150 may also select renewable power project 140 based on T_{diff}, available T_{diff} incentives, and one or more of: the availability of electricity, the price of electricity, the location of electricity generation, the type of electricity generation, and the carbon footprint of electricity. The price of electricity can vary by the minute when electricity is purchased, so control unit 150 must be robust enough for precise, fast net cost analysis and purchases. In some embodiments, control unit 150 may select one of renewable power projects 140 based on attributes of the Energy Attribute Certificates (EACs) that are used for the project.

In some embodiments, data processing unit 130 determines the time correlation (T_{diff}) by analyzing historical and forecasted data of the supply and demand of electricity from renewable power projects 140. In another embodiment, data processing unit 130 determines the time correlation (T_{diff}) by analyzing electricity bidding data or current price data published by renewable power projects 140 or by renewable power brokers.

In some embodiments, data processing unit 130 stores the determined time correlation (T_{diff}) in database 132 accessible by control unit 150.

In some embodiments, control unit 150 adjusts the operation of electrolysis unit 110 based on the determined time correlation (T_{diff}) to produce hydrogen during periods of excess renewable electricity supply. Control unit 150 accesses the renewable power based on the time correlation (T_{diff}) in order to maximize incentives; wherein the incentives may be one of US IRA hydrogen PTC, the UK RTFO, or the EU RFNBO or its successors and programs in other jurisdictions defining green hydrogen production with similar metrics. In some embodiments, low carbon fuels such as diesel, gasoline, or sustainable aviation fuel (SAF) are produced from the hydrogen in a hydrogen conversion unit. In some embodiments the hydrogen is used in transportation, power, plastics, or decarbonization.

Low carbon products, such as sustainable aviation fuel, diesel, methanol, ammonia, ethylene, and others, can be produced from green hydrogen through a series of complex processes.

To produce sustainable aviation fuel, green hydrogen undergoes a process called hydrogenation, where it is combined with carbon-bearing feedstocks, such as biomass or carbon dioxide, using catalysts under high pressure and temperature. This process results in the formation of long-chain hydrocarbons, similar to traditional aviation fuel but with significantly lower carbon emissions.

Methanol and ammonia can also be produced from green hydrogen. Methanol is manufactured through a multi-step process, where green hydrogen reacts with carbon monoxide or carbon dioxide, while ammonia is produced by combining green hydrogen with nitrogen gas. Both methanol and ammonia serve as essential feedstocks in various industries, including the chemical, agricultural, and renewable energy sectors.

Green hydrogen can also be used to produce ethylene, propylene or other building blocks for plastics and other chemical products. Direct production of these chemicals is possible or through the production of naphtha and then using steam cracking resulting in the formation of ethylene and other valuable co-products.

In some embodiments control unit 150 maximizes incentives by minimizing T_{diff}, by calculating the net electricity cost as a function of T_{diff}, incentives, and the price of electricity, or by a combination thereof. In some embodiments control unit 150 can adjust the amount of electricity available to electrolysis unit 110 based on net electricity cost thresholds set by the hydrogen producer.

In another embodiment, system 100 further comprises an electricity storage unit 160 configured to store purchased electricity; wherein electricity storage unit 160 comprises at least one of a battery, a supercapacitor, a kinetic energy storage system, a heat energy storage system, or other suitable energy storage device. In some embodiments system 100 further comprises hydrogen storage unit 170 configured to store hydrogen produced by electrolysis unit 110. Hydrogen storage unit 110 may be configured to store produced hydrogen in a sorbent, or as a liquid organic hydrogen carrier (LOHC), or in a pressurized tank. In one embodiment, stored hydrogen in hydrogen storage unit 170 may be converted into larger molecules when the net electrolysis unit electricity costs rise above a threshold where it is not cost preferred to purchase electricity from the grid for hydrogen production.

Control unit 150 may purchase more electricity than is needed from renewable power project 140 when electricity is inexpensive. Excess renewable power can be stored in electricity storage unit 160 to be used later by electrolysis unit 110. Control unit 150 may use electricity in electricity storage unit 160 rather than from renewable power project 140 when electricity prices are high. In some embodiments, control unit 150 adjusts the operation of electrolysis unit 110 to consume electricity from electricity storage unit 160 based on the time correlation (T_{diff}) in order to maximize incentives; wherein the incentives may be one of US IRA hydrogen PTC, the UK RTFO, or the EU RFNBO or its successors and programs in other jurisdictions defining green hydrogen production with similar metrics.

In one embodiment, electrolysis unit 110 sends surplus produced hydrogen to produce methane, ethane, ethylene, propane, and/or propylene as a hydrogen storage material which may be stored in hydrogen storage unit 170. The hydrogen storage material can later be converted into larger molecules, such as low carbon fuels, low carbon chemicals, or other commodity materials, when electricity costs rise above a threshold.

In another embodiment, system 100 further comprises hydrogen dispensing unit 180 configured to dispense hydrogen from hydrogen storage unit 170 for use in fuel cells, production of eFuels or other products, or other applications.

In some embodiments, control unit 150 selects renewable power projects 140 based on their geographical proximity to electrolysis unit 110. Geographical proximity may be determined by metrics including a predetermined distance, zone, region, country, state, or other such measures. In another embodiment, control unit 150 selects renewable power projects 140 based in the same bidding zone, area, or region as electrolysis unit 110.

In some embodiments, control unit 150 selects renewable power projects 140 based on their additionality relative to the electrolysis unit 110.

In some embodiments, control unit 150 selects renewable power projects 140 based on their additionality as power sources relative to electrolysis unit 110; based in the same bidding zone, area, or region as electrolysis unit 110; and based on achieving a predetermined value of T_{diff}.

In some embodiments, control unit 150 selects renewable power projects 140 based on their additionality as power sources relative to electrolysis unit 110, based in the same bidding zone, area, or region as electrolysis unit 110; based on achieving a predetermined value of T_{diff}; and based on economic value of using electrolysis unit 110.

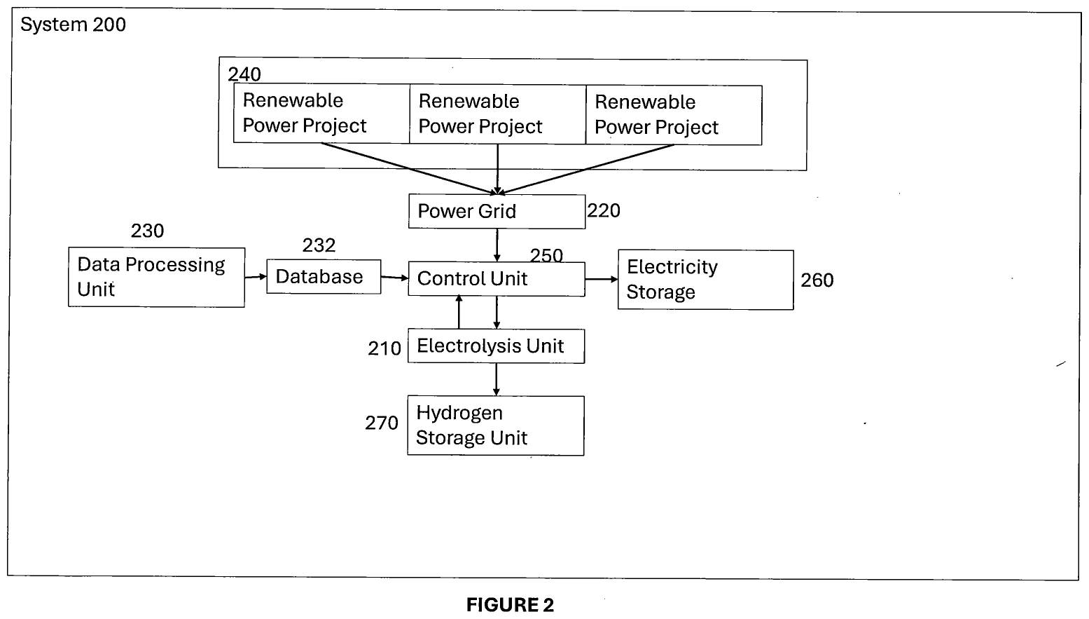

FIG. 2 shows an illustrative block diagram of a system 200 for producing green hydrogen using electrolysis. System 200 includes electrolysis unit 210 configured to demand electricity from power grid 220; renewable power projects 240; data processing unit 230 configured to determine a time correlation (T_{diff}); database 232 configured to store information; control unit 250 configured to purchase electricity based on the calculation of at least Tiff; electricity storage 260; and hydrogen storage unit 270.

An embodiment of electrolysis unit 210 may include one of a high-pressure alkaline electrolyzer, a Proton Exchange Membrane (PEM) electrolyzer, a solid oxide electrolyzer, an alkaline exchange membrane (AEM) electrolyzer, a direct methanol fuel cell (DMFC) electrolyzers, or other such electrolyzers that meet the needs of the system.

In some embodiments, renewable power projects 240 may be one or more of wind, solar, hydro, nuclear, biomass, geothermal, tidal, thermal, or other suitable renewable, low carbon, or clean electricity production facility. Renewable power projects 240 are a portion of power grid 220.

T_{diff} is the difference in time between when renewable power is produced and when renewable power is used to produce hydrogen by electrolysis unit 210. Preferably, T_{diff} is equal to or less than one hour, equal to or less than one day, equal to or less than one week, equal to or less than one month, equal to or less than one quarter, equal to or less than one year, or equal to or less than ten years. Certain T_{diff} thresholds qualify hydrogen producers for electricity cost incentives for using renewable power. These incentives may apply to renewable power projects 240 in the same bidding zone, area, or region as electrolysis unit 210.

In some embodiments, data processing unit 230 determines the time correlation (T_{diff}) by analyzing historical and forecasted data of the supply and demand of electricity from renewable power projects 240. In another embodiment, data processing unit 230 determines the time correlation (T_{diff}) by analyzing electricity bidding data or current price data published by renewable power projects 240 or by renewable power brokers.

In some embodiments, data processing unit 230 determines a net electricity price through a calculation based on at least T_{diff}, power demand from electrolysis unit 210, and available renewable power project 240 that meet incentive requirements.

In some embodiments, data processing unit 230 stores the determined time correlation (T_{diff}) in database 232 accessible by control unit 250.

In some embodiments, control unit 250 purchases electricity when the net electricity price determined by data processing unit 230 is below a set threshold.

In another embodiment, system 200 further comprises an electricity storage unit 260 configured to store purchased electricity; wherein electricity storage unit 260 comprises at least one of a battery, a supercapacitor, a kinetic energy storage system, a heat energy storage system, or other suitable energy storage device. In some embodiments system 200 further comprises hydrogen storage unit 270 configured to store hydrogen produced by electrolysis unit 210. Hydrogen storage unit 210 may be configured to store produced hydrogen in a sorbent, or as a liquid organic hydrogen carrier (LOHC), or in a pressurized tank. In one embodiment, stored hydrogen in hydrogen storage unit 270 may be converted into larger molecules when the net electrolysis unit electricity costs rise above a threshold where it is not cost preferred to purchase electricity from the grid for hydrogen production.

In some embodiments, control unit 250 may purchase excess electricity when the net electricity price determined by data processing unit is below a set threshold. Excess renewable power can be stored in electricity storage unit 260 to be used later by electrolysis unit 210.

In one embodiment, electrolysis unit 210 sends surplus produced hydrogen to produce methane, ethane, ethylene, propane, and/or propylene as a hydrogen storage material which may be stored in hydrogen storage unit 270. The hydrogen storage material can later be converted into larger molecules, such as low carbon fuels, low carbon chemicals, or other commodity materials, when electricity costs rise above a threshold.

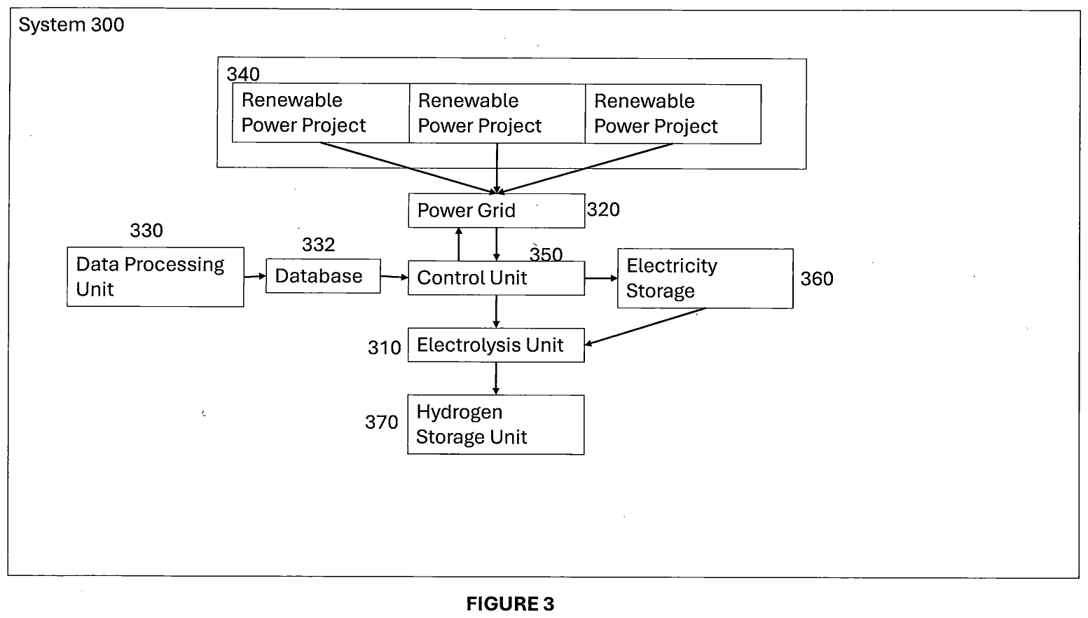

FIG. 3 shows an illustrative block diagram of a system 300 for producing green hydrogen using electrolysis. System 300 includes electrolysis unit 310 configured to demand electricity from power grid 320; renewable power projects 340; data processing unit 330 configured to determine a time correlation (T_{diff}), incentives based on at least T_{diff}, and net electricity price; database 332 configured to store information; control unit 350 configured to purchase electricity when net electricity price is below at least one price threshold; electricity storage 360; and hydrogen storage unit 370.

An embodiment of electrolysis unit 310 may include one of a high-pressure alkaline electrolyzer, a Proton Exchange Membrane (PEM) electrolyzer, a solid oxide electrolyzer, an alkaline exchange membrane (AEM) electrolyzer, a direct methanol fuel cell (DMFC) electrolyzers, or other such electrolyzers that meet the needs of the system.

In some embodiments, renewable power projects 340 may be one or more of wind, solar, hydro, nuclear, biomass, geothermal, tidal, thermal, or other suitable renewable, low carbon, or clean electricity production facility. Renewable power projects 340 are a portion of power grid 320.

T_{diff} is the difference in time between when renewable power is produced and when renewable power is used to produce hydrogen by electrolysis unit 310. Preferably, T_{diff} is equal to or less than one hour, equal to or less than one day, equal to or less than one week, equal to or less than one month, equal to or less than one quarter, equal to or less than one year, or equal to or less than ten years. Certain T_{diff} thresholds qualify hydrogen producers for electricity cost incentives for using renewable power. These incentives may apply to renewable power projects 340 in the same bidding zone, area, or region as electrolysis unit 310.

In some embodiments, data processing unit 330 determines the time correlation (T_{diff}) by analyzing historical and forecasted data of the supply and demand of electricity from renewable power projects 340. In another embodiment, data processing unit 330 determines the time correlation (T_{diff}) by analyzing electricity bidding data or current price data published by renewable power projects 340 or by renewable power brokers.

In some embodiments, data processing unit 330 determines a net electricity price through a calculation based on at least T_{diff}, power demand from electrolysis unit 310, and available renewable power project 340 that meet incentive requirements.

In some embodiments, data processing unit 330 stores the determined time correlation (T_{diff}) and or the net electricity price in database 332 accessible by control unit 350.

In some embodiments, control unit 350 purchases electricity from a renewable power project 340 when the net electricity price determined by data processing unit 330 is below a set threshold.

In some embodiments, electrolysis unit 310 demands electricity when the net electricity price determined by data processing unit 330 is higher than a set threshold. When this occurs, control unit 350 will not purchase electricity at a price above the threshold, and there may not be sufficient electricity to meet demands. Electrolysis unit 310 is underpowered when enough electricity cannot be purchased to meet demands and there is not additional supply in energy storage unit 360.

In some embodiments, electrolysis unit 310 demands electricity when the net electricity price determined by data processing unit 330 is lower than a set threshold. When this occurs, control unit 350 will purchase electricity at a price equal to or lower than the threshold, and there is then enough electricity to meet demands. Electrolysis unit 310 is fully powered when enough electricity can be purchased to meet demands, or when there is enough purchased electricity and additional supply in energy storage unit 360. Fully powered is defined as sufficiently powered to supply the desired quantity of hydrogen to downstream chemical processes.

In some embodiments, control unit 350 may purchase excess electricity when the net electricity price determined by data processing unit is below a set threshold and electrolysis unit 310 is fully powered. Excess renewable power can be stored in electricity storage unit 360 to be used later by electrolysis unit 310.

In some embodiments, control unit 350 may purchase electricity at different set thresholds, including a fully powered price threshold, excess electricity threshold, or other such threshold set to meet the needs of system 300. In some embodiments, each threshold has the same value. In some embodiments each threshold has different values. In some embodiments, the threshold value is dynamic based on other factors such as T_{diff}, incentives, type of renewable power project, or other relevant factors.

Multiple price thresholds can be set, including a fully powered price threshold and an excess electricity price threshold, each having a different value.

In another embodiment, system 300 further comprises an electricity storage unit 360 configured to store purchased electricity; wherein electricity storage unit 360 comprises at least one of a battery, a supercapacitor, a kinetic energy storage system, a heat energy storage system, or other suitable energy storage device. In some embodiments system 300 further comprises hydrogen storage unit 370 configured to store hydrogen produced by electrolysis unit 310. Hydrogen storage unit 310 may be configured to store produced hydrogen in a sorbent, or as a liquid organic hydrogen carrier (LOHC), or in a pressurized tank. In one embodiment, stored hydrogen in hydrogen storage unit 370 may be converted into larger molecules when the net electrolysis unit electricity costs rise above a threshold where it is not cost preferred to purchase electricity from the grid for hydrogen production.

In one embodiment, electrolysis unit 310 sends surplus produced hydrogen to produce methane, ethane, ethylene, propane, and/or propylene as a hydrogen storage material which may be stored in hydrogen storage unit 370. The hydrogen storage material can later be converted into larger molecules, such as low carbon fuels, low carbon chemicals, or other commodity materials, when electricity costs rise above a threshold.

Systems 100, 200, and 300 can share details and embodiments.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments. Acts may be done manually, automatically, or a combination of the two to optimize desired outcomes of the processing facility.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples and embodiments, are discussed in detail. Moreover, it is to be understood that both the foregoing information and the following detailed description are merely illustrative examples of various aspects and are intended to provide an overview or framework for understanding the nature and character of the claimed aspects and examples. Any example disclosed herein may be combined with any other example in any manner consistent with at least one of the objects, aims, and needs disclosed herein, and references to “an embodiment”, “exemplary embodiment”, “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

This section is from Official Journal of the European Union, L 157/20, 20.6.2023: COMMISSION DELEGATED REGULATION (EU) 2023/1185 of 10 Feb. 2023 supplementing Directive (EU) 2018/2001 of the European Parliament and of the Council by establishing a minimum threshold for greenhouse gas emissions savings of recycled carbon fuels and by specifying a methodology for assessing greenhouse gas emissions savings from renewable liquid and gaseous transport fuels of non-biological origin and from recycled carbon fuels

### The European Commission,

Having regard to the Treaty on the Functioning of the European Union,
Having regard to Directive (EU) 2018/2001 of the European Parliament and of the Council of 11 Dec. 2018 on the promotion of the use of energy from renewable sources, and in particular Articles 25(2) and 28(5) thereof,
Whereas:
(1) Taking into account the need to substantially reduce greenhouse gas emissions in the transport sector and the possibility for each fuel to make significant greenhouse gas emissions savings by applying carbon capture and storage techniques, among other measures, and considering the greenhouse gas saving requirements set for other fuels in Directive (EU) 2018/2001, a minimum greenhouse gas emission saving threshold of 70% should be set for all types of recycled carbon fuels.
(2) Clear rules need to be set, based on objective and non-discriminatory criteria, for calculating greenhouse gas emissions savings for renewable liquid and gaseous transport fuels of non-biological origin and recycled carbon fuels and their fossil fuel comparators.
(3) The greenhouse gas emissions accounting methodology should take into account the full life-cycle emissions from producing renewable liquid and gaseous transport fuels of non-biological origin and recycled carbon fuels and be based on objective and non-discriminatory criteria.
(4) Credits should not be granted for capturing CO₂ which has already been taken into account under other provisions of Union law. Therefore that kind of captured CO₂ should not be considered as being avoided when determining the emissions from the inputs' existing use or fate.
(5) The origin of carbon used for the production of renewable liquid and gaseous transport fuels of non-biological origin and recycled carbon fuels is not relevant for determining emission savings of such fuels in the short term, as currently many carbon sources are available and can be captured while making progress on decarbonisation. In an economy on a trajectory towards climate neutrality by 2050, sources of carbon that can be captured should become scarce in the medium- to long-term, increasingly restricted to CO₂ emissions that are hardest to abate. In addition, the continued use of renewable liquid and gaseous transport fuels of non-biological origin and recycled carbon fuels that contain carbon from non-sustainable fuel is not compatible with a trajectory towards climate neutrality by 2050 as it would entail the continued use of non-sustainable fuels and their related emissions. Therefore, capturing of emissions from non-sustainable fuels should not be considered as avoiding emissions indefinitely when determining the greenhouse gas emissions savings from the use of renewable liquid and gaseous transport fuels of non-biological origin and recycled carbon fuels. Captured emissions from the combustion of non-sustainable fuels for the production of electricity should be considered avoided emissions up to 2035, as most should be abated by that date, while emissions from other uses of non-sustainable fuels should be considered avoided emissions up to 2040, as these emissions will remain longer. These dates will be subject to review in light of the implementation in the sectors covered by Directive 2003/87/EC of the European Parliament and of the Council of the Union-wide climate target for 2040. The Union-wide climate target for 2040 is to be proposed by the Commission at the latest within six months of the first global stocktake carried out under the Paris Agreement, in accordance with Regulation (EU) 2021/1119 of the European Parliament and of the Council. The implementation of the target in Directive 2003/87/EC will further determine the expected scarcity of emissions in each sector.
(6) Emissions from activities listed in Annex I to Directive 2003/87/EC, namely from industrial processes or from the combustion of non-sustainable fuels, should be prevented, even if they could be captured and used to produce renewable liquid and gaseous transport fuels of non-biological origin and recycled carbon fuels. These emissions are subject to carbon pricing to incentivize abating the emissions from non-sustainable fuels in the first place. Therefore, where such emissions are not taken into account upstream through an effective carbon pricing, those emissions must be accounted for and should not be considered as being avoided.
(7) Renewable liquid and gaseous transport fuels of non-biological origin and recycled carbon fuels can be produced in various processes, which may yield a mixture of different types of fuels. The methodology to assess the greenhouse gas emissions savings should therefore be able to derive the actual emission savings from those processes, including processes that yield both renewable liquid and gaseous transport fuels of non-biological origin and recycled carbon fuels.
(8) To determine the greenhouse gas emissions intensity of renewable liquid and gaseous transport fuels of non-biological origin and recycled carbon fuels it is necessary to calculate the share of the energy content of such fuels in the output of a process. For this purpose, the fraction of each type of fuel should be determined by dividing the relevant energy input for the type of fuel in question by the total relevant energy inputs into the process. In case of the production of renewable liquid and gaseous transport fuels of non-biological origin, it is necessary to determine whether the relevant electricity input should be considered as fully renewable. The relevant electricity input should be counted as fully renewable if the provisions under Article 27(3) fifth and sixth subparagraph of Directive (EU) 2018/2001 are fulfilled. Otherwise, the average share of electricity from renewable sources in the country of production, as measured two years before the year in question, should be used to determine the share of renewable energy. In case of the production of recycled carbon fuels, only liquid or solid waste streams of non-renewable origin which are not suitable for material recovery in accordance with Article 4 of Directive 2008/98/EC of the European Parliament and of the Council (4) and waste processing gas and exhaust gas of non-renewable origin which are produced as an unavoidable and unintentional consequence of the production process in industrial installations can be considered as relevant energy input for the production of recycled carbon fuels.
(9) The fossil fuel comparator for renewable liquid and gaseous transport fuels of non-biological origin and recycled carbon fuels should be set at 94 gCO₂ eq/MJ in line with the value set out for biofuels and bioliquids in Directive (EU) 2018/2001.
(10) The main objective of promoting recycled carbon fuels is to reduce greenhouse gas emissions by improving the efficiency of use of eligible feedstock compared to present uses. Given that feedstock that can be used to produce recycled carbon fuels may already have been in use to produce energy, it is appropriate to take the greenhouse gas emissions resulting from the diversion of the use of those rigid inputs from its current use into account when calculating greenhouse gas emissions. The same should apply for rigid inputs obtained from incorporated processes and used to produce renewable liquid and gaseous transport fuels of non-biological origin.
(11) If the electricity used to produce renewable liquid and gaseous transport fuels of non-biological origin is taken from the electricity grid and is not considered as fully renewable, the average carbon intensity of electricity consumed in the Member State where the fuel is produced should be applied, given that that best describes the greenhouse gas intensity of the whole process. Alternatively, electricity taken from the electricity grid that is used in the production process of renewable liquid and gaseous transport fuels of non-biological origin and recycled carbon fuels that does not qualify as fully renewable according to Article 27(3) of Directive (EU) 2018/2001, could be attributed greenhouse gas emissions values depending on the number of full load hours the installation producing renewable liquid and gaseous transport fuels of non-biological origin and recycled carbon fuels is operating. If the electricity used to produce renewable liquid and gaseous transport fuels of non-biological origin is considered fully renewable according to the rules set out in Article 27 of Directive (EU) 2018/2001, a carbon intensity of zero should be applied to this electricity supply,
   Has Adopted this Regulation:

### Article 1

This Regulation establishes a minimum threshold for greenhouse gas emissions savings of recycled carbon fuels and specifies the methodology to calculate the greenhouse gas emissions savings from renewable liquid and gaseous transport fuels of non-biological origin and from recycled carbon fuels.

### Article 2

The greenhouse gas emissions savings from the use of recycled carbon fuels shall be at least 70%.

### Article 3

The greenhouse gas emissions savings from renewable liquid and gaseous transport fuels of non-biological origin and from recycled carbon fuels shall be determined in accordance with the methodology set out in the Annex.

### Article 4

This Regulation shall enter into force on the twentieth day following that of its publication in the Official Journal of the European Union.

This Regulation shall be binding in its entirety and directly applicable in all Member States. Done at Brussels, 10 Feb. 2023. For the Commission, The President. Ursula VON DER LEYEN

### Annex

Methodology for determining greenhouse gas emissions savings from renewable liquid and gaseous transport fuels of non-biological origin and from recycled carbon fuels

### A. Methodology

1. Greenhouse gas emissions from the production and use of renewable liquid and gaseous transport fuels of non-biological origin or recycled carbon fuels shall be calculated as follows:

$$E = {e}_{i} + {e}_{p} + {e}_{td} + {e}_{u} - {e}_{ccs}$$

where:
E=total emissions from the use of the fuel (gCO₂ eq/MJ fuel)
eᵢ=eᵢ elastic+eᵢ rigid−e ex-use: emissions from supply of inputs (gCO₂ eq/MJ fuel)
eᵢ elastic=emissions from elastic inputs (gCO₂ eq/MJ fuel)
eᵢ rigid=emissions from rigid inputs (gCO₂ eq/MJ fuel)
e ex-use=emissions from inputs' existing use or fate (gCO₂ eq/MJ fuel)
eₚ=emissions from processing (gCO₂ eq/MJ fuel)
e_{td}=emissions from transport and distribution (gCO₂ eq/MJ fuel)
eᵤ=emissions from combusting the fuel in its end-use (gCO₂ eq/MJ fuel)
e_{ccs}=emission savings from carbon capture and geological storage (gCO₂ eq/MJ fu
Emissions from the manufacture of machinery and equipment shall not be taken into account.
The greenhouse gas emissions intensity of renewable liquid and gaseous transport fuels of non-biological origin or recycled carbon fuels shall be determined by dividing the total emissions of the process covering each element of the formula by the total amount of fuel stemming from the process and shall be expressed in terms of grams of CO₂ equivalent per MJ of fuel (gCO₂ eq/MJ fuel). If a fuel is a mix of renewable liquid and gaseous transport fuels of non-biological origin, recycled carbon fuels and other fuels, all (fuel) types shall be considered to have the same emission intensity.
The exception to this rule is the case of co-processing where renewable liquid and gaseous transport fuels of non-biological origin and recycled carbon fuels are only partially replacing a conventional input in a process.
In such a situation it shall be distinguished in the calculation of the greenhouse gas emissions intensity on a proportional basis of the energetic value of inputs between:
   the part of the process that is based on the conventional input, and
   the part of the process that is based on renewable liquid and gaseous transport fuels of non-biological origin and recycled carbon fuels assuming that the process parts are otherwise identical.
An analogous distinction between processes shall be applied where renewable liquid and gaseous transport fuels of non-biological origin and recycled carbon fuels are processed together with biomass.
The greenhouse gas emissions intensity may be calculated as an average for the entire production of fuels occurring during a period of at most one calendar month but may also be calculated for shorter time intervals. Where electricity qualifying as fully renewable according to the methodology set out in Directive (EU) 2018/2001 is used as input that enhances the heating value of the fuel or intermediate products, the time interval shall be in line with the requirements applying for temporal correlation. Where relevant, greenhouse gas emissions intensity values calculated for individual time intervals may then be used to calculate an average greenhouse gas emissions intensity for a period of up to one month, provided that the individual values calculated for each time period meet the minimum savings threshold of 70%.
2. Greenhouse gas emission savings from renewable liquid and gaseous transport fuels of non-biological origin or from recycled carbon fuels shall be calculated as follows:

$$Savings = ( {E}_{F} - E ) / {E}_{F}$$

where:
E=total emissions from the use of renewable liquid and gaseous transport fuel of non-biological origin or recycled carbon fuel.
E_{F}=total emissions from the fossil fuel comparator.
For all renewable liquid and gaseous transport fuels of non-biological origin and recycled carbon fuels, the total emissions from the fossil fuel comparator shall be 94 gCO₂ eq/MJ.
3. If the output of a process does not fully qualify as renewable liquid and gaseous transport fuels of non-biological origin or recycled carbon fuel, their respective shares in the total output shall be determined as follows:
   (a) the fraction of renewable liquid and gaseous transport fuels of non-biological origin shall be determined by dividing the relevant renewable energy input into the process by the total relevant energy inputs into the process;
   (b) the fraction of recycled carbon fuel shall be determined by dividing the relevant energy input qualifying as a source for the production of recycled carbon fuels into the process by the total relevant energy inputs into the process.
   The relevant energy for material inputs is the lower heating value of the material input that enters into the molecular structure of the fuel (OJ L 328, 21 Dec. 2018, p. 82).
   For electricity inputs that are used to enhance the heating value of the fuel or intermediate products the relevant energy is the energy of the electricity.
   For industrial off-gases, it is the energy in the off-gas based on their lower heating value. In case of heat that is used to enhance the heating value of the fuel or intermediate product, the relevant energy is the useful energy in the heat that is used to synthesise the fuel. Useful heat is the total heat energy multiplied by the Carnot efficiency, as defined in Annex V, part C, point (1)(b) of Directive (EU) 2018/2001. Other inputs are only taken into account when determining the emission intensity of the fuel.
4. When determining emissions from supply of inputs, it shall be distinguished between elastic inputs and rigid inputs. Rigid inputs are those whose supply cannot be expanded to meet extra demand. Thus, all inputs qualifying as a carbon source for the production of recycled carbon fuels are rigid, as well as outputs produced in fixed ratio by an incorporated process (Directive 2003/87/EC of the European Parliament and of the Council of 13 Oct. 2003 establishing a scheme for greenhouse gas emission allowance trading within the Community and amending Council Directive 96/61/EC (OJ L 275, 25 Oct. 2003, p. 32) and which represent less than 10% of the economic value of the output. If it represents 10% or more of the economic value, it shall be treated as elastic. In principle, elastic inputs are those whose supply can be increased to meet extra demand. Petroleum products from refineries fall into this category because refineries can change the ratio of their products.
5. Electricity qualifying as fully renewable according to Article 27(3) of Directive (EU) 2018/2001, shall be attributed zero greenhouse gas emissions.
6. One of the three following alternative methods shall be applied during each calendar year to attribute greenhouse gas emissions values to the electricity taken from the grid that does not qualify as fully renewable according to Article 27(3) of Directive (EU) 2018/2001 and is used to produce renewable liquid and gaseous transport fuels of non-biological origin and recycled carbon fuels:
   (a) greenhouse gas emissions values shall be attributed according to part C of this Annex. This is without prejudice to the assessment under State aid rules;
   (b) greenhouse gas emissions values shall be attributed depending on the number of full load hours the installation producing renewable liquid and gaseous transport fuels of non-biological origin and recycled carbon fuels is operating. Where the number of full load hours is equal or lower than the number of hours in which the marginal price of electricity was set by installations producing renewable electricity or nuclear power plants in the preceding calendar year for which reliable data are available, grid electricity used in the production process of renewable liquid and gaseous transport fuels of non-biological origin and recycled carbon fuels shall be attributed a greenhouse gas emissions value of zero gCO₂ eq/MJ. Where this number of full load hours is exceeded, grid electricity used in the production process of renewable liquid and gaseous transport fuels of non-biological origin and recycled carbon fuels shall be attributed a greenhouse gas emissions value of 183 gCO₂ eq/MJ; or
   (c) the greenhouse gas emissions value of the marginal unit generating electricity at the time of the production of the renewable liquid and gaseous transport fuels of non-biological origin in the bidding zone may be used if this information is publicly available from the national transmission system operator.
   If the method set in point (b) is used, it shall also be applied to electricity that is used to produce renewable liquid and gaseous transport fuels of non-biological origin and recycled carbon fuels and qualifies as fully renewable according to Article 27(3) of Directive (EU) 2018/2001.
7. GHG emissions of elastic inputs that are obtained from an incorporated process shall be determined based on data from their actual production process. This shall include all emissions arising due to their production over the whole supply chain (including emissions arising from the extraction of the primary energy required to make the input, processing of the input and transportation of the input). Combustion emissions related to the carbon content of fuel inputs shall not be included (Regulation (EU) 2021/1119 of the European Parliament and of the Council of 30 Jun. 2021 establishing the framework for achieving climate neutrality and amending Regulations (EC) No 401/2009 and (EU) 2018/1999 (OJ L 243, 9.7.2021, p. 1).
   However, GHG emissions from the elastic inputs that are not obtained from an incorporated process shall be determined based on the values included in Part B of this Annex. If the input is not included in the list, information of the emission intensity may be drawn from the latest version of the JEC-WTW report, the ECOINVENT database, official sources such as the IPCC, IEA or government, other reviewed sources such as the E3 and GEMIS database and peer reviewed publications.
8. The supplier of each input, excluding those where the values are taken from part B of this Annex, shall calculate the emissions intensity (Directive 200898/EC of the European Parliament and of the Council of 19 Nov. 2008 on waste and repealing certain Directives (OJ L 312, 22 Nov. 2008, p. 3)) of the input following the procedures in this document, and report the value to the next production step or final fuel producer. The same rule applies to the suppliers of inputs further back in the supply chain.
9. Emissions from rigid inputs shall include the emissions resulting from the diversion of those inputs from a previous or alternative use. These emissions shall take into account the loss of production of electricity, heat or products that were previously generated using the input as well as any emissions due to additional treatment of the input and transport. The following rules shall apply:
   (a) Emissions attributed to the supply of rigid inputs shall be determined by multiplying the lost production of electricity, heat or other products with the relevant emission factor. In case of lost electricity production, the emission factors to consider are for grid electricity generation in the country where the displacement occurred determined according to the appropriate methodology set out under points 5 or 6. In case of diverted material, the emissions to be attributed to the replacement material are calculated as for material inputs in this methodology. For the first 20 years after the start of production of renewable liquid and gaseous transport fuels of non-biological origin or recycled carbon fuels, the loss of production of electricity, heat and material shall be determined based on the average amount of electricity and heat that was produced from the rigid input over the last three years before the start of production of renewable liquid and gaseous transport fuels of non-biological origin or recycled carbon fuels. After 20 years of production, the loss of production of electricity, heat or other products shall be determined based on the minimum energy performance standards assumed in pertinent best available technology (BAT) conclusions. Where the process is not covered by a BAT, the estimation of lost production shall be based on a comparable process applying state of the art technology.
   (b) In case of rigid inputs that are intermediate streams in industrial processes, such as coke oven gas, blast furnace gas in a steelworks, or refinery gas in an oil refinery, if the effect of diverting it for fuel production cannot be measured directly, the emissions due to the diversion of inputs shall be determined based on simulations of the plant operation before and after it is modified to produce recycled carbon fuels. If the modification of the plant caused a reduction of output of some products, the emissions attributed to the rigid input shall include the emissions associated with replacing the lost products.
   (c) Where the process makes use of rigid inputs from new installations such as a new steelworks that uses its blast furnace gas for making recycled carbon fuels, the impact of diverting the input from the most economic alternative use shall be taken into account. Then the emission implications are calculated according to the minimum energy performance standards assumed in the pertinent BAT conclusions. For industrial processes which are not covered by a BAT, the saved emissions shall be calculated on the basis of the comparable process applying state of the art technology.
10. Emissions from existing use or fate include all emissions in the existing use or fate of the input that are avoided when the input is used for fuel production. These emissions shall include the CO₂ equivalent of the carbon incorporated in the chemical composition of the fuel that would have otherwise been emitted as CO₂ into the atmosphere. This includes CO₂ that was captured and incorporated into the fuel provided that at least one of the following conditions is fulfilled:
   (a) the CO₂ has been captured from an activity listed under Annex I of Directive 2003/87/EC and has been taken into account upstream in an effective carbon pricing system and is incorporated in the chemical composition of the fuel before 2036. This date shall be extended to 2041 in other cases than CO₂ stemming from the combustion of fuels for electricity generation; or
   (b) the CO₂ has been captured from the air; or
   (c) the captured CO₂ stems from the production or the combustion of biofuels, bioliquids or biomass fuels complying with the sustainability and greenhouse gas saving criteria and the CO₂ capture did not receive credits for emission savings from CO₂ capture and replacement, set out in Annex V and VI of Directive (EU) 2018/2001; or
   (d) the captured CO₂ stems from the combustion of renewable liquid and gaseous transport fuels of non-biological origin or recycled carbon fuels complying with the greenhouse gas saving criteria, set out in Article 25(2) and Article 28(5) of Directive (EU) 2018/2001 and this Regulation; or
   (e) the captured CO₂ stems from a geological source of CO₂ and the CO₂ was previously released naturally.
   Captured CO₂ stemming from a fuel that is deliberately combusted for the specific purpose of producing the CO₂ and CO₂, the capture of which has received an emissions credit under other provisions of the law shall not be included.
   Emissions associated with the inputs like electricity and heat and consumable materials used in the capture process of CO₂ shall be included in the calculation of emissions attributed to inputs.
11. The dates established in point 10(a) will be subject to review considering the implementation in the sectors covered by Directive 2003/87/EC of the Union-wide climate target for 2040 established in accordance with Article 4(3) of Regulation (EU) 2021/1119.
12. Emissions from processing shall include direct atmospheric emissions from the processing itself, from waste treatment and from leakages.
13. Emissions from combustion of the fuel refer to the total combustion emissions of the fuel in use.
14. The greenhouse gases taken into account in emissions calculations, and their carbon dioxide equivalents, shall be the same as specified in Annex V, part C, point 4 of Directive (EU) 2018/2001.
15. Where a process yields multiple co-products such as fuels or chemicals, as well as energy co-products such as heat, electricity or mechanical energy exported from the plant, greenhouse gas emissions shall be allocated to these co-products applying the following approaches in the following manner:
   (a) The allocation shall be conducted at the end of the process that produces the co-products. The emissions allocated shall include the emissions from the process itself, as well as the emissions attributed to inputs to the process.
   (b) The emissions to be allocated shall be e; plus any fractions of e p, e id and e ccs that take place up to and including the process step at which the co-products are produced. If an input into the process is itself a co-product of another process, the allocation at the other process shall be done first to establish the emissions to be attributed to the input.
   (c) If any installation inside the project boundary treats only one of the project's co-products, then the emissions from that installation shall be ascribed entirely to that co-product.
   (d) Where the process allows to change the ratio of the co-products produced, the allocation shall be done based on physical causality by determining the effect on the process' emissions of incrementing the output of just one co-product whilst keeping the other outputs constant.
   (e) Where the ratio of the products is fixed and the co-products are all fuels, electricity or heat, the allocation shall be done by energy content. If allocation concerns exported heat on the basis of the energy content, only the useful part of the heat may be considered, as defined in Annex V, part C, point 16 of Directive (EU) 2018/2001.
   (f) Where the ratio of the products is fixed and some co-products are materials with no energy content, the allocation shall be done by the economic value of the co-products. The economic value considered shall be the average factory-gate value of the products over the last three years. If such data is not available, the value shall be estimated from commodity prices minus the cost of transport and storage.
16. Emissions from transport and distribution shall include emissions from the storage and distribution of the finished fuels. Emissions attributed to inputs eᵢ shall include emissions from their associated transport and storage.
17. Where a process for making renewable liquid and gaseous transport fuels of non-biological origin or recycled carbon fuels produces carbon emissions that are permanently stored in accordance with Directive 2009/31/EC on the geological storage of carbon dioxide, this may be credited to the products of the process as a reduction in emissions under e_{ccs}. Emissions arising due to the storage operation (including transport of the carbon dioxide) will also need to be taken into account under eₚ.

### B. ‘Standard Values’ for Greenhouse Gas Emission Intensities of Elastic Inputs

The GHG intensities of inputs other than electricity are shown in the table below:

| | | | Combustion |
|---|---|---|---|
| | Total emissions | Upstream emissions | emissions |
| | gCO₂eq/MJ | gCO₂eq/MJ | gCO₂eq/MJ |
| Natural gas | 66.0 | 9.7 | 56.2 |
| Diesel | 95.1 | 21.9 | 73.2 |
| Gasoline | 93.3 | 19.9 | 73.4 |
| Heavy fuel oil | 94.2 | 13.6 | 80.6 |
| Methanol | 97.1 | 28.2 | 68.9 |
| Hard coal | 112.3 | 16.2 | 96.1 |
| Lignite | 116.7 | 1.7 | 115.0 |

| | gCO₂eq/kg |
|---|---|
| Ammonia | 2 351.3 |
| Calcium chloride (CaCl₂) | 38.8 |
| Cyclohexane | 723.0 |
| Hydrochloric acid (HCl) | 1 061.1 |
| Lubricants | 947.0 |
| Magnesium sulphate (MgSO₄) | 191.8 |
| Nitrogen | 56.4 |
| Phosphoric acid (H₃PO₄) | 3 124.7 |
| Potassium hydroxide (KOH) | 419.1 |
| Pure CaO for processes | 1 193.2 |
| Sodium carbonate (Na₂CO₃) | 1 245.1 |
| Sodium chloride (NaCl) | 13.3 |
| Sodium hydroxide (NaOH) | 529.7 |
| Sodium methoxide (Na(CH₃O)) | 2 425.5 |
| SO₂ | 53.3 |
| Sulphuric acid (H₂SO₄) | 217.5 |
| Urea | 1 846.6 |

### C. GHG Emission Intensity of Electricity

The greenhouse gas emission intensity of electricity shall be determined at the level of countries or at the level of bidding zones. The greenhouse gas emission intensity of electricity may be determined at the level of bidding zones only, if the required data are publicly available. The calculation the carbon intensity of electricity, expressed as gCO₂ eq/kWh electricity, shall consider all potential primary energy sources for electricity generation, type of plant, conversion efficiencies and own electricity consumption in the power plant.

The calculation shall consider all carbon equivalent emissions, associated with the combustion and supply of the fuels used for electricity production. This relies on the amount of different fuels used in the electricity production facilities and the emission factors from fuel combustion and the upstream fuel emission factors.

Greenhouse Gases other than CO₂ shall be converted to CO₂ eq by multiplying their Global Warming Potential (GWP) relative to CO₂ over the 100-year time horizon as set out in Annex V, part C, point 4 to Directive (EU) 2018/2001. Because of their biogenic origin, CO₂ emissions from the combustion of biomass fuels are not accounted for, but emissions of CH₄ and N₂O shall be accounted for.

For the calculation of the GHG emissions from fuels combustion, the IPCC default emission factors for stationary combustion in the energy industries shall be used (IPCC 2006). The upstream emissions shall include emissions from all the processes and phases required to make the fuel ready to supply the power production; they result from the extraction, refining and transport of the fuel used for electricity production.

In addition, all the upstream emissions from the cultivation, harvesting, collection, processing and transport of biomass shall be considered. Peat and the components of waste materials that are from fossil origins shall be treated as a fossil fuel.

The fuels used for gross electricity production in electricity only plants are determined based on the electricity production and the efficiency of conversion to electricity. In the case of Combined Heat and Power (CHP), the fuels used for heat produced in CHP shall be counted by considering alternative heat production with average overall efficiencies of 85%, while the rest shall be attributed to electricity generation.

For nuclear power plants, the conversion efficiency from nuclear heat shall be assumed to be 33% or data provided by Eurostat or a similar, accredited source.

No fuels are associated with electricity production from renewables that include hydro, solar, wind and geothermal. The emissions from the construction and decommissioning and waste management of electricity producing facilities are not considered. Thus, the carbon equivalent emissions associated with the renewable electricity (wind, solar, hydro and geothermal) production are considered to be equal to zero.

The CO₂ equivalent emissions from gross electricity production shall include upstream emissions from JEC WTW v5 (Prussi et al, 2020) listed in Table 3 and the default emission factors for stationary combustion from IPCC Guidelines for National Greenhouse Gas Inventories (IPCC 2006) listed in Tables 1 and 2. The upstream emissions for supplying the fuel used shall be calculated applying the JEC WTW v5 upstream emission factors (Prussi et al, 2020).

The calculation of the carbon intensity of electricity shall be done following the formula:

$${e}_{gross \_ prod} = {\sum }_{i = 1}^{k} ( {c}_{i - ups} + {c}_{i - comb} ) \times {B}_{i}$$

$$where : {e}_{gross \_ prod} = {CO}_{2} equivalent emissions$$

$$[ {gCO}_{2 eq} ]$$

$${c}_{i - ups} = upstream {CO}_{2} equivalent emission factors$$

$$[ \frac{{gCO}_{2 eq}}{MJ} ]$$

$${c}_{i - comb} = {CO}_{2} equivalent emission factors from fuels combustion$$

$$[ \frac{{gCO}_{2 eq}}{MJ} ]$$

$${B}_{i} = fuel consumption for electricity generation$$

$$[ MJ ]$$

$$i = 1 … k = fuels used for electricity production$$

The amount of not electricity production is determined by the gross electricity production, own electricity consumption in the power plant and the electricity losses in pump storage.

$${E}_{net} = {E}_{gross} - {E}_{own} - {E}_{pump}$$

$$where : {E}_{net} = net electricity production$$

$$[ MJ ]$$

$${E}_{gross} = gross electricity production$$

$$[ MJ ]$$

$${E}_{own} = own internal electricity consumption in power plant$$

$$[ MJ ]$$

$${E}_{pump} = electricity for pumping$$

$$[ MJ ]$$

The carbon intensity of net produced electricity shall be the total gross GHG emissions for producing or using the net electricity:

$$CI = \frac{{e}_{gross \_ prod}}{{E}_{net}}$$

$$where : CI = {CO}_{2} equivalent emissions from electricity production$$

$$[ \frac{{gCO}_{2 eq}}{MJ} ]$$

### Electricity Production and Fuel Consumption Data

Data on electricity production and fuel consumption shall be sourced from IEA Data and statistics that provides data on energy balances and electricity produced using various fuels, e.g. from IEA website, Data and Statistic section (‘Energy Statistics Data Browser’).

For EU Member States, Eurostat data are more detailed and can be used instead. Where the greenhouse gas emission intensity is established at the level of bidding zones, data from official national statistics of the same level of detail as the IEA data shall be used. Fuel consumption data shall include available data at the highest level of detail available from national statistics: solid fossil fuels, manufactured gases, peat and peat products, oil shale and oil sands, oil and petroleum products, natural gas, renewables and biofuels, non-renewable waste and nuclear. Renewables and biofuels include biofuels, renewable municipal waste, hydro, ocean, geothermal, wind, solar and heat pumps.

Input Data from Literature Sources

TABLE 1
Default emissions factors for stationary combustion
[g/MJ fuel on a net calorific value]

| Fuel | CO₂ | CH₄ | N₂O |
|---|---|---|---|
| Solid fossil fuels | | | |
| Anthracite | 98.3 | 0.001 | 0.0015 |
| Coking coal | 94.6 | 0.001 | 0.0015 |
| Other bituminous coal | 94.6 | 0.001 | 0.0015 |
| Sub-bituminous coal | 96.1 | 0.001 | 0.0015 |
| Lignite | 101 | 0.001 | 0.0015 |
| Patent fuel | 97.5 | 0.001 | 0.0015 |
| Coke oven coke | 107 | 0.001 | 0.0015 |
| Gas coke | 107 | 0.001 | 0.0001 |
| Coal tar | 80.7 | 0.001 | 0.0015 |
| Brown coal briquettes | 97.5 | 0.001 | 0.0015 |
| Manufactured gases | | | |
| Gas works gas | 44.4 | 0.001 | 0.0001 |
| Coke oven gas | 44.4 | 0.001 | 0.0001 |
| Blast furnace gas | 260 | 0.001 | 0.0001 |
| Other recovered gases | 182 | 0.001 | 0.0001 |
| Peat and peat products | 106 | 0.001 | 0.0015 |
| Oil shale and oil sands | 73.3 | 0.003 | 0.0006 |
| Oil and petroleum products | | | |
| Crude oil | 73.3 | 0.003 | 0.0006 |
| Natural gas liquids | 64.2 | 0.003 | 0.0006 |
| Refinery feedstocks | 73.3 | 0.003 | 0.0006 |
| Additives and oxygenates | 73.3 | 0.003 | 0.0006 |
| Other hydrocarbons | 73.3 | 0.003 | 0.0006 |
| Refinery gas | 57.6 | 0.001 | 0.0001 |
| Ethane | 61.6 | 0.001 | 0.0001 |
| Liquefied petroleum gases | 63.1 | 0.001 | 0.0001 |
| Motor gasoline | 69.3 | 0.003 | 0.0006 |
| Aviation gasoline | 70 | 0.003 | 0.0006 |
| Gasoline-type jet fuel | 70 | 0.003 | 0.0006 |
| Kerosene-type jet fuel | 71.5 | 0.003 | 0.0006 |
| Other kerosene | 71.5 | 0.003 | 0.0006 |
| Naphtha | 73.3 | 0.003 | 0.0006 |
| Gas oil and diesel oil | 74.1 | 0.003 | 0.0006 |
| Fuel oil | 77.4 | 0.003 | 0.0006 |
| White spirit and SBP | 73.3 | 0.003 | 0.0006 |
| Lubricants | 73.3 | 0.003 | 0.0006 |
| Bitumen | 80.7 | 0.003 | 0.0006 |
| Petroleum coke | 97.5 | 0.003 | 0.0006 |
| Paraffin waxes | 73.3 | 0.003 | 0.0006 |
| Other oil products | 73.3 | 0.003 | 0.0006 |
| Natural gas | 56.1 | 0.001 | 0.0001 |
| Waste | | | |
| Industrial waste (non-renewable) | 143 | 0.03 | 0.004 |
| Non-renewable municipal waste | 91.7 | 0.03 | 0.004 |

Note:
values have to be multiplied with GWP factors set out in Annex V, part C, point 4 to Directive (EU) 2018/2001.
Source: IPCC, 2006.

TABLE 2
Default emissions factors for stationary combustion of fuels
of biomass origin [g/MJ fuel on a net calorific value]

| Fuel | CO₂ | CH₄ | N₂O |
|---|---|---|---|
| Primary solid biofuels | 0 | 0.03 | 0.004 |
| Charcoal | 0 | 0.2 | 0.004 |
| Biogases | 0 | 0.001 | 0.0001 |
| Renewable municipal waste | 0 | 0.03 | 0.004 |
| Pure biogasoline | 0 | 0.003 | 0.0006 |
| Blended biogasoline | 0 | 0.003 | 0.0006 |
| Pure biodiesels | 0 | 0.003 | 0.0006 |
| Blended biodiesels | 0 | 0.003 | 0.0006 |
| Pure bio jet kerosene | 0 | 0.003 | 0.0006 |
| Blended bio jet kerosene | 0 | 0.003 | 0.0006 |
| Other liquid biofuels | 0 | 0.003 | 0.0006 |

Source: IPCC, 2006.

TABLE 3
Fuel upstream emission factors [
gCO₂eq/MJ fuel on a net calorific value]

| Fuel | Emission factor |
|---|---|
| Hard coal | 15.9 |
| Brown coal | 1.7 |
| Peat | 0 |
| Coal gases | 0 |
| Petroleum Products | 11.6 |
| Natural gas | 12.7 |
| Solid biofuels | 0.7 |
| Liquid biofuels | 46.8 |
| Industrial Waste | 0 |
| Municipal waste | 0 |
| Biogases | 13.7 |
| Nuclear | 1.2 |

Source: JEC WTW v5.

Table A includes the values for the GHG emission intensity of electricity at country level in the European Union. If the greenhouse gas emission intensity of electricity is determined at country level, these values shall be used for electricity sourced in the European Union until more recent data becomes available to determine the emission intensity of electricity.

TABLE A
Emission intensity of electricity in the European Union 2020

| Country | Emission intensity of generated electricity (gCO₂eq/MJ) |
|---|---|
| Austria | 39.7 |
| Belgium | 56.7 |
| Bulgaria | 119.2 |
| Cyprus | 206.6 |
| Czechia | 132.5 |
| Germany | 99.3 |
| Denmark | 27.1 |
| Estonia | 139.8 |
| Greece | 125.2 |
| Spain | 54.1 |
| Finland | 22.9 |
| France | 19.6 |
| Croatia | 55.4 |
| Hungary | 72.9 |
| Ireland | 89.4 |
| Italy | 92.3 |
| Latvia | 39.4 |
| Lithuania | 57.7 |
| Luxembourg | 52.0 |
| Malta | 133.9 |
| Netherlands | 99.9 |
| Poland | 196.5 |
| Portugal | 61.6 |
| Romania | 86.1 |
| Slovakia | 45.6 |
| Slovenia | 70.1 |
| Sweden | 4.1 |

Source: JRC, 2022.

This section is from Official Journal of the European Union, L 157/11, 20.6.2023: COMMISSION DELEGATED REGULATION (EU) 2023/1184 of 10 Feb. 2023 supplementing Directive (EU) 2018/2001 of the European Parliament and of the Council by establishing a Union methodology setting out detailed rules for the production of renewable liquid and gaseous transport fuels of non-biological origin

### The European Commission,

Having regard to the Treaty on the Functioning of the European Union,

Having regard to Directive (EU) 2018/2001 of the European Parliament and of the Council of 11 Dec. 2018 on the promotion of the use of energy from renewable sources, and in particular Article 27(3), seventh subparagraph thereof,

### Whereas:

(1) Renewable liquid and gaseous transport fuels of non-biological origin are important for increasing the share of renewable energy in sectors that are expected to rely on gaseous and liquid fuels in the long term, such as maritime and aviation. It is necessary to establish a Union methodology setting out detailed rules on electricity used for liquid and gaseous transport fuels of non-biological origin to be considered fully renewable. To this end and considering the overall environmental objectives in Directive (EU) 2018/2001 it is necessary to lay down clear rules, based on objective and non-discriminatory criteria. As a principle, liquid and gaseous fuels of non-biological origin which are produced from electricity are considered renewable only when the electricity is renewable. This renewable electricity may be supplied by an installation that is directly connected to the installation (typically an electrolyser) that produces renewable liquid and gaseous transport fuels of non-biological origin, or may come directly from the grid.
(2) The energy content of nearly all renewable liquid and gaseous transport fuels of non-biological origin is based on renewable hydrogen produced via electrolysis. The emission intensity of hydrogen produced from fossil-based electricity is substantially higher than the emission intensity of hydrogen produced from natural gas in conventional processes. It is therefore important to ensure that the electricity demand for the production of renewable liquid and gaseous transport fuels of non-biological origin is met by renewable electricity. Following Russia's invasion of Ukraine, the need of the Union for a rapid clean energy transition and the reduction of its dependency on fossil fuel imports has become even clearer and stronger. The Commission outlined in the RepowerEU Communication its strategy to become independent from Russian fossil fuels well before the end of the decade. Renewable liquid and gaseous transport fuels of non-biological origin play an important role in this endeavour as well as reducing reliance on fossil fuel imports in general. Therefore, the criteria to be laid down are also important to prevent that electricity demand to produce hydrogen necessary for renewable transport fuels of non-biological origin would lead to increased fossil fuel imports from Russia for the production of the required electricity.
(3) The rules set out in this Regulation should apply regardless of whether the liquid and gaseous transport fuel of non-biological origin is produced inside or outside the territory of the Union. Where reference is made to bidding zone and imbalance settlement period, concepts that exist in the Union but not in all other countries, it is appropriate to allow fuel producers in third countries to rely on equivalent concepts provided the objective of this Regulation is maintained and the provision is implemented based on the most similar concept existing in the third country concerned. In case of bidding zones such concept could be similar market regulations, the physical characteristics of the electricity grid, notably the level of interconnection or as a last resort the country.
(4) The nascent nature of the hydrogen industry, its value chain and the market means that planning and construction of installations generating renewable electricity as well as installations producing renewable liquid and gaseous transport fuel of non-biological origin are often subject to significant delays in the permitting processes and other unexpected hurdles, despite being scheduled to enter into operation at the same time. It is therefore appropriate for the reason of practical feasibility to consider a time period of up to 36 months when determining if an installation generating renewable electricity has come into operation after, or at the same time as, the installation producing renewable liquid and gaseous transport fuel of non-biological origin. Sourcing renewable electricity for the production of renewable liquid and gaseous transport fuels of non-biological origin via a direct connection from an installation producing renewable electricity that is not connected to the grid demonstrates that the electricity is produced in this installation. However, if the installation producing renewable electricity and the installation producing hydrogen are not only directly connected but are also connected to the grid, evidence should be provided that the electricity used to produce hydrogen is supplied through the direct connection. The installation supplying electricity for hydrogen production through a direct connection should always supply renewable electricity. If it supplies non-renewable electricity, the resulting hydrogen should not be considered renewable.
(5) In bidding zones where renewable electricity already represents the dominant share, electricity taken from the grid should be considered as fully renewable provided that the number of full load hours of renewable liquid and gaseous transport fuel of non-biological origin production is limited to the share of renewable electricity in the bidding zone and any production exceeding this share is considered non-renewable. Adding additional installations producing renewable electricity is not necessary given that it can be reasonably assumed that producing renewable hydrogen in a bidding zone where the share of renewable energy exceeds 90% allows meeting the 70% greenhouse gas saving criterion set out in Article 25(2) of Directive (EU) 2018/2001 and it may create challenges for the operation of electricity system.
(6) Similarly, in bidding zones, where the emission intensity of electricity is below 18 gCO₂ eq/MJ, adding further installations producing renewable electricity is not required to achieve the 70% emissions savings for renewable hydrogen. In such cases, it is appropriate to consider electricity taken from the grid as fully renewable provided that the renewable properties of electricity are demonstrated with renewables power purchase agreements and by applying criteria for temporal and geographic correlation. Lack of compliance with these conditions and criteria would prevent electricity used for the production of renewable liquid and gaseous transport fuels from being considered as fully renewable.
(7) It is further appropriate to consider electricity taken from the grid as fully renewable at times where the production of renewable liquid and gaseous transport fuel of non-biological origin supports the integration of renewable power generation into the electricity system and reduces the need for redispatching of renewable electricity generation.
(8) In all other cases, the production of renewable hydrogen should incentivize the deployment of new renewable electricity generation capacity and take place at times and in places where renewable electricity is available (temporal and geographic correlation) to avoid incentives for more fossil-based electricity generation. Given that planning and construction of installations generating renewable electricity are often subject to significant delays in the permitting processes, it is appropriate to consider an installation generating renewable electricity as new if it has come into operation not earlier than 36 months before the installation producing renewable liquid and gaseous transport fuel of non-biological origin.
(9) Power purchase agreements are a suitable tool to incentivize the deployment of new renewable electricity generation capacity provided the new renewable electricity generation capacity does not receive financial support since the renewable hydrogen is already being supported by being eligible to count towards the obligation on fuel suppliers set out in Article 25 of Directive (EU) 2018/2001. Alternatively, fuel producers could also produce the amount of renewable electricity required for the production of renewable liquid and gaseous transport fuel of non-biological origin in renewable electricity generation capacity they own themselves. The cancellation of the power purchase agreement should not be detrimental to the possibility for the installation producing renewable electricity to be still considered as a new installation when covered by a new power purchase agreement. Furthermore, any extension of the installation producing renewable hydrogen that increases its production capacity may be considered to come into operation at the same time as the original installation. This would avoid the potential need to conclude power purchase agreements with different installations every time there is an extension, thus reduce administrative burden. Financial support that is repaid or financial support for land or grid connections for the renewable power generation facility should not be considered as operating aid or investment aid.
(10) Due to the fluctuating nature of some sources of renewable energy including wind power and solar power, as well as congestion of the electricity grid, renewable electricity may not be constantly available for the production of renewable hydrogen. It is therefore appropriate to set out rules that ensure that renewable hydrogen is produced at times and in places where renewable electricity is available.
(11) In order to demonstrate that renewable hydrogen is produced when renewable electricity is available, hydrogen producers should show that production of renewable hydrogen takes place in the same calendar month as the production of the renewable electricity, that the electrolyser uses stored renewable electricity, or that the electrolyser uses electricity at times when electricity prices are so low that fossil-based electricity generation is not economically viable and, therefore, additional demand for electricity triggers more renewable electricity production and does not trigger an increase in fossil electricity generation. The criterion for synchronisation should become stricter when markets, infrastructures and technologies allowing for a quick adjustment of hydrogen production and the synchronisation of electricity generation and hydrogen production become available.
(12) Bidding zones are designed to avoid grid congestion within the zone. To ensure that there is no electricity grid congestion between the electrolyser producing renewable hydrogen and the installation generating renewable electricity it is appropriate to require that, both installations should be located in the same bidding zone. Where they are located in interconnected bidding zones, the electricity price in the bidding zone where the installation generating renewable electricity is located should be equal or higher than in the bidding zone where the renewable liquid and gaseous transport fuel of non-biological origin is produced so that it contributes to reducing congestion; or the installation generating renewable electricity under the power purchase agreement should be located in an offshore bidding zone interconnected to the bidding zone where the electrolyser is located.
(13) In order to address national specificities of their bidding zones and to support the integrated planning of electricity and hydrogen networks, Member States should be allowed to set out additional criteria concerning the location of electrolysers within bidding zones.
(14) Fuel producers could combine different options for counting electricity that is used for the production of renewable liquid and gaseous transport fuels of non-biological origin in a flexible way provided only one option is applied for each unit of electricity input. In order to verify whether the rules have been followed correctly it is appropriate to request fuels suppliers to thoroughly document which options were applied to source renewable electricity that is used for the production of renewable liquid and gaseous transport fuels of non-biological origin. Voluntary schemes and national schemes are expected to play an important role in the implementation and certification of the rules in third countries as Member States are required to accept the evidence obtained from recognised voluntary schemes.
(15) Articles 7 and 19 of Directive (EU) 2018/2001 provide sufficient assurances that the renewable properties of electricity used for the production of renewable hydrogen are claimed only once and only in one end-use sector. Article 7 of that Directive ensures that, when calculating the overall share of renewables in gross final energy consumption, renewable liquid and gaseous transport fuels of non-biological origin are not accounted because the renewable electricity used to produce them has already been accounted for. Article 19 of that Directive should avoid that both the producer of the renewable electricity and the producer of the renewable liquid and gaseous transport fuels of non-biological origin produced from that electricity can receive guarantees of origin by ensuring that the guarantees of origin issued to the producer of renewable electricity are cancelled.
(16) Implementation of temporal correlation is hampered in the short term by technological barriers to measure hourly matching, the challenging implications for electrolyser designs, as well as the lack of hydrogen infrastructure enabling storage and transportation of renewable hydrogen to end users in need of constant hydrogen supply. In order to enable the ramp-up of the production of renewable liquid and gaseous transport fuels of non-biological origin, the criteria on temporal correlation should therefore be more flexible in the initial phase, allowing market players to put in place the necessary technological solutions.
(17) Due to the time needed for the planning and construction of installations generating renewable electricity and the lack of new installations generating renewable electricity that do not receive support, the requirements set out in Article 5, points (a) and (b) of this Regulation should apply only at a later stage.
(18) The reliance on fossil fuels for electricity generation should decline over time with the implementation of the European Green Deal and the share of energy from renewable sources should increase. The Commission should monitor this development closely and assess the impact of the requirements set out in this Regulation, notably the gradual strengthening of the requirements on temporal correlation, regarding production costs, greenhouse gas emission savings and the energy system, and submit at the latest by 1 Jul. 2028 a report to the European Parliament and the Council,
   Has Adopted this Regulation:

### Article 1

### Subject Matter

This Regulation lays down detailed rules for determining when electricity used for the production of renewable liquid and gaseous transport fuels of non-biological origin can be considered fully renewable. These rules shall apply to the production of renewable liquid and gaseous transport fuels of non-biological origin via electrolysis and analogously for less common production pathways.

They shall apply regardless of whether the liquid and gaseous transport fuel of non-biological origin is produced inside or outside the territory of the Union.

### Article 2

### Definitions

For the purposes of this Regulation, the following definitions apply:
(1) ‘bidding zone’ means bidding zone as defined in Article 2, point (65), of Regulation (EU) 2019/943 of the European Parliament and of the Council for Member States, or an equivalent concept for third countries;
(2) ‘direct line’ means direct line as defined in Article 2, point (41), of Directive (EU) 2019/944 of the European Parliament and of the Council;
(3) ‘installation generating renewable electricity’ means individual units, or groups of units, producing electricity in one or several locations from the same or from different renewable sources, as defined in Article 2, point (1) of Directive (EU) 2018/2001, excluding units producing electricity from biomass and storage units;
(4) ‘fuel producer’ means an economic operator that produces renewable liquid and gaseous transport fuel of non-biological origin;
(5) ‘come into operation’ means starting production of renewable liquid and gaseous transport fuels of non-biological origin or renewable electricity for the first time or following a repowering as defined under Article 2, point (10) of Directive (EU) 2018/2001 requiring investments exceeding 30% of the investment that would be needed to build a similar new installation;
(6) ‘smart metering system’ means smart metering system as defined in Article 2, point (23) of Directive (EU) 2019/944;
(7) ‘imbalance settlement period’ means imbalance settlement period as defined in Article 2, point (15) of Regulation (EU) 2019/943 within the Union, or an equivalent concept for third countries.

### Article 3

Rules for Counting Electricity Obtained from Direct Connection to an Installation Generating Renewable Electricity as Fully Renewable

For the purpose of demonstrating compliance with the criteria set out in Article 27(3), fifth subparagraph of Directive (EU) 2018/2001 for counting electricity obtained from direct connection to an installation generating renewable electricity as fully renewable, the fuel producer shall provide evidence on the following:
(a) the installations generating renewable electricity are connected to the installation producing renewable liquid and gaseous transport fuel of non-biological origin via a direct line, or the renewable electricity production and production of renewable liquid and gaseous transport fuel of non-biological origin take place within the same installation;
(b) the installations generating renewable electricity came into operation not earlier than 36 months before the installation producing renewable liquid and gaseous transport fuel of non-biological origin; where additional production capacity is added to an existing installation producing renewable liquid and gaseous transport fuel of non-biological origin, the added capacity shall be considered to be part of the existing installation, provided that the capacity is added at the same site and the addition takes place no later than 36 months after the initial installation came into operation;
(c) the installation producing electricity is not connected to the grid, or the installation producing electricity is connected to the grid but a smart metering system that measures all electricity flows from the grid shows that no electricity has been taken from the grid to produce renewable liquid and gaseous transport fuel of non-biological origin. If the fuel producer also uses electricity from the grid, it may count it as fully renewable if it complies with the rules set out in Article 4.

### Article 4

General Rules for Counting Electricity Taken from the Grid as Fully Renewable
1. Fuel producers may count electricity taken from the grid as fully renewable if the installation producing the renewable liquid and gaseous transport fuel of non-biological origin is located in a bidding zone where the average proportion of renewable electricity exceeded 90% in the previous calendar year and the production of renewable liquid and gaseous transport fuel of non-biological origin does not exceed a maximum number of hours set in relation to the proportion of renewable electricity in the bidding zone.
This maximum number of hours shall be calculated by multiplying the total number of hours in each calendar year by the share of renewable electricity reported for the bidding zone where the renewable liquid and gaseous transport fuel of non-biological origin is produced. The average share of renewable electricity shall be determined by dividing the gross final consumption of electricity from renewable sources in the bidding zone calculated by analogy to the rules set out in Article 7 (2) of Directive (EU) 2018/2001 by the gross electricity production from all energy sources as defined in Annex B to Regulation (EC) No 1099/2008 of the European Parliament and of the Council, except from water previously pumped uphill, plus imports minus exports of electricity to the bidding zone. Once the average share of renewable electricity exceeds 90% in a calendar year, it shall be continued to be considered to be higher than 90% for the subsequent five calendar years.
2. Where the conditions set out under paragraph 1 are not met, fuel producers may count electricity taken from the grid as fully renewable if the installation producing the renewable liquid and gaseous transport fuel of non-biological origin is located in a bidding zone where the emission intensity of electricity is lower than 18 gCO₂ eq/MJ, provided that the following criteria are met:
(a) the fuel producers have concluded directly, or via intermediaries, one or more renewables power purchase agreements with economic operators producing renewable electricity in one or more installations generating renewable electricity for an amount that is at least equivalent to the amount of electricity that is claimed as fully renewable and the electricity claimed is effectively produced in this or these installations;
(b) the conditions on temporal and geographical correlation in accordance with Articles 6 and 7 are met.
   The emission intensity of electricity shall be determined following the approach for calculating the average carbon intensity of grid electricity in the methodology for determining the greenhouse gas emissions savings from renewable liquid and gaseous transport fuels of non-biological origin and from recycled carbon fuels set out in the delegated act adopted pursuant to Article 28(5) of Directive (EU) 2018/2001 based on latest available data.
   Once the emission intensity of electricity is lower than 18 gCO₂ eq/MJ in a calendar year, the average emission intensity of electricity shall be continued to be considered to be lower than 18 gCO₂ eq/MJ for the subsequent five calendar years.
3. Electricity taken from the grid that is used to produce renewable liquid and gaseous transport fuel of non-biological origin may also be counted as fully renewable if the electricity used to produce renewable liquid and gaseous transport fuel of non-biological origin is consumed during an imbalance settlement period during which the fuel producer can demonstrate, based on evidence from the national transmission system operator, that:
(a) power-generating installations using renewable energy sources were redispatched downwards in accordance with Article 13 of Regulation (EU) 2019/943;
(b) the electricity consumed for the production of renewable liquid and gaseous transport fuel of non-biological origin reduced the need for redispatching by a corresponding amount.
4. Where the conditions in paragraphs 1, 2 and 3 are not met, fuel producers may count electricity taken from the grid as fully renewable if it complies with the conditions on additionality, temporal correlation and geographic correlation in accordance with Articles 5, 6 and 7.

### Article 5

### Additionality

The additionality condition referred to in Article 4(4), first subparagraph shall be considered complied with if fuel producers produce an amount of renewable electricity in their own installations that is at least equivalent to the amount of electricity claimed as fully renewable, or have concluded directly, or via intermediaries, one or more renewables power purchase agreements with economic operators producing renewable electricity in one or more installations for an amount of renewable electricity that is at least equivalent to the amount of electricity that is claimed as fully renewable and the electricity claimed is effectively produced in this or these installations, provided that the following criteria are met:
(a) The installation generating renewable electricity came into operation not earlier than 36 months before the installation producing the renewable liquid and gaseous transport fuel of non-biological origin.
   Where an installation generating renewable electricity complied with the requirements set out in the first subparagraph of this paragraph under a renewables power purchase agreement with a fuel producer that has ended, it shall be considered to have come into operation at the same time as the installation producing the renewable liquid and gaseous transport fuel of non-biological origin under a new renewables power purchase agreement.
   Where additional production capacity is added to an existing installation producing renewable liquid and gaseous transport fuel of non-biological origin, the added capacity shall be considered to have come into operation at the same time as the initial installation, provided that the capacity is added at the same site and the addition takes place no later than 36 months after the initial installation came into operation.
(b) The installation generating renewable electricity has not received support in the form of operating aid or investment aid, excluding support received by installations before their repowering, financial support for land or for grid connections, support that does not constitute net support, such as support that is fully repaid and support for installations generating renewable electricity that are supplying installations producing renewable liquid and gaseous transport fuel of non-biological origin used for research, testing and demonstration.

### Article 6

### Temporal Correlation

Until 31 Dec. 2029 the temporal correlation condition referred to in Article 4(2) and (4), shall be considered complied with if the renewable liquid and gaseous transport fuel of non-biological origin is produced during the same calendar month as the renewable electricity produced under the renewables power purchase agreement or from renewable electricity from a new storage asset that is located behind the same network connection point as the electrolyser or the installation generating renewable electricity, that has been charged during the same calendar month in which the electricity under the renewables power purchase agreement has been produced.

From 1 Jan. 2030, the temporal correlation condition shall be considered complied with if the renewable liquid and gaseous transport fuel of non-biological origin is produced during the same one-hour period as the renewable electricity produced under the renewables power purchase agreement or from renewable electricity from a new storage asset that is located behind the same network connection point as the electrolyser or the installation generating renewable electricity, that has been charged during the same one-hour period in which the electricity under the renewables power purchase agreement has been produced. Following a notification to the Commission, Member States may apply the rules set out in this paragraph from 1 Jul. 2027 for renewable liquid and gaseous transport fuel of non-biological origin produced in their territory.

The temporal correlation condition shall always be considered complied with if the renewable liquid and gaseous transport fuel of non-biological origin is produced during a one-hour period where the clearing price of electricity resulting from single day-ahead market coupling in the bidding zone, as referred to in Article 39(2), point (a) of Commission Regulation (EU) 2015/1222, is lower or equal to EUR 20 per MWh or lower than 0.36 times the price of an allowance to emit 1 tonne of carbon dioxide equivalent during the relevant period for the purpose of meeting the requirements of Directive 2003/87/EC of the European Parliament and of the Council.

### Article 7

### Geographical Correlation

1. The geographical correlation condition referred to in Article 4(2) and (4) shall be considered complied with if at least one of the following criteria relating to the location of the electrolyser is fulfilled:
(a) the installation generating renewable electricity under the renewables power purchase agreement is located, or was located at the time when it came into operation, in the same bidding zone as the electrolyser;
(b) the installation generating renewable electricity is located in an interconnected bidding zone, including in another Member State, and electricity prices in the relevant time period on the day-ahead market referred to in Article 6 in the interconnected bidding zone is equal or higher than in the bidding zone where the renewable liquid and gaseous transport fuel of non-biological origin is produced;
(c) the installation generating renewable electricity under the renewables power purchase agreement is located in an offshore bidding zone that is interconnected with the bidding zone where the electrolyser is located.
2. Without prejudice to Articles 14 and 15 of Regulation (EU) 2019/943, Member States may introduce additional criteria concerning the location of electrolysers and the installation producing renewable electricity to the criteria set out in paragraph 1, in order to ensure compatibility of capacity additions with the national planning of the hydrogen and electricity grid. Any additional criteria shall have no negative impact on the functioning of the internal electricity market.

### Article 8

### Common Rules

Fuel producers shall provide reliable information demonstrating that all requirements set out in Articles 3 to 7 are complied with, including for each hour as relevant:
(a) the amount of electricity used to produce renewable liquid and gaseous transport fuel of non-biological origin, further detailed as follows:
   (i) the amount of electricity sourced from the grid that does not count as fully renewable as well as the proportion of renewable electricity;
   (ii) the amount of electricity that counts as fully renewable because it has been obtained from a direct connection to an installation generating renewable electricity as set out in Article 3;
   (iii) the amount of electricity sourced from the grid that counts as fully renewable in accordance with the criteria set out in Article 4(1);
   (iv) the amount of electricity that counts as fully renewable in accordance with the criteria set out in Article 4(2);
   (v) the amount of electricity that counts as fully renewable in accordance with the criteria set out in Article 4(3);
   (vi) the amount of electricity that counts as fully renewable in accordance with the criteria set out in Article 4(4);
(b) the amount of renewable electricity generated by the installations generating renewable electricity, regardless of whether they are directly connected to an electrolyser and regardless of whether the renewable electricity is used for the production of the renewable liquid and gaseous transport fuel of non-biological origin or for other purposes;
(c) the amounts of renewable and non-renewable liquid and gaseous transport fuel of non-biological origin produced by the fuel producer.

### Article 9

### Certification of Compliance

Regardless of whether the renewable liquid and gaseous transport fuel of non-biological origin is produced inside or outside the territory of the Union, fuel producers may make use of national schemes or international voluntary schemes recognised by the Commission pursuant to Article 30 (4) of Directive (EU) 2018/2001 to demonstrate compliance with the criteria set out in Articles 3 to 7 of this Regulation, in line with Article 8, as relevant.

Where a fuel producer provides evidence or data obtained in accordance with a scheme that has been the subject of a decision in accordance with Article 30 (4) of Directive (EU) 2018/2001, to the extent that such decision covers the demonstrating of compliance of the scheme with Article 27(3), fifth and sixth subparagraphs of that Directive, a Member State shall not require the suppliers of renewable liquid and gaseous transport fuels of non-biological origin to provide further evidence of compliance with the criteria set out in this Regulation.

### Article 10

### Reporting

By 1 Jul. 2028, the Commission shall submit a report to the European Parliament and the Council assessing the impact of the requirements set out in this Regulation, including the impact of temporal correlation, on production costs, greenhouse gas emission savings and the energy system.

### Article 11

### Transitional Phase

Article 5, points (a) and (b) shall not apply until 1 Jan. 2038 to installations producing renewable liquid and gaseous transport fuel of non-biological origin that come into operation before 1 Jan. 2028. This exemption shall not apply to capacity added after 1 Jan. 2028 for the production of renewable liquid and gaseous transport fuel of non-biological origin.

### Article 12

Entry into Force

This Regulation shall enter into force on the twentieth day following that of its publication in the Official Journal of the European Union.

This Regulation shall be binding in its entirety and directly applicable in all Member States. Done at Brussels, 10 Feb. 2023.

For the Commission, The President, Ursula VON DER LEYEN

This section is from: RTFO Guidance for Renewable Fuels of Non-Biological Origin Valid from Jan. 1, 2024, Department of Transport, UK.

### 1. Introduction

RTFO Guidance for Renewable Fuels of Non-Biological Origin petrol, kerosene and diesel. It can also be reacted with nitrogen through the Haber process to produce renewable ammonia.
1.5 If a RFNBO is produced from CO2, the CO2 can come from waste fossil sources (for example, waste flue gases from coal and natural gas power generation or similar industrial combustion processes), from biological sources (e.g. alcohol fermentation or anaerobic digestion) or from atmospheric or naturally-occurring/geothermal sources.
1.6 If the CO2 is generated from fossil energy sources specifically for the purposes of producing transport fuel, this CO2 must be accounted for as fossil CO2 emissions in the reported carbon intensity of the RFNBO (see paragraph 3.13). Upstream supply-chain emissions associated with extracting, refining and transporting the fossil energy source must also be accounted for.
1.7 Where non-waste biogenic CO2 is used to produce a RFNBO, the biomass used to produce the biogenic CO2 is considered to be a feedstock. This feedstock must not have been generated specifically for the purpose of converting it into a fuel for use in transport. This means that:
   the biomass source must be a waste or residue and must meet the relevant sustainability criteria as set out in Chapters 7 and 9 of the RTFO Compliance Guidance—for example, forestry residues must meet the forest criteria
   any and all supply-chain emissions associated with the cultivation, collection, extraction and transport of the biomass source must be accounted for in the carbon intensity of the RFNBO
1.8 When a fuel is produced without biological feedstocks using a mixture of renewable (non-bioenergy) energy and non-renewable (and/or bioenergy²) energy, the resulting fuel is a part RFNBO, part non-RFNBO. Chapter 2 explains how to determine the renewable portion of a RFNBO. ²Biomass-derived electricity cannot be used to generate a RFNBO, as the energy content of a RFNBO has to come from non-bioenergy sources. Biomass-derived electricity used in a hydrogen electrolyser therefore generates a hydrogen fuel that is not a fossil fuel, not a biofuel and not a RFNBO. Similarly, nuclear fission-derived electricity cannot be used to generate a RFNBO, as nuclear power is not listed as a renewable energy source, so again, the resulting fuel would neither be a fossil fuel, nor a biofuel, nor a RFNBO.

### Eligibility for RTFCs

1.9 The renewable portion of a RFNBO which meets the sustainability criteria is eligible for Renewable Transport Fuel Certificates (RTFCs). To apply for RTFCs, suppliers must also meet the wider requirements of the RTFO such as the submission of fuel volumes, carbon and sustainability information, chain of custody requirements and having supplied fuel for use in relevant transport modes in the UK. Suppliers should refer to the RTFO Compliance Guidance for more information.
1.10 Any fuel rewarded under the RTFO must meet the requirements with regards to multiple incentives, outlined in Chapter 6 of the RTFO Compliance Guidance.

### RTFO Guidance for Renewable Fuels of Non-Biological Origin

However, it is permissible for the electricity used in production to have received support, such as through contract for difference (CfD).
1.11 To meet the sustainability criteria, a RFNBO must achieve a 65% greenhouse gas (GHG) emission saving over the whole life-cycle relative to the fossil fuel baseline of 94 gCO2 eq/MJ. This is equivalent to a carbon intensity of 32.9 gCO2 eq/MJ. GHG emissions must be calculated in line with the methodology set out in Chapter 3.
1.12 RFNBOs are not required to meet the land criteria. This means that the following sustainability data is not required:
   whether the fuel met a voluntary scheme that covers the land criteria (though voluntary schemes that cover, for example, the GHG calculation or the chain of custody may be relevant)
   the land use on 1 Jan. 2008
1.13 Should a consignment of RFNBO fail to meet the sustainability criteria then this volume will not be eligible for RTFCs. Moreover, this volume of unsustainable fuel will be added to the supplier's fuel supply from which its obligation is calculated, provided the supplier exceeds the reporting threshold (see the RTFO Compliance Guidance).
1.14 Under the RTFO, consignments of fuel must be reported on an individual feedstock basis (see the RTFO Compliance Guidance). For RFNBOs, the feedstock should be reported as the energy source (e.g. wind power or geothermal energy). Where a mix of non-bioenergy renewable electricity sources have been used in the production of a consignment of RFNBO, it is permissible to report the feedstock as “Renewable electricity mix (non-bioenergy)”. Care must be taken to ensure that the bioenergy is not counted within this mix.
1.15 In line with the treatment of other fuels under the RTFO, suppliers must, on request by the Administrator, be able to provide evidence of a complete chain of custody for a given consignment of fuel from feedstock up to the assessment point. This chain of custody must follow the principles of mass balance. Suppliers can meet this requirement by reporting through a recognised voluntary scheme or by setting up their own chain of custody. More information is provided in the RTFO Compliance Guidance.
1.16 RFNBOs can be classified as development fuels and be eligible for double reward of development RTFCs (dRTFCs) if they meet the criteria set out in Chapter 4 of the RTFO Compliance Guidance.
1.17 Some RFNBOs are eligible for specific reward reflecting their energy content. Specific multipliers and RTFC reward rates are outlined in Chapters 1 and 6 of the RTFO Compliance Guidance.
   2. Determining the Portion of the Fuel that is a RFNBO

### General Conditions

2.1 RFNBOs are generally made using renewable electricity as the energy source. The proportion of the fuel that is considered renewable depends on the electricity it is derived from and whether it meets the criteria for additionality³ or regionalisation⁴ described in this Chapter (paragraphs 2.14 & 2.16). These scenarios are summarised in Table 1 and a flow diagram is provided in FIG. 1. ³“Additionality” refers to whether the renewable energy can be considered additional, in that it is produced from new, upgraded or recommissioned production capacity, and/or it wouldn't have been produced or would have been wasted if it were not consumed in the RFNBO production process.⁴“Regionalisation” refers to whether the grid in question can be reasonably considered to be a separate electricity grid from the relevant national grid.
2.2 If a fuel is made using heat rather than electricity and not all of the heat is from non-bioenergy renewable sources, the amount of eligible RFNBO produced should be calculated as follows:

MJ of RFNBO=MJ of renewable (non-bioenergy) inputs

MJ of all energy inputs×MJ of fuel produced
2.3 The default position where a fuel is made using electricity is that the RFNBO portion of the fuel is equal to the proportion of supply from non-biomass renewable sources in the national grid they are drawing electricity from (Scenario 1, Table 1). This should be calculated using either:
   annual grid averages from the relevant competent authority⁵ for the most recent available full year ⁵For the purposes of this guidance, the “relevant competent authority” might include government departments, regulators or network operators.

### RTFO Guidance for Renewable Fuels of Non-Biological Origin

real-time figures for each 30-minute period, where this data, and the corresponding whole life-cycle carbon intensity (see paragraphs 3.17 & 3.19), is available from a reliable and authoritative sources⁶ (also see paragraph 2.4) ⁶The RTFO Administrator is not currently aware of any robust data sources that provide the necessary real-time data on both the share of non-bioenergy renewables as well as the whole life-cycle carbon intensity taking into account direct generation, well-to-tank and transmission and distribution emissions (see paragraph 3.17). The RTFO Administrator will keep this position under review as new data sources emerge.
An individual production site must use either annual grid averages or real-time figures for fuel supplied within a given obligation year, it is not permitted to switch between the two.
Imported electricity should be taken into account when calculating the proportion supply that is renewable. Imported electricity should be assumed to be non-renewable unless it can be demonstrated otherwise using reliable data from the relevant competent authority.
2.4 Where real-time figures are used, it is permissible to calculate the renewability over periods of continuous production longer than 30 minutes (up to a maximum of 12 months). This average should be weighted based on the electricity consumed in each 30-minute period within the period chosen. The period used should exactly match the period used for determining the weighted average carbon intensity of the electricity consumed (see paragraph 3.16).
2.5 There are three exceptions to the default position set out in paragraph 2.3:
   if a production site is connected to an electricity grid that meets the criteria for regionalisation (paragraph 2.14) then the RFNBO portion of the fuel produced at that site is calculated in the same way as described in paragraph 2.3 but for the regional rather than national grid (Scenario 2, Table 1)
   if the renewable electricity meets the criteria for additionality (paragraph 2.16) then it can be considered additional renewable electricity and the RFNBO portion of the fuel should be calculated as described in paragraph 2.8 (Scenario 3, Table 1)
   if the renewable electricity is not from new generation capacity (paragraph 2.197) but otherwise meets the criteria for additionality (paragraph 2.16) and associated evidence requirements (Table 2) then it can be considered 100% renewable and the RFNBO portion of the fuel should be calculated as described in paragraph 2.8 (Scenario 4, Table 1)⁸
2.6 It is also permitted to produce a consignment of RFNBO using a portion of electricity which meets the criteria for additionality (Scenario 3, Table 1) and a portion of electricity not from new generation capacity but which otherwise meets the criteria for additionality (Scenario 4, Table 1). This mix of Scenario 3 and Scenario 4 is labelled Scenario 5 in Table 1. To make use of this scenario, the following conditions apply: ⁸Note that Scenario 4 cannot be utilised where there is no grid connection.
⁷As per paragraph 2.19, new generation capacity in the context includes new, upgraded, life-extended or recommissioned sites.
   the carbon intensity of the electricity used to produce the RFNBO must be calculated based on a weighted average carbon intensity (paragraph 3.18) over the period chosen by the supplier
   the weighted average should be calculated over the one single period of continuous operation and for the same production facility⁹ ⁹It is permissible during this continuous period of time for one or more of the sources of renewable electricity to be supplying no electricity for some of this period (e.g. solar power would only be contributing during daylight hours) but the electrolyser itself must be continuously operating over the period chosen.
   the maximum period over which the weighted average can be calculated is 12 months
   the finished fuel must meet the 65% greenhouse gas (GHG) emissions saving requirement (paragraph 1.11)
2.7 The GHG emissions associated with the renewable energy consumed must be taken into account when calculating the overall GHG emissions of the RFNBO following the methodology set out in Chapter 3. The factor to be used for each scenario is set out in Table 1 and is zero for wholly additional renewable electricity. See paragraphs 3.14 & 3.15 for more details.
2.8 Where additionality is demonstrated for all of the electricity consumed and all of that electricity is derived from non-bioenergy renewable sources, the fuel can be considered to be 100% RFNBO. Where some of the electricity input is derived from non-renewable or bioenergy sources, the amount of eligible RFNBO produced should be calculated using the following equation:

MJ of RFNBO=MJ of renewable (non-bioenergy) inputs

MJ of all energy inputs×MJ of fuel produced
2.9 In some situations, the criteria for additionality may only be met for a proportion of the electricity supplied, for example where an electricity production site provides insufficient electricity to the grid to meet the demand from the RFNBO production site (as calculated in paragraph 2.24). In such cases, the RFNBO fuel should be divided into two consignments proportional to the amount of electricity supplied that meets the additionality criteria (FIG. 1). The consignment derived from electricity which doesn't meet the additionality criteria should revert to using grid average figures for determining renewability (Scenarios 1 or 2 in Table 1).
2.10 In all cases, suppliers must be able to demonstrate evidence of where the electricity used in fuel production has been sourced from. Where applicable, suppliers must also be able to provide evidence that their circumstances meet the criteria for regionalisation and/or additionality. Such evidence is likely to take the form of commercial documentation such as contracts and meter readings.
2.11 Where a supplier produces both renewable and non-renewable fuel at the same plant, they must keep adequate records that demonstrate that they have followed the principles of mass balance in accounting for and tracking the RFNBO portion.
2.12 Renewability can be re-assigned between different consignments of the same chemically identical product made from a part RFNBO, part non-RFNBO process, as RTFO Guidance for Renewable Fuels of Non-Biological Origin for partial biofuels (see Chapter 4 of the RTFO Compliance Guidance). Renewability cannot be assigned between chemically different products.
2.13 Each consignment of each product must be sold with the correct renewability information. For example, any non-renewable portion must not be sold as renewable fuel. See Chapter 10 of the RTFO Compliance Guidance for more details. This information must match any reassignment which has occurred following paragraph 2.12.

TABLE 1
Summary of scenarios for producing RFNBOs using electricity and corresponding
renewable portions, GHG intensity and evidence requirements. A flow diagram
for determining which scenario applies is provided in FIG. 1.

| | | Methodology for | GHG intensity of | |
|---|---|---|---|---|
| | Description of | calculating RFNBO | the electricity | Evidence |
| Scenario | electricity supply | portion | consumed | requirements |
| 1 | Electricity drawn | Proportional to the | Grid average or real- | Evidence of |
| | from a national grid, | percentage supply from | time GHG intensity | connection to and |
| | no additionality or | non-bioenergy | (national) | electricity supply |
| | regional grid | renewables in the | | from the national |
| | demonstrated | national grid | | grid |
| 2 | Electricity drawn | Proportional to the | Grid average or real- | Evidence of |
| | from a regional grid, | percentage supply from | time GHG intensity | connection to and |
| | no additionality | non-bioenergy | (regionalised) | electricity supply |
| | demonstrated | renewables in the | | from the relevant |
| | | regional grid | | regional grid |
| 3 | Electricity that meets | Proportional to the | Zero | Evidence of |
| | the criteria for | renewable (non- | | additionality relevant |
| | additionality | bioenergy) electricity | | to the specific case |
| | | used in production | | (see paragraph 2.18) |
| | | (paragraph 2.8) | | |
| 4 | Electricity that meets | Proportional to the | Grid average or real- | Evidence of |
| | cases B or C in the | renewable (non- | time GHG intensity | additionality relevant |
| | criteria for | bioenergy) electricity | (national or regional | to the specific case |
| | additionality | used in production | as appropriate) | (see paragraph 2.18), |
| | (paragraph 2.17) | (paragraph 2.8) | | excluding |
| | except it is not from | | | paragraph 2.19 |
| | new generation | | | |
| | capacity (paragraph | | | |
| | 2.19)¹⁰ | | | |
| 5 | A mix of electricity | Proportional to the | A weighted average | As per Scenario 3 |
| | sources, a portion | renewable (non- | of the electricity | and Scenario 4 |
| | meeting scenario 3, | bioenergy) electricity | supplied under the | |
| | and a portion meeting | used in production | two scenarios (see | |
| | scenario 4 | (paragraph 2.8) | paragraph 3.18) | |
| | (see paragraph 2.6) | | | |

¹⁰Note that Scenario 4 cannot be applied to cases A or D in Table 2.

FIG. 1 Flow diagram for determining what methodology to use when determining the proportion of a fuel which can be considered a RFNBO. (*) Scenario 5 corresponds to fuel produced from a mix of electricity meeting Scenario 3 and Scenario 4—see paragraph 2.6.

### Criteria for Regionalisation

2.14 If the electricity grid a production site is connected to can be reasonably considered under the criteria set out in paragraph 2.15 to be a distinct electricity grid from the relevant national grid, suppliers may use data from that electricity grid rather than the national grid in determining the portion of their fuel which is defined as a RFNBO.
2.15 An electricity grid meets the criteria for regionalisation if it meets one of the following conditions:
   a) The relevant competent authority¹¹ considers and manages the grid in question as a physically separate electricity grid which does not directly reflect national boundaries, as is the case in North America and Northern Ireland. ¹¹For the purposes of this guidance, the “relevant competent authority” might include government departments, regulators or network operators.
   b) It can be demonstrated that there is no physical connection between the electricity grid that the production site is connected to and the national grid of the country in which the production site it is located.
   c) It can be demonstrated that there is a systematic grid congestion which prevents renewable energy generated supplied into a sub-grid from being supplied to the wider national grid.

### Criteria for Additionality

2.16 The renewable electricity used in RFNBO production is considered to be “additional renewable energy” if the electricity would not have been produced, or would have been wasted, if not consumed by the RFNBO production site. Suppliers can demonstrate that their process is consuming additional renewable energy if they can provide evidence to satisfy one of the criteria listed in paragraph 2.17.
2.17 Renewable electricity meets the criteria for additionality if it meets one of the following cases (subject to also meeting the conditions and evidence requirements outlined in paragraphs 2.18-2.27 and Table 2):
   a) Direct line, no grid connection: The electricity production site is directly connected to the RFNBO production site with no connection to an electricity grid.
   b) Direct line, grid connection: The electricity production site is connected directly to the fuel production plant and the electricity grid, and the fuel production plant can evidence that their consumption has been provided by the electricity production site without importing electricity from the wider grid.
   c) Additional capacity via an electricity grid: The electricity production site (or a proportion of it) is new, upgraded or recommissioned, and/or it was specifically built, upgraded, life-extended or brought back into service for the purposes of providing electricity via an electricity grid to a given RFNBO production site.
   d) Curtailment and wastage: The renewable electricity used is electricity which would have led to curtailment or been wasted if not consumed by the RFNBO production site.¹² 6 ¹²Curtailment and wastage could involve electricity that has been consumed as part of a balancing mechanism or from a renewable electricity generation facility which would have been curtailed but instead provided electricity to the electrolyser. Exact evidence requirements will depend on the specific case and should be discussed with the Administrator.
   e) Other: The supplier can provide evidence relating to a case not specified above that satisfies the Administrator that the renewable electricity is additional.
2.18 The specific conditions and evidence requirements for cases a to d described in paragraph 2.17 are summarised in Table 2 and described in paragraphs 2.19-2.27. The evidence requirements for case E will depend on the specific situation and will be at the discretion of the Administrator.

TABLE 2
Summary of conditions and evidence requirements
for each case described in paragraph 2.16

| | New | | | | Grid |
|---|---|---|---|---|---|
| | generation | Temporal | Purchase | Grid | congestion |
| | capacity | correlation | agreement | losses | (Par |
| Case | (Par. 2.19) | (Par. 2.21) | (Par. 2.23) | (Par. 2.24) | 2.26) |
| A - Direct line, no grid | □ | □ | □ | □ | □ |
| connection | | | | | |
| B - Direct line, grid connection | □ | □ | □ | □ | □ |
| C - Additional capacity via an | □ | □ | □ | □ | □ |
| electricity grid | | | | | |
| D - Curtailment and wastage | □ | □ | □ | □ | □ |

2.19 For cases A to C in paragraph 2.17, a supplier must demonstrate that the renewable electricity consumed is from new generation capacity at a new, upgraded, life-extended or recommissioned site. For new, upgraded or recommissioned sites, evidence should be provided to demonstrate that the new generation capacity came online at the same time or after the RFNBO production site started operating. For life-extended sites, it should be demonstrated that the electricity production site would have ceased being able to operate without investment as a result of demand from the RFNBO production site and that this life-extension was completed at the same time or after the RFNBO production site started operating.
2.20 At the discretion of the Administrator, an exception to paragraph 2.19 may be permitted if it can be demonstrated that there was a clear intention before the new generating capacity came online for the renewable electricity generated, or a portion of it, to be consumed by the RFNBO production site. This could be demonstrated through planning permissions or other appropriate documentation that show that the fuel production plant was intended to start operation before or at the same time as the new generation capacity came online but was delayed due to unforeseen circumstances
   contractual arrangements (e.g. heads of terms, exclusivity agreements) between the electricity generator and the RFNBO producer, in place before the new generating capacity came online, demonstrating a clear intention for the RFNBO production site to consume electricity from the electricity production site
2.21 For cases C and D in paragraph 2.17, temporal correlation between electricity generation and electricity consumption must be demonstrated. This can be demonstrated over a settlement period of up to 30 minutes.¹³ For each balancing period it must be demonstrated that the amount of renewable electricity consumed by the RFNBO production site was not more than the renewable electricity supplied by the electricity production site(s) exclusively for use by the RFNBO production site. ¹³Please note that this does not mean that there needs to be one consignment of fuel per 30-minute settlement period. Consignments of fuel simply need to have the exact same sets of ‘set of sustainability characteristics’ and associated with a particular reporting month or quarter-see Chapter 7 of the RTFO Compliance guidance. Also see paragraph 2.4.
2.22 For the purposes of demonstrating temporal correlation (paragraph 2.21), it is permissible to use energy storage such as batteries to buffer the electricity supply because the use of electricity by an on-site energy storage asset would be considered electricity consumption by the RFNBO production plant. However, for any electricity stored rather than immediately consumed by an electrolyser, evidence must be provided to demonstrate that this power was stored in the energy storage asset between the time of consumption from the electricity grid to the time of consumption by the electrolyser.
2.23 For cases C and D in paragraph 2.17 a renewables power purchase agreement (PPA), or equivalent contractual mechanism, must be in place between the electricity producer and the RFNBO producer for an amount of electricity equivalent to the amount that is claimed as additional renewable electricity. Both direct/sleeved and portfolio/aggregated PPAs are permitted. Where the same legal entity operates both the electricity and RFNBO production sites a PPA is not required but equivalent documentation must be provided to demonstrate that the claimed renewable electricity was supplied to the grid exclusively for use by the RFNBO production site and was not consumed or sold for use elsewhere.
2.24 For cases C and D in paragraph 2.17, suppliers must take into account grid technical losses when determining the amount of additional renewable electricity supplied. This means that the corresponding amount of renewable electricity (RE) that needs to be supplied to the grid should be calculated as follows:

RE supplied to grid (kwh)=RE extracted from grid (kwh)×(1+grid loss factor)
2.25 For the purposes of paragraph 2.24, suppliers may use a default grid loss factor of
0.1 (i.e. 10%) for UK networks. Alternatively, figures provided by the relevant network operator (or other reliable source) for technical losses may be used.
2.26 For cases C and D in paragraph 2.17, a supplier must be able to demonstrate that there is no systematic grid congestion between the renewable electricity production site(s) and the RFNBO production site.
2.27 For cases C and D in paragraph 2.17 where RFNBOs are produced from additional renewable electricity supplied through the electricity grid in a country where a guarantees of origin (GOs) or equivalent system is in place, suppliers must be able to demonstrate evidence of the retirement of any and all certificates associated with the renewable electricity consumed.

### 3. Greenhouse Gas Emission Methodology for RFNBOs

### Overall Methodology

3.1 Greenhouse gas (GHG) emissions from the production and use of renewable fuels of non-biological origin (RFNBOs) shall be calculated as follows:

E=eec+epp+etd+eu−eccs Where:
E=total emissions from the use of the fuel
   eec=emissions from the extraction or collection of raw materials epp=emissions from production and processing
   etd=emissions from transport and distribution eu=emissions from the fuel in use
   eccs=emission saving from carbon capture and storage
3.2 Emissions from the manufacture of machinery and equipment needed for renewable fuel production shall not be taken into account.
3.3 GHG emissions from renewable fuels, E, shall be expressed in terms of grams of CO₂ equivalent per MJ of fuel, gCO2e/MJ.
3.4 The greenhouse gases taken into account for the purposes of the equation in paragraph 3.1 and shall be CO2, N2O and CH4. For the purpose of calculating CO2 equivalence, those gases shall be valued as follows:
   CO2: 1
   N2O: 298
   CH4: 25
3.5 GHG emissions savings percentage from RFNBOs shall be calculated as follows:

$$( {E}_{FF} - {E}_{RF} )$$

$$GHG Saving ( \% ) = E$$

$$FF \times 100$$

Where:
ERF=total emissions from the RFNBO
EFF=total emissions from fossil fuel comparator for transport
3.6 For the purposes of the calculations referred to in paragraph 3.5, the fossil fuel comparator EFF shall be 94 gCO₂ eq/MJ.

### Guidance on Calculating Individual Components

3.7 Emissions from the extraction or collection of raw materials, eec, include emissions:
   from the extraction process itself
   from the collection of raw materials
   from waste and leakages
   from the production of chemicals or products used in extraction or collection of the raw materials (this includes the additional energy and chemicals used in any carbon capture)
3.8 Water, biogenic CO2, atmospheric CO2 and naturally occurring/geothermal CO2 are considered to have zero lifecycle greenhouse gas emissions up to the process of collection of these materials. Where naturally occurring or geothermal CO2 sources are utilised, evidence must be provided to the Administrator that these emission sources have not been increased by the extraction of the CO2, or that any additional emissions have been included within the extraction emissions, eec. Where biogenic CO2 sources are utilised, evidence should be provided to the Administrator that this CO2 is not already being used to claim a GHG credit in the original bioenergy supply chain and would otherwise have been emitted to atmosphere¹⁴. ¹⁴For example, a biofuels producer cannot claim that any biogenic CO2 used to make a RFNBO constitutes an “emission saving from carbon capture and replacement” within their own biofuel supply chain GHG calculation. This would be an erroneous double claim of GHG savings between biofuel and RFNBO supply chains. Due to their consumption and emission to atmosphere, RFNBOs also do not count as an “emission saving from carbon capture and storage” in the biofuels calculation.
3.9 Suppliers should inform the Administrator if they plan on using naturally occurring, geothermal or biogenic CO2 sources and the Administrator will define what evidence is required to demonstrate compliance with the criteria in 3.8.
3.10 Waste fossil CO2 is also considered to have zero lifecycle greenhouse gas emissions up to the point of collection, provided these materials meet the definition of a waste¹⁵, evidence is provided that the carbon in these materials would have otherwise been ¹⁵‘Waste’ means any substance or object which the holder discards or intends or is required to discard. It excludes substances that have been intentionally modified or contaminated to for the purpose of transforming it into a waste.
   emitted to atmosphere, and provided the facility generating these waste materials does not claim a reduction in their emissions due to this use of the waste fossil CO2.
3.11 If the waste fossil generating facility does wish to claim a reduction in their emissions¹⁶, then these GHG emissions instead need to be assigned to the waste fossil material used to produce the RFNBO and must contribute to eec, in line with the material's global warming potential (e.g. one tonne of waste fossil CO2 would be assigned 1 tCO2e/tonne). Similarly, if the carbon in the material would not otherwise have been emitted to atmosphere (e.g. waste fossil plastic might have sequestered its carbon for centuries in landfill, or as a building insulation material), then the additional greenhouse gas emissions from this avoided sequestration also need to be assigned to the waste fossil material and contribute to eec. ¹⁶For example, from a desire to reduce their costs under the UK's Emission Trading Scheme, or other national taxes on emissions. The waste fossil generating facility cannot claim a GHG savings whilst the RNFBO manufacturer also claims a low carbon fuel is being made, as this would be an erroneous double claim of only one set of GHG savings-since the original fossil carbon is still ultimately ending up in the atmosphere.
3.12 If a supplier wishes to carry out either of the practices outlined in paragraph 3.11 they should contact the Administrator for further guidance.
3.13 Emissions from production and processing, epp, shall include emissions:
   from the production and processing itself
   from waste and leakages
   from the production of chemicals or products used in processing including the CO2 emissions corresponding to the carbon contents of fossil inputs, whether or not actually combusted in the process¹⁷ ¹⁷This includes non-waste fossil CO2 used as an input in producing the RFNBO (see paragraph 1.6).

In accounting for the consumption of methane or natural gas not produced within the fuel production plant, the gas consumed should be assumed to be entirely fossil gas (and appropriate GHG emissions factors applied). However, if it can be demonstrated that an equivalent quantity of renewable gas has been produced and mass balanced to the point of consumption, the GHG emissions intensity of the gas consumed can be taken to be that of the renewable gas. However, the GHG emissions intensity cannot be taken to be less than zero and the requirements of the RTFO Guidance for Biomethane must be met.

Emissions from processing shall include emissions from drying of interim products and materials where relevant.
3.14 Where a RFNBO has been produced using wholly additional renewable electricity (Scenario 3 in Table 1) the GHG emissions associated with the renewable electricity used to produce it can be taken as zero.
3.15 Where a RFNBO has been produced using renewable electricity drawn from an electricity grid and doesn't meet the criteria for additionality outlined in paragraph
2.16 (Scenarios 1, 2 and 4 in Table 1), the GHG intensity of the production and distribution of that electricity can be calculated as either:
   equal to the average emission intensity of that electricity grid for the most recent available full year which shall be taken to be the national grid average unless the criteria for regionalisation are met (paragraph 2.14), in which case the relevant regional grid average shall be used
   equal to the real-time carbon intensity figures for the given 30-minute periods when the RFNBO was produced, where this data is available from reliable and authoritative sources¹⁸ (also see paragraph 3.16) ¹⁸The RTFO Administrator is not currently aware of any robust data sources that provide the necessary real-time data on both the share of non-bioenergy renewables as well as the whole life-cycle carbon intensity taking into account direct generation, well-to-tank and transmission and distribution emissions (see paragraph 3.17). The RTFO Administrator will keep this position under review as new data sources emerge.

In all cases, the figures used should meet the requirements of paragraph 3.17 and match the methodology used to calculate the RFNBO portion of the fuel as described in Chapter 2 and summarised in Table 1. An individual production site must use either annual grid averages or real-time figures for fuel supplied within a given obligation year, it is not permitted to switch between the two.
3.16 Where real-time carbon intensity figures are used following paragraph 3.15 (potentially applicable to Scenarios 1, 2 and 4 in Table 1), it is permissible to calculate an average carbon intensity over continuous periods longer than 30 minutes (up to a maximum of 12 months). This average should be weighted based on the electricity consumed in each 30-minute period within the period chosen. The period used should exactly match the period used for determining the renewability of the RFNBO (see paragraph 2.4).
3.17 For the purposes of paragraph 3.15, figures for the grid average GHG emissions should be sourced from reliable and authoritative sources such as government bodies and/or network operators. The figures used should take into account direct (Scope 2) emissions associated with electricity generation and indirect (Scope 3) emissions associated with the extraction, refining and transportation of primary fuels as well as electricity transmission and distribution.
3.18 Where a RFNBO has been produced using some electricity which meets the criteria for additionality (Scenario 3, Table 1) and some electricity not from new generation capacity but which otherwise meets the criteria for additionality (Scenario 4, Table 1)—Scenario 5 in Table 1—the carbon intensity of the electricity should be calculated based on a weighted average as follows:

$$GHG ElectricityScen 4 \times GHGElec , Scen 4 = Elec , Scen 5$$

Where:

ElectricityScen 3+ElectricityScen 4
GHGElec, Scen 5=The weighted average GHG intensity of the electricity used to produce RFNBO in scenario 5 [gCO2e/MJ]
   GHGElec, Scen 4=The GHG intensity of the electricity used to produce RFNBO in scenario 4 (see paragraph 3.15) [gCO2e/MJ]
   ElectricityScen 3=The total electricity supplied which meets the conditions for Scenario 3 in Table 1 [MJ]
   ElectricityScen 4=The total electricity supplied which meets the conditions for Scenario 4 in Table 1 [MJ]

Please note: For simplicity, the emissions from electricity supplied following scenario 3 are not included in the above equation, as they are taken to be zero (see paragraph 3.14).
3.19 Emissions from transport and distribution, etd, includes emissions from the transport and storage of raw and semi-finished materials, wastes and leakages, and from the storage and distribution of finished materials. Emissions from transport and distribution to be taken into account under eec shall not be covered by etd.
3.20 Emissions from the fuel in use, eu, shall be taken to be zero for RFNBOs.
3.21 Emission saving from carbon capture and storage eccs, that have not already been accounted for in epp, shall be limited to emissions avoided through the capture and permanent storage of otherwise emitted carbon directly related to the transport, processing and distribution of the fuel.¹⁹ Storage must be demonstrably permanent and stable. Examples may include geological sequestration of CO2, the permanent sequestration of solid carbon through inert underground storage, or integration into concrete or cement for use in construction. The capture of any CO2 at the start of the fuel chain, i.e. the collection of raw materials used to manufacture the assessed fuel, cannot be included within this eccs emission saving—nor can any recycling of captured CO2 within the fuel chain—as these are not sequestration activities. ¹⁹Where carbon is sequestered in a form other than CO2, an equivalent quantity of CO2 sequestered should be calculated based on the amount of elemental carbon sequestered. For example, if 1 kg of solid, elemental carbon is captured and sequestered, this would be equivalent to 3.66 kgs of sequestered CO2.

### Allocation of GHG Emissions

3.22 Where a RFNBO production process produces, in combination, the fuel for which emissions are being calculated and one or more other products (‘co-products’), upstream and relevant process step GHG emissions shall be divided between the fuel or its intermediate product and the co-products in proportion to their energy content using the following equation:

$$Fuel allocation factor = Energy in fuel [ MJ ]$$

$$Energy in fuel [ MJ ] + Energy in co - products [ MJ ]$$

In the case of co-products other than electricity and heat, the energy content of products and co-products should be determined based on LHV (wet) of the feedstock, which can be calculated as follows:

$${LHV}_{wet} = {LHV}_{dry} \times ( 1 - \% water content ) - 2.441 \times \% water content$$

The GHG intensity of excess useful heat or excess electricity is the same as the GHG intensity of heat or electricity delivered to the RFNBO production process and is determined from calculating the GHG intensity of all inputs and emissions, including the feedstock and CH₄ and N2O emissions, to and from the cogeneration unit, boiler or other apparatus delivering heat or electricity to the RFNBO production process. In the case of cogeneration of electricity and heat, the calculation is performed following paragraph 3.24.
3.23 For the purposes of the calculation referred to in paragraph 3.22, the emissions to be divided shall be eec and those fractions of epp, etd and eccs that take place up to and including the process step at which a co-product is produced. If any allocation to co-products has taken place at an earlier process step in the life-cycle, the fraction of those emissions assigned in the last such process step to the intermediate fuel product shall be used for those purposes instead of the total of those emissions.

All co-products shall be taken into account for the purposes of that calculation. No emissions shall be allocated to wastes and residues. Co-products that have a negative energy content shall be considered to have an energy content of zero for the purposes of the calculation.

In the case of fuels produced in refineries, other than the combination of processing plants with boilers or cogeneration units providing heat and/or electricity to the processing plant, the unit of analysis for the purposes of the calculation referred to in paragraph 3.22 shall be the refinery.
3.24 Where a cogeneration unit-providing heat and/or electricity to a RFNBO production process for which emissions are being calculated-produces excess electricity and/or excess useful heat, the GHG emissions shall be divided between the electricity and the useful heat according to the temperature of the heat (which reflects the usefulness (utility) of the heat). The useful part of the heat is found by multiplying its energy content with the Carnot efficiency, Ch, calculated as follows:

$${T}_{h} - {T}_{0}$$

$$C {=}_{h} T$$

$$h$$

Where:
Th=Temperature, measured in absolute temperature (kelvin), of the useful heat at point of delivery.
T0=Temperature of surroundings, set at 273.15 kelvin (equal to 0° C.).

If the excess heat is exported for heating of buildings, at a temperature below 150° C. (423.15 kelvin), Ch can alternatively be defined as follows:
Ch=Carnot efficiency in heat at 150° C. (423.15 kelvin), which is: 0.3546

For the purposes of this calculation, the actual efficiencies shall be used, defined as the annual mechanical energy, electricity and heat produced respectively divided by the annual energy input.

For the purposes of this calculation, the following definitions apply:
‘cogeneration’ shall mean the simultaneous generation in one process of thermal energy and electrical and/or mechanical energy;
‘useful heat’ shall mean heat generated to satisfy an economical justifiable demand for heat, for heating or cooling purposes;
‘economically justifiable demand’ shall mean the demand that does not exceed the needs for heat or cooling and which would otherwise be satisfied at market conditions.

This section is from: DEPARTMENT OF THE TREASURY, Federal Register, Vol. 88, No. 246, 89220.

### Internal Revenue Service 26 CFR Part 1

### [REG-117631-23] RIN 1545-BQ97

Section 45V Credit for Production of Clean Hydrogen; Section 48(a)(15) Election To Treat Clean Hydrogen Production Facilities as Energy Property
AGENCY: Internal Revenue Service (IRS), Treasury.
SUMMARY: This document contains proposed regulations relating to the credit for production of clean hydrogen (clean hydrogen production credit) and the energy credit, as established and amended by the Inflation Reduction Act of 2022, respectively. The proposed regulations would provide rules for: determining lifecycle greenhouse gas emissions rates resulting from hydrogen production processes; petitioning for provisional emissions rates; verifying production and sale or use of clean hydrogen; modifying or retrofitting existing qualified clean hydrogen production facilities; using electricity from certain renewable or zero-emissions sources to produce qualified clean hydrogen; and electing to treat part of a specified clean hydrogen production facility instead as property eligible for the energy credit. The proposed regulations would affect all taxpayers who produce qualified clean hydrogen and claim the clean hydrogen production credit, elect to treat part of a specified clean hydrogen production facility as property eligible for the energy credit, or produce electricity from certain renewable or zero-emissions sources used by taxpayers or related persons to produce qualified clean hydrogen. This document also provides notice of a public hearing on the proposed regulations.
   DATES: Written or electronic comments must be received by Feb. 26, 2024. The public hearing on these proposed regulations is scheduled to be held on Mar. 25, 2024, at 10 a.m. (ET).

Requests to speak and outlines of topics to be discussed at the public hearing must be received by Mar. 4, 2024. If no outlines are received by Mar. 4, 2024, the public hearing will be cancelled. Requests to attend the public hearing must be received by Mar. 18, 2024. The public hearing will be made accessible to people with disabilities.

Requests for special assistance during the hearing must be received by Mar. 18, 2024.
ADDRESSES: Commenters are strongly encouraged to submit public comments electronically via the Federal eRulemaking Portal at https://www.regulations.gov (indicate IRS and REG-117631-23) by following the online instructions for submitting comments. Requests for a public hearing must be submitted as prescribed in the “Comments and Requests for a Public Hearing” section. Once submitted to the Federal eRulemaking Portal, comments cannot be edited or withdrawn. The Department of the Treasury (Treasury Department) and the IRS will publish for public availability any comments submitted to the IRS's public docket.

Send paper submissions to: CC: PA: LPD: PR (REG-117631-23), Room 5203, Internal Revenue Service, P.O. Box 7604, Ben Franklin Station, Washington, DC 20044.

### For Further Information Contact:

Concerning these proposed regulations, the Office of Chief Counsel (Passthroughs and Special Industries) at (202) 317-6853 (not a toll-free number); concerning submissions of comments or the public hearing, Vivian Hayes at (202) 317-6901 (not a toll-free number) or by email to publichearings@irs.gov (preferred).

### Supplementary Information

### Background

This document contains proposed regulations to amend the Income Tax Regulations (26 CFR part 1) under sections 45V and 48(a)(15) of the Internal Revenue Code (Code), as added to the Code by section 13204 of Public Law 117-169, 136 Stat. 1818 (Aug. 16, 2022), commonly known as the Inflation Reduction Act of 2022 (IRA).

The IRA added several provisions to the Code related to the production of, and investment in, clean hydrogen, which, along with the provisions of sections 45V and 48(a)(15), are described in part I of this Background section. Part II of this Background section describes a previous request for public comment on these provisions.

### I. IRA Provisions for Clean Hydrogen Production and Investment

This part I describes the credit for production of clean hydrogen as determined under section 45V (section 45V credit) and the irrevocable election to claim an energy credit under section 48 (section 48 credit) in lieu of the section 45V credit. Also described are statutory exceptions to the requirement that electricity be sold to an unrelated person to be eligible for the renewable electricity production credit determined under section 45 (section 45 credit) or the zero-emission nuclear power production credit determined under section 45U (section 45U credit). Under these exceptions, electricity produced by a taxpayer from a qualified facility under section 45(d) or a qualified nuclear power facility under section 45U(b)(1) may be treated as sold by the taxpayer to an unrelated person during the taxable year if the electricity is used by the taxpayer or a related person at a qualified clean hydrogen production facility to produce qualified clean hydrogen.

### A. Section 45V

### 1. Amount of Credit

Section 45V provides a tax credit for the production of qualified clean hydrogen. For purposes of section 38 of the Code, section 45V(a) provides that the clean hydrogen production credit for any taxable year is an amount equal to the product of (i) the kilograms of qualified clean hydrogen produced by the taxpayer during such taxable year at a qualified clean hydrogen production facility during the 10-year period beginning on the date such facility was originally placed in service, and (ii) the applicable amount as determined under section 45V(b) with respect to such hydrogen.

Section 45V(b)(1) provides that, for purposes of section 45V(a)(2), the applicable amount is an amount equal to the applicable percentage of $0.60. If the amount so determined is not a multiple of 0.1 cent, then such amount is rounded to the nearest multiple of 0.1 cent.

Section 45V(b)(2) provides that, for purposes of section 45V(b)(1), the applicable percentage is determined based on the lifecycle greenhouse gas emissions (lifecycle GHG emissions) rate of the process to produce any qualified clean hydrogen as follows: (i) if the lifecycle GHG emissions rate is not greater than 4 kilograms of carbon dioxide equivalent (CO2e) per kilogram of hydrogen, and not less than 2.5 kilograms of CO2e per kilogram of hydrogen, then the applicable percentage is 20 percent; (ii) if the lifecycle GHG emissions rate is less than 2.5 kilograms of CO2e per kilogram of hydrogen, and not less than 1.5 kilograms of CO2e per kilogram of hydrogen, then the applicable percentage is 25 percent; (iii) if the lifecycle GHG emissions rate is less than 1.5 kilograms of CO2e per kilogram of hydrogen, and not less than 0.45 kilograms of CO2e per kilogram of hydrogen, then the applicable percentage is 33.4 percent; and (iv) if the lifecycle GHG emissions rate is less than 0.45 kilograms of CO2e per kilogram of hydrogen, then the applicable percentage is 100 percent.

Section 45V(b)(3) provides that the $0.60 amount in section 45V(a)(1) is adjusted by multiplying such amount by the inflation adjustment factor (as determined under section 45(e)(2), determined by substituting “2022” for “1992” in section 45(e)(2)(B)) for the calendar year in which the qualified clean hydrogen is produced. If any amount as increased under section 45V(b)(3) is not a multiple of 0.1 cent, such amount is rounded to the nearest multiple of 0.1 cent.¹

Section 45V(e)(1) provides that, in the case of any qualified clean hydrogen production facility that satisfies the requirements of section 45V(e)(2), the amount of the section 45V credit with respect to qualified clean hydrogen described in section 45V(b)(2) is equal to the amount determined under section 45V(a) (determined without regard to section 45V(e)(1)) multiplied by five.

A qualified clean hydrogen production facility meets the requirements of section 45V(e)(2) if: (i) the facility began construction before Jan. 29, 2023, and with respect to any taxable year, for any period of such taxable year that is within the 10-year period beginning on the date the facility is originally placed in service, the prevailing wage requirements of section 45V(e)(3)(A) are met for any alteration or repair of the facility that occurs after Jan. 29, 2023 (to the extent applicable);² or (ii) the facility satisfies the prevailing wage and apprenticeship (PWA) requirements of sections 45V(e)(3)(A) and (4).³

Generally, the prevailing wage requirements under section 45V(e)(3)(A) with respect to any qualified clean hydrogen production facility require the taxpayer to ensure that any laborers and mechanics employed by the taxpayer or by any contractor or subcontractor in (i) the construction of such facility, and (ii) with respect to any taxable year, for any portion of such taxable year that is within the 10-year period beginning on the date such facility was originally placed in service, the alteration or repair of such facility, are paid wages at rates not less than the prevailing rates for construction, alteration, or repair of a similar character in the locality in which such facility is located as most recently determined by the Secretary of Labor, in accordance with subchapter IV of chapter 31 of title 40 of the United States Code, commonly known as the Davis-Bacon Act. Correction and penalty rules similar to the rules of section 45(b)(7)(B) also apply.

Section 45V(e)(4) provides that rules similar to the apprenticeship requirements of section 45(b)(8) apply for purposes of section 45V(e)(2).⁴ For purposes of section 45V(a), in the case of a qualified clean hydrogen production facility that does not satisfy the requirements of section 45(e)(2), the amount of the clean hydrogen production credit for any taxable year is $0.12, $0.15, $0.20, or $0.60 per kilogram of qualified clean hydrogen produced (before taking into account any inflation adjustment under section 45V(b)(3)), depending on the lifecycle GHG emissions rate associated with the facility's hydrogen production process. For facilities meeting the requirements of section 45V(e)(2), the credit amount determined under section 45V(a) (as adjusted for inflation subject to section 45V(b)(3)) is multiplied by five.

### 2. Definitions

a. Lifecycle Greenhouse Gas Emissions Section 45V(c)(1)(A) Provides

That, subject to section 45V(c)(1)(B), the term “lifecycle greenhouse gas emissions” has the same meaning given such term under section 211(o)(1)(H) of the Clean Air Act (42 U.S.C. 7545(o)(1)(H)), as in effect on Aug. 16, 2022. Under section 45V(c)(1)(B), the term “lifecycle greenhouse gas emissions” includes emissions only through the point of production (well-to-gate), as determined under the most recent Greenhouse gases, Regulated Emissions, and Energy use in Transportation model, referred to as the “GREET model” commonly and in this document, developed by Argonne National Laboratory, or a successor model as determined by the Secretary of the Treasury or her delegate (Secretary).

b. Qualified Clean Hydrogen

Section 45V(c)(2)(A) provides that the term “qualified clean hydrogen” means hydrogen that is produced through a process that results in a lifecycle GHG emissions rate of not greater than 4 kilograms of CO2e per kilogram of hydrogen. Section 45V(c)(2)(B) further provides that the term “qualified clean hydrogen” does not include any hydrogen unless (i) such hydrogen is produced (A) in the United States (as defined in section 638(1) of the Code) or a United States territory (having the meaning of the term “possession” as defined in section 638(2)), (B) in the ordinary course of a trade or business of the taxpayer, and (C) for sale or use; and (ii) the production and sale or use of such hydrogen is verified by an unrelated party.

c. Provisional Emissions Rate

Section 45V(c)(2)(C) provides that, in the case of any hydrogen for which a lifecycle GHG emissions rate has not been determined for purposes of section 45V, a, taxpayer producing such hydrogen may file a petition with the Secretary for a determination of the lifecycle GHG emissions rate with respect to such hydrogen, which is referred to as a “provisional emissions rate” or PER in the proposed regulations.

d. Qualified Clean Hydrogen Production Facility

Section 45V(c)(3) provides that the term “qualified clean hydrogen production facility” means a facility (i) owned by the taxpayer, (ii) that produces qualified clean hydrogen, and
(iii) the construction of which begins before Jan. 1, 2033.5

### 3. Special Rules

a. Treatment of Facilities Owned by More than One Taxpayer

Section 45V(d)(1) provides that rules similar to the rules of section 45(e)(3) apply for purposes of section 45V. Section 45(e)(3) provides that, in the case of a facility in which more than one person has an ownership interest, except to the extent provided in regulations prescribed by the Secretary, production from the facility is allocated among such persons in proportion to their respective ownership interests in the gross sales from such facility.

b. Coordination With Section 45Q

Section 45V(d)(2) provides that no section 45V credit is allowed with respect to any qualified clean hydrogen produced at a facility that includes carbon capture equipment for which a credit is allowed to any taxpayer as determined under section 45Q (section 45Q credit) for the taxable year or any prior taxable year.

### C. Credit Reduced for Tax-Exempt Bonds

Section 45V(d)(3) provides that rules similar to the rules under section 45(b)(3) (credit reduced for tax-exempt bonds) apply for purposes of section 45V. Section 45V(d)(3) is effective for facilities that begin construction after Aug. 16, 2022. Section 13204(a)(5)(B) of the IRA. Section 45(b)(3) provides that the amount of the credit determined under section 45(a) with respect to any facility for any taxable year (determined after the application of section 45(b)(1) and (2) regarding phaseout and inflation adjustment rules) is reduced by the amount that is the product of the amount so determined for such year and the lesser of 15 percent or a fraction
(A) the numerator of which is the sum, for the taxable year and all prior taxable years, of proceeds of an issue of any obligations the interest on which is exempt from tax under section 103 and that is used to provide financing for the qualified facility, and
(B) the denominator of which is the aggregate amount of additions to the capital account for the qualified facility for the taxable year and all prior taxable years. Section 45(b)(3) further provides that the amounts determined under section 45(b)(3) for any taxable year are determined as of the close of the taxable year.
   d. Modification of Existing Facilities

Section 45V(d)(4) provides that for purposes of section 45V(a)(1), in the case of any facility that (A) was originally placed in service before Jan. 1, 2023, and, prior to the modification described in section 45V(d)(4)(B), did not produce qualified clean hydrogen, and (B) after the date such facility was originally placed in service (i) is modified to produce qualified clean hydrogen, and (ii) amounts paid or incurred with respect to such modification are properly chargeable to the capital account of the taxpayer, such facility is deemed to have been originally placed in service as of the date the property required to complete the modification described in section 45V(d)(4)(B) is placed in service. Section 45V(d)(4) is effective for modifications made after Dec. 31, 2022. See section 13204(a)(5)(C) of the IRA.

### B. Electricity Used at a Qualified Clean Hydrogen Production Facility

Section 45(e)(13) provides that electricity produced by the taxpayer is treated as sold by such taxpayer to an unrelated person during the taxable year if (i) such electricity is used during such taxable year by the taxpayer or a person related to the taxpayer at a qualified clean hydrogen production facility (as defined in section 45V(c)(3)) to produce qualified clean hydrogen (as defined in section 45V(c)(2)); and (ii) such use and production is verified (in such form or manner as the Secretary may prescribe) by an unrelated party. Section 45(e)(13) is effective for electricity produced after Dec. 31, 2022. See section 13204(b)(3) of the IRA.

Section 45U(c)(2) provides that rules similar to the rules of section 45(e)(13) apply for purposes of section 45U. Generally, section 45U is effective for electricity produced at a qualified nuclear power facility and sold after Dec. 31, 2023, in taxable years beginning after that date.

### C. Election to Treat Clean Hydrogen Production Facilities as Energy Property

Section 48(a)(15)(A)(i) provides that, in the case of any qualified property (as defined in section 48(a)(5)(D)) that is part of a specified clean hydrogen production facility, such property is treated as energy property. Section 48(a)(15)(A)(ii) provides that the energy percentage of the basis of any qualified property that is treated as energy property is, for a facility that is designed and reasonably expected to produce qualified clean hydrogen with a lifecycle GHG emissions rate that is: (i) not greater than 4 kilograms of CO2e per kilogram of hydrogen, and not less than 2.5 kilograms of CO2e per kilogram of hydrogen, 1.2 percent; (ii) less than 2.5 kilograms of CO2e per kilogram of hydrogen, and not less than 1.5 kilograms of CO2e per kilogram of hydrogen, 1.5 percent; (iii) less than 1.5 kilograms of CO2e per kilogram of hydrogen, and not less than 0.45 kilograms of CO2e per kilogram of hydrogen, 2 percent; and (iv) less than 0.45 kilograms of CO2e per kilogram of hydrogen, 6 percent. Under section 48(a)(9), the amount of the section 48 credit determined for a specified clean hydrogen production facility under section 48(a)(15) is multiplied by five if the facility meets the requirements of section 48(a)(9)(B) (regarding application of certain maximum net output levels of electrical or thermal energy or prevailing wage and apprenticeship requirements). However, the domestic content and energy communities bonuses under section 48(a)(12) and (a)(14) do not apply to a specified clean hydrogen production facility.

Section 48(a)(15) is effective for property placed in service after Dec. 31, 2022, and for any property the construction of which began before Jan. 1, 2023, only to the extent of the basis thereof attributable to construction, reconstruction, or erection after Dec. 31, 2022. See section 13204(c)(3) of the IRA.

### 1. Denial of Production Credit

Section 48(a)(15)(B) provides that no section 45V credit or section 45Q credit is allowed for any taxable year with respect to any specified clean hydrogen production facility or any carbon capture equipment included at such facility.

### 2. Specified Clean Hydrogen Production Facility

Section 48(a)(15)(C) provides that the term “specified clean hydrogen production facility” means any qualified clean hydrogen production facility (as defined in section 45V(c)(3)) (i) that is placed in service after Dec. 31, 2022, (ii) with respect to which (I) no section 45V credit or section 45Q credit has been allowed, and (II) the taxpayer makes an irrevocable election to have section 48(a)(15) apply, and (iii) for which an unrelated third party has verified (in such form or manner as the Secretary may prescribe) that such facility produces hydrogen through a process that results in lifecycle GHG emissions that are consistent with the hydrogen that such facility was designed and expected to produce under section 48(a)(15)(A)(ii).

### 3. Qualified Clean Hydrogen

Section 48(a)(15)(D) provides that, for purposes of section 48(a)(15), the term “qualified clean hydrogen” has the meaning given such term by section 45V(c)(2).

### 4. Regulations

Section 48(a)(15)(E) provides the Secretary authority to issue regulations or other guidance as she determines necessary to carry out the purposes of section 48, including regulations or other guidance that recaptures so much of any section 48 credit allowed as exceeds the amount of the credit that would have been allowed if the expected production were consistent with the actual verified production (or all of the credit so allowed in the absence of verification).

### II. Previous Request for Comments

On Nov. 3, 2022, the Treasury Department and the IRS published Notice 2022-58, 2022-47 I.R.B. 483. The notice requested general comments on issues arising under section 45V and the associated clean hydrogen production and investment incentives in sections 45 and 48. The notice also requested specific comments concerning (i) definitions; (ii) boundaries of the well-to-gate analysis for determining the lifecycle GHG emissions rate; (iii) the PER process; (iv) recordkeeping and reporting; (v) verification by unrelated parties; and (vi) coordination with sections 45, 48, and 45Q. The Treasury Department and the IRS received over 200 comments from industry participants, environmental groups, individuals, and other stakeholders. The Treasury Department and the IRS appreciate the commenters' interest and engagement on these issues. These comments have been carefully considered in the development of these proposed regulations.

### Explanation of Provisions

### I. Overview

Proposed § 1.45V-1 would provide guidance, including definitions of key terms used in proposed §§ 1.45V-1 through 1.45V-6 and 1.48-15, to determine the eligibility for, and the amount of, the section 45V credit for the production of qualified clean hydrogen. The term “section 45V credit” would be provided at § 1.45V-1(a)(12) and mean the credit for production of clean hydrogen determined under section 45V, so much of sections 6417 and 6418 that relate to section 45V, and the section 45V regulations. The term “section 45V regulations” would be provided at proposed § 1.45V-1(a)(13) to mean the provisions of §§ 1.45V-1 through 1.45V-6 and so much of the regulations under sections 6417 and 6418 that relate to the section 45V credit.

Proposed § 1.45V-2 would provide special rules for purposes of the section 45V credit. Proposed § 1.45V-4 would provide procedures for determining lifecycle GHG emissions rates for qualified clean hydrogen. Proposed § 1.45V-5 would provide procedures for verification of qualified clean hydrogen production and sale or use. Proposed § 1.45V-6 would provide rules for determining the placed in service date for an existing facility that is modified or retrofitted to produce qualified clean hydrogen. Additionally, proposed § 1.48-15 would provide procedures for a taxpayer to elect to treat any qualified property that is part of a specified clean hydrogen production facility as energy property for purposes of the section 48 credit.

### I. Definitions

Proposed § 1.45V-1(a)(2) through (13) would provide generally applicable definitions of terms for purposes of section 45V, so much of sections 6417 and 6418 of the Code that relate to the section 45V credit, and the section 45V regulations. The definitions for applicable amount, applicable percentage, and qualified clean hydrogen production facility would generally reflect the statutory definitions without additional elaboration on the terms. See proposed § 1.45V-1(a)(2), (3), and (10). This part II discusses those definitions in the proposed regulations that provide additional clarity beyond the statutory language.

### A. Facility

Proposed § 1.45V-1(a)(7)(i) would provide that, for purposes of the definition of a qualified clean hydrogen production facility provided at section 45V(c)(3), the term “facility” means a single production line that is used to produce qualified clean hydrogen. A “single production line” would include all components of property that function interdependently to produce qualified clean hydrogen. Components of property are functionally interdependent if the placing in service of each component is dependent upon the placing in service of each of the other components to produce qualified clean hydrogen. Proposed § 1.45V-1(a)(7)(ii) would provide that a facility does not include equipment used to condition or transport hydrogen beyond the point of production. A facility would also not include electricity production equipment used to power the hydrogen production process, including any carbon capture equipment associated with the electricity production process. Proposed § 1.45V-1(a)(7)(iii) would provide that components that have a purpose in addition to the production of qualified hydrogen may be part of a facility if such components function interdependently with other components to produce qualified clean hydrogen. Proposed § 1.45V-1(a)(7)(iv) would provide an example to illustrate the definition of facility for purposes of section 45V.

B. Lifecycle Greenhouse Gas Emissions Proposed § 1.45V-1(a)(8)(i) would incorporate the statutory definition of the term “lifecycle greenhouse gas emissions” under section 45V(c)(1)(A) and (B), specifically providing that the term has the same meaning as that in 42 U.S.C. 7545(o)(1)(H) as in effect on Aug. 16, 2022, and includes emissions only through the point of production (well-to-gate) as determined under the most recent GREET model.

### C. Most Recent GREET Model

Proposed § 1.45V-1(a)(8)(ii) would provide that the term “most recent GREET model” means the latest version of 45VH2-GREET developed by Argonne National Laboratory (ANL) that is publicly available on the first day of the taxpayer's taxable year in which the qualified clean hydrogen for which the taxpayer is claiming the section 45V credit was produced.⁶ After consultation with the Department of Energy (DOE), the Treasury Department and the IRS believe that the use of the latest version of 45VH2-GREET would be appropriate because it is tailored to the administration of the section 45V tax credit and includes features that make it easy to use for taxpayers. Use of the latest version of 45VH2-GREET would also ensure that the pathways and approaches provided for determining well-to-gate emissions for various hydrogen production processes are of sufficient methodological certainty to be appropriate for determining eligibility of tax credits. The latest version of 45VH2-GREET is the only variant of GREET that is suitable for use and may be used to determine emissions rates for purposes of the section 45V credit. Further, proposed § 1.45V-1(a)(8)(ii) would provide that, if a version of 45VH2-GREET becomes publicly available after the first day of the taxable year of production (but still within such taxable year), then the taxpayer may, in its discretion, treat such version of 45VH2-GREET as the most recent GREET model.

Instead of defining “most recent GREET model” to be the latest version of 45VH2-GREET that is publicly available on the first day of the taxpayer's taxable year, an alternative approach would be for the Secretary to determine that the latest version of 45VH2-GREET is an appropriate “successor model,” as provided by section 45V(c)(1)(B), for the purpose of administering the section 45V tax credit. The Treasury Department and the IRS request comment on these approaches.

### D. Emissions Through the Point of Production (Well-to-Gate)

Proposed § 1.45V-1(a)(8)(iii) would provide that, for purposes of section 45V(c)(1)(B) and proposed § 1.45V-1(a)(8)(i), the term “emissions through the point of production (well-to-gate)” means the aggregate lifecycle GHG emissions related to hydrogen produced at a hydrogen production facility during the taxable year through the point of production. It includes emissions associated with feedstock growth, gathering, extraction, processing, and delivery to a hydrogen production facility. It also includes the emissions associated with the hydrogen production process, inclusive of the electricity used by the hydrogen production facility and any capture and sequestration of carbon dioxide generated by the hydrogen production facility.

### E. Qualified Clean Hydrogen

Proposed § 1.45V-1(a)(9)(i) would incorporate the statutory definition of the term “qualified clean hydrogen” provided at section 45V(c)(2)(A) and (B), including the requirement that the hydrogen be produced (i) in the United States or a U.S. territory (meaning possession as provided in section 638(2)); (ii) in the ordinary course of a trade or business of the taxpayer; and
(iii) for sale or use. Proposed § 1.45V-1(a)(9)(i)(B) would provide that, to qualify as qualified clean hydrogen, the production and sale or use of such hydrogen must be verified by an unrelated party (as required by section 45V(c)(2)(B)(ii)). See also proposed § 1.45V-5. Proposed § 1.45V-1(a)(9)(ii) would provide that for purposes of section 45V(c)(2)(B)(i)(III) and proposed § 1.45V-1(a)(9)(i)(C) the term “for sale or use” means for the primary purpose of making such hydrogen ready and available for sale or use. Storage of hydrogen before its sale or use would not disqualify such hydrogen from being considered produced for sale or use.

### II. Rules of General Applicability

Proposed § 1.45V-1(b)(1) would provide the general rules for calculating the amount of the section 45V credit. Proposed § 1.45V-1(b)(2) would provide that, for purposes of section 45V(a)(1) and proposed § 1.45V-1(b)(1), the term “taxpayer” means the taxpayer that owns the qualified clean hydrogen production facility at the time of the facility's production of qualified clean hydrogen with respect to which the section 45V credit is claimed, regardless of whether such taxpayer is treated as a producer under section 263A of the Code or under any other provision of law with respect to such qualified clean hydrogen. This rule is intended to avoid unintended consequences that could arise with respect to contract manufacturing and tolling arrangements under § 1.263A-2(a)(1)(ii)(A) and (a)(1)(ii)(B)(1) in the context of the section 45V credit, as well as to simplify the administration of the section 45V credit and provide clarity for taxpayers.

Proposed § 1.45V-1(c) would provide that, subject to any applicable Code sections that may limit the section 45V credit amount, the section 45V credit for any taxable year is determined with respect to the qualified clean hydrogen produced by the taxpayer during that taxable year although the verification of the production and sale or use of such hydrogen may occur in a later taxable year. However, the taxpayer would not be eligible to claim the section 45V credit until all relevant verification requirements, and the verification itself, have been completed. Therefore, despite such verification occurring in a later taxable year, the section 45V credit would be properly claimed with respect to the taxable year of hydrogen production and subject to the general period of limitations for filing a claim for credit or refund. Thus, if verification occurred after the extended return filing deadline for the taxable year in which the hydrogen was produced, the taxpayer would need to file an amended return or administrative adjustment request (AAR) to claim the section 45V credit for such hydrogen. The Treasury Department and the IRS request comments on this proposed rule, specifically whether taxpayers anticipate they will be able to complete all the requirements for claiming the section 45V credit, including the proposed requirements for verification specified below, by the extended return filing deadline for the taxable year of hydrogen production. If taxpayers anticipate that they will not be able to complete all the requirements by such filing deadline, comments are also requested on what specific alternatives to the proposed rule, if any, should be considered and their rationale.

### III. Special Rules

Proposed § 1.45V-2(a) would address the coordination between the section 45V credit and the section 45Q credit. Proposed § 1.45V-2(b)(1) would provide an anti-abuse rule that would make the section 45V credit unavailable in extraordinary circumstances in which, based on a consideration of all the relevant facts and circumstances, the primary purpose of the production and sale or use of qualified clean hydrogen is to obtain the benefit of the section 45V credit in a manner that is wasteful, such as the production of qualified clean hydrogen that the taxpayer knows or has reason to know will be vented, flared, or used to produce hydrogen.

If the cost of producing qualified clean hydrogen were to be less than the amount of the section 45V credit that would be available with respect to such hydrogen, the Treasury Department and the IRS are concerned that taxpayers may have an incentive to produce qualified clean hydrogen solely for the purpose of exploiting the section 45V credit in a manner that is inconsistent with a purpose of section 45V, which is to provide an incentive to produce qualified clean hydrogen for a productive use. Producing and selling or using qualified clean hydrogen with the primary purpose of obtaining the benefit of the section 45V credit in a wasteful manner would not, in certain circumstances, satisfy the requirement in section 45V(c)(2)(B)(i)(II) for hydrogen to be produced in the ordinary course of a trade or business of the taxpayer. Proposed § 1.45V-2(b)(2) would provide an example illustrating this anti-abuse rule.

### IV. Procedures for Determining Lifecycle Greenhouse Gas Emissions Rates for Qualified Clean Hydrogen

Proposed § 1.45V-4(a) would provide that the amount of the section 45V credit is determined under section 45V(a) and proposed § 1.45V-1(b) based upon the lifecycle GHG emissions rate (as defined in proposed § 1.45V-1(a)(8)(i)) of all hydrogen produced at a qualified clean hydrogen production facility (as defined in proposed § 1.45V-1(a)(10)) during the taxable year. This determination is made following the close of each such taxable year and must include all hydrogen production from the year. Further, proposed § 1.45V-4(a) would provide that the lifecycle GHG emissions rate for purposes of section 45V is determined under the most recent GREET model (as defined in proposed § 1.45V-1(a)(8)(ii)).

Additionally, proposed § 1.45V-4(a) would provide that in the case of any hydrogen for which a lifecycle GHG emissions rate has not been determined under the most recent GREET model for purposes of section 45V, a taxpayer producing such hydrogen may file a petition with the Secretary for a determination of the lifecycle GHG emissions rate with respect to such hydrogen (a provisional emissions rate (PER)).

### A. GREET Model

Proposed § 1.45V-4(b) would provide procedures to calculate the lifecycle GHG emissions rate of hydrogen produced at a hydrogen production facility using the most recent GREET model as defined in proposed § 1.45V-1(a)(8)(ii) (referring to 45VH2-GREET). Proposed § 1.45V-4(b) would provide that for each taxable year during the period described in section 45V(a)(1), a taxpayer claiming the section 45V credit determines the lifecycle GHG emissions rate of hydrogen produced at a hydrogen production facility using the most recent GREET model. Such a determination is made separately for each hydrogen production facility the taxpayer owns and as of the close of each respective taxable year in which such production occurs (that is, such a determination is made for that taxable year's total hydrogen production at a hydrogen production facility). Proposed § 1.45V-4(b) would provide that in calculating the lifecycle GHG emissions rate for purposes of determining the amount of the section 45V credit, the taxpayer must accurately enter all information about its qualified clean hydrogen production facility requested within the interface of 45VH2-GREET in compliance with the most recent version of the Guidelines to Determine Well-to-Gate Greenhouse Gas (GHG) Emissions of Hydrogen Production Pathways using 45VH2-GREET (GREET User Manual), which currently can be found at: www.energy.gov/45vresources. Current 45VH2-GREET, previous versions of 45VH2-GREET, and subsequent updates to 45VH2-GREET can be found at www.energy.gov/45vresources. Proposed § 1.45V-4(b) would provide that information for the location of 45VH2-GREET and accompanying documentation will be included in the instructions to the Form 7210, Clean Hydrogen Production Credit. productively utilized or sold) and allocates emissions to those co-products (rather than to the hydrogen production) as described in Guidelines to Determine Well-to-Gate Greenhouse Gas (GHG) Emissions of Hydrogen Production Pathways using 45VH2-GREET 2023. As described in that document, 45VH2-GREET utilizes the “system expansion” approach for all co-products if possible, but restricts the amount of steam co-product that reformers can claim based on the quantity of steam that an optimally designed reformer is expected to be capable of producing based on modeling from the National Energy Technology Laboratory.⁷ This restriction is included within the model to avoid incentivizing generation or over-production of hydrogen co-products like steam to enable access to a higher tax credit value by artificially reducing the calculated carbon intensity of the hydrogen (for example, by combustion of fuel onsite that is unnecessary for hydrogen production). The Treasury Department and the IRS seek comments on this approach, including whether alternative co-product accounting methods, such as physical allocation (for example, energy allocation or mass allocation) or allocation based on other characteristics, would better ensure well-to-gate carbon intensity of hydrogen production is accurately represented.

### B. Provisional Emissions Rate

Proposed § 1.45V-4(c)(1) would provide that, for purposes of section 45V(c)(2)(C) and proposed § 1.45V-4(a), the term “provisional emissions rate” or “PER” means the lifecycle GHG emissions rate of the process by which qualified clean hydrogen is produced by the taxpayer at a qualified clean hydrogen production facility as determined by the Secretary under proposed § 1.45V-4(c). Proposed § 1.45V-4(c)(2)(i) would provide that a taxpayer may not file a petition with the Secretary for a PER unless a lifecycle GHG emissions rate has not been determined under the most recent GREET model (as defined in proposed § 1.45V-1(a)(8)(ii) as 45VH2-GREET) for hydrogen produced by the taxpayer at a hydrogen production facility. Proposed § 1.45V-4(c)(2)(i) would further provide that a lifecycle GHG emissions rate has not been determined under the most recent GREET model with respect to hydrogen produced by the taxpayer at a hydrogen production facility if it uses a hydrogen production pathway that is not included in the most recent GREET model—that is, if either the feedstock used by such facility or the facility's hydrogen production technology is not included in the most recent GREET model.

For example, the initial version of 45VH2-GREET does not model every possible biomass fuel as a feedstock nor does it represent all hydrogen production technologies that are currently of commercial interest or that may be commercially viable in the future, including geologic hydrogen, trigeneration, or other technologies if sufficient technical analysis had not been completed at the time the model was published. A taxpayer with one of these types of hydrogen production pathways may use the PER process to obtain carbon intensities because such hydrogen production technologies or feedstocks are not currently in 45VH2-GREET. To use the PER process, the hydrogen production pathway that the taxpayer is utilizing must either be consuming a feedstock that is not represented in 45VH2-GREET (for example, a type of biomass that is not represented in the model) or using a hydrogen production technology that is not represented in 45VH2-GREET (for example, technologies used to drill for geologic hydrogen or trigeneration that can use a fuel cell to co-produce hydrogen, heat, and power). A taxpayer may not use the PER process if its feedstock and hydrogen production technology are represented in 45VH2-GREET, even if the taxpayer disagrees with the underlying assumptions (that is, background data) or calculation approach used by the most recent 45VH2-GREET. Future versions of 45VH2-GREET may include additional hydrogen production pathways, such as geologic hydrogen, as sufficient technical information becomes available to provide consistent treatment in 45VH2-GREET.

Proposed § 1.45V-4(c)(2)(i) would also provide that, if a taxpayer's request for an emissions value from the DOE under proposed § 1.45V-4(c)(5) with respect to the hydrogen produced by the taxpayer at a hydrogen production facility is pending at the time such hydrogen production facility's pathway is included in an updated version of 45VH2-GREET, the taxpayer's request for an emissions value will be automatically denied.

Proposed § 1.45V-4(c)(2)(ii) would specify that, notwithstanding proposed § 1.45V-1(a)(8)(ii), for the taxable year in which the hydrogen production pathway the taxpayer uses to produce hydrogen at a qualified clean hydrogen production facility is first included in an updated version of 45VH2-GREET, the updated version of 45VH2-GREET will be considered the most recent GREET model with respect to the hydrogen produced by the taxpayer at the hydrogen production facility.

### 1. Process for Filing a Provisional Emissions Rate Petition

Proposed § 1.45V-4(c)(3) would provide that a taxpayer petitions the Secretary for a PER by attaching a PER petition to its Federal income tax return or information return for the first taxable year of hydrogen production ending within the 10-year period described in section 45V(a)(1) for which the taxpayer claims the section 45V credit for hydrogen to which the PER petition relates and for which a lifecycle GHG emissions rate has not been determined, as defined under proposed § 1.45V-4(c)(2)(i). Proposed § 1.45V-4(c)(3) would provide that a PER petition must contain (i) an emissions value obtained from the DOE setting forth the DOE's analytical assessment of the lifecycle GHG emissions rate associated with the facility's hydrogen production pathway, and (ii) a copy of the taxpayer's request to the DOE for an emissions value, including any information that the taxpayer provided to the DOE pursuant to the emissions value request process specified in proposed § 1.45V-4(c)(5). Proposed § 1.45V-4(c)(3) would further provide that, if the taxpayer obtained more than one emissions value from the DOE, then the PER petition must contain the emissions value setting forth the lifecycle GHG emissions rate of the hydrogen for which the section 45V credit is claimed on the Form 7210, Clean Hydrogen Production Credit, to which the PER petition is attached.

### 2. Provisional Emissions Rate Determination

Proposed § 1.45V-4(c)(4) would provide that upon the IRS's acceptance of the taxpayer's Federal income tax return or information return containing a PER petition, the emissions value specified on such PER petition will be deemed accepted. Proposed § 1.45V-4(c)(4) would provide that a taxpayer would be able to rely upon an emissions value provided by the DOE for purposes of calculating and claiming a section 45V credit, provided that any information, representations, or other data provided to the DOE in support of the request for an emissions value are accurate. Proposed § 1.45V-4(c)(4) would also state that the IRS's deemed acceptance of such emissions value is the Secretary's determination of the PER. Proposed § 1.45V-4(c)(4) would state, however, that the production and sale or use of such hydrogen must be verified by an unrelated party under section 45V(c)(2)(B)(ii) and in compliance with the procedures provided in proposed § 1.45V-5. Proposed § 1.45V-4(c)(4) would state that such verification and any information, representations, or other data provided to the DOE in support of the request for an emissions value are subject to later examination by the IRS.

### 3. Department of Energy Emissions Value Request Process

Proposed § 1.45V-4(c)(5) would provide that, in order to obtain an emissions value, an applicant must submit a request for an emissions value following procedures that will be specified by the DOE. The emissions value request process will open on Apr. 1, 2024. Proposed § 1.45V-5 would also provide that emissions values will be evaluated using the same well-to-gate system boundary that is employed in 45VH2-GREET, as proposed in § 1.45V-1(a)(8)(iii). Additionally, proposed § 1.45V-5 would also provide that if applicable, background data parameters in 45VH2-GREET would also be treated as background data (with fixed values that an applicant cannot change) in the emissions value request process. The emissions value request process would be subject to any guidance issued under section 45V, including any guidance related to the use of EACs.

Proposed § 1.45V-4(c)(5) would also provide that an applicant may request an emissions value from the DOE only after a front-end engineering and design (FEED) study or similar indication of project maturity, such as project specification and cost estimation sufficient to inform a final investment decision, has been completed for the hydrogen production facility.

Forthcoming guidance from the DOE, which will be published prior to the Apr. 1, 2024, opening of the emissions value request process, will specify criteria the DOE intends to consider in evaluating whether a FEED study has been completed or that a similar indicator of project readiness has been achieved. The Treasury Department and the IRS seek comments on appropriate indicators of project readiness that should be in place before an applicant requests an emissions value to ensure that requests correspond to hydrogen production facilities with significant commercial interest, and standards against which these indicators could be measured.

Additionally, proposed § 1.45V-4(c)(5) would provide that the DOE may decline to review applications that are not responsive, including those applications that use a hydrogen production technology and feedstock already in GREET or applications that are incomplete. Guidance and procedures for applicants to request and obtain an emissions value from the DOE will be published by the DOE,⁸ including a process for, under limited circumstances, a revision to the DOE's initial analytical assessment of an emissions value, such as to address revised technical information or facility design and operation.

### 4. Effect of Provisional Emissions Rate

Proposed § 1.45V-4(c)(6) would provide that a taxpayer may use a PER determined by the Secretary to calculate the amount of the clean hydrogen production credit under section 45V(a) and proposed § 1.45V-1(b) with respect to qualified clean hydrogen produced by the taxpayer at a qualified clean hydrogen production facility beginning with the first taxable year in which a PER determined by the Secretary has been obtained and for any subsequent taxable year during the 10-year period beginning on the date such facility was originally placed in service, provided all other requirements of section 45V are met, and until the lifecycle GHG emissions rate of such hydrogen has been determined (for purposes of section 45V(c)(2)(C)) under the most recent GREET model (as defined in proposed § 1.45V-1(a)(8)(ii)).

Proposed § 1.45V-4(c)(6) would provide that the Secretary's PER determination is not an examination or an inspection of books of account for purposes of section 7605(b) of the Code, and would not preclude or impede the IRS (under section 7605(b) or any administrative provisions adopted by the IRS) from later examining a return or inspecting books or records with respect to any taxable year for which the section 45V credit is claimed. Proposed § 1.45V-4(c)(6) would provide that a verification report submitted under section 45V(c)(2)(B)(ii) and § 1.45V-5 and any information, representations, or other data provided to the DOE in support of an emissions value request would still be subject to IRS examination. Further, proposed § 1.45V-4(c)(6) would state that a PER determination would not mean that the IRS has determined that all the requirements of section 45V have been satisfied for any taxable year, nor would it create an inference that such a presumption exists.

### C. Use of Energy Attribute Certificates

The Treasury Department and the IRS, in consultation with the United States Environmental Protection Agency (EPA) and the DOE, have preliminarily determined that energy attribute certificates (EACs) may be considered under certain conditions in documenting purchased electricity inputs and assessing emissions impacts of electricity used in the production of hydrogen for purposes of the section 45V credit.⁹ For purposes of these proposed regulations, the term “EACs” refers solely to EACs that represent attributes of electricity generated by a specific facility or source. The EPA has advised that EACs are an established mechanism for substantiating the purchase of electricity from zero GHG-emitting sources and that the use of EACs with attributes that meet certain criteria is an appropriate way for the Treasury Department and the IRS to document electricity inputs to electrolytic hydrogen-production. Such EACs can also serve as a reasonable methodological proxy for quantifying certain indirect emissions associated with electricity for purposes of the section 45V credit. Similarly, the EPA and the DOE have advised that it would be appropriate for EACs with attributes that meet certain criteria to be included as part of the basis for assessing emissions for purposes of the section 45V credit. The Treasury Department and the IRS have preliminarily determined that the use of certain EACs, which satisfy the qualifying EAC requirements (as specified in proposed § 1.45V-4(d)(3)), is consistent with the references to subparagraph (H) of section 211(o)(1) of the Clean Air Act (42 U.S.C. 7545(o)(1)(H)) and the most recent GREET Model, as specified in section 45V(c)(1).

Proposed § 1.45V-4(d)(1) would provide that for purposes of section 45V, if a taxpayer determines a lifecycle GHG emissions rate for hydrogen produced at a hydrogen production facility using the most recent GREET model (as defined in proposed § 1.45V-1(a)(8)(ii)) or a PER (as defined in proposed § 1.45V-4(c)(1)), then the taxpayer may reflect in GREET or include in a PER such hydrogen production facility's use of electricity as being from a specific electricity generating facility rather than the being from the regional electricity grid (as represented in 45VH2-GREET) only if the taxpayer acquires and retires a qualifying EAC (as defined in proposed § 1.45V-4(d)(2)(iv)) for each unit of electricity that the taxpayer claims from such source. For example, one megawatt-hour of electricity used to produce hydrogen would need to be matched with one megawatt-hour of qualifying EACs. The Treasury Department and the IRS seek comments on whether a different treatment would be more appropriate to account for transmission and distribution line losses.

Further, proposed § 1.45V-4(d)(1) would provide that to satisfy this requirement, a taxpayer's acquisition and retirement of qualifying EACs must also be recorded in a qualified EAC registry or accounting system (as defined in proposed § 1.45V-4(d)(2)(v)) so that the acquisition and retirement of such EACs may be verified by a qualified verifier (as defined in proposed § 1.45V-5(h)). The double counting of EACs and their underlying attributes would undermine the integrity of lifecycle GHG emissions rate determinations that incorporate EACs. A double counting occurs if two different parties claim the same environmental benefits from the same generated energy.¹⁰ Uniformly requiring claims of using electricity generated from specific sources to be evidenced by EACs that meet the requirements of proposed § 1.45V-4(d)(1) would mitigate the risk of double counting. Thus, proposed § 1.45V-4(d)(1) would provide that certain requirements must be met regardless of whether the electricity generating facility giving rise to the qualifying EAC is grid connected, directly connected, or co-located with the hydrogen production facility (that is, regardless of whether the underlying source of the qualifying EAC physically supplies electricity through a direct connection to the hydrogen production facility).

### 1. Definitions Related to Use of Energy Attribute Certificates

Proposed § 1.45V-4(d)(2)(i) would define the term “commercial operations date” or “COD” as the date on which a facility that generates electricity begins commercial operations. The COD, as defined here, is the first date of the operation of the relevant electricity generating facility. The general rules for determining an electricity generating facility's placed in service date for Federal income tax purposes would not apply in determining its COD.

Proposed § 1.45V-4(d)(2)(ii) would define the term “energy attribute certificate” or “EAC” to mean a tradeable contractual instrument, issued through a qualified EAC registry or accounting system (as defined in proposed § 1.45V-4(d)(2)(v)), that represents the energy attributes of a specific unit of energy produced. An EAC may be acquired with or separately from the underlying energy it represents. An EAC can be retired by or on behalf of its owner, which is the party that has the right to claim the underlying attributes represented by an EAC. Renewable energy certificates (RECs) and other similar energy certificates issued through a registry or accounting system are forms of EACs.

Proposed § 1.45V-4(d)(2)(iii) would define the term “eligible EAC” to mean an EAC that, with respect to the electricity to which the EAC relates, provides, at minimum, the following information: (i) a description of the electricity generating facility, including the technology and feedstock used to generate the electricity; (ii) the amount and units of electricity; (iii) the date on which the facility that generated the electricity first began commercial operations (referred to as the commercial operations date (COD)) (as defined in proposed § 1.45V-4(d)(2)(i));
(iv) for electricity that is generated before Jan. 1, 2028, the calendar year in which such electricity was generated;
(v) for electricity that is generated after Dec. 31, 2027, the date and hour in which such electricity was generated; and (vi) a unique project identification number or assigned identifier for each EAC that can be used to cross reference any additional electricity generating facility information that may be needed, such as location.

Proposed § 1.45V-4(d)(2)(iv) would define the term “qualifying EAC” to mean an eligible EAC (as defined in proposed § 1.45V-4(d)(2)(iii)) that meets the requirements of proposed § 1.45V-4(d)(3) and for which the satisfaction of those requirements has been verified by a qualified verifier (as defined in proposed § 1.45V-5(h)).

Proposed § 1.45V-4(d)(2)(v) would define the term “qualified EAC registry or accounting system” to mean a tracking system that (i) assigns a unique identification number to each EAC tracked by such system, (ii) enables verification that only one EAC is associated with each unit of electricity, (iii) verifies that the underlying attributes of each EAC is claimed and retired only once, (iv) identifies the owner of each EAC, and (v) provides a publicly accessible view (for example, through an application programming interface) of all currently registered electricity generators in the tracking system to prevent the duplicative registration of such generators.

Qualified EAC registries currently include, but are not limited to, the following: Electric Reliability Council of Texas (ERCOT); Michigan Renewable Energy Certification System (MIRECS); Midwest Renewable Energy Tracking System, Inc. (M-RETS); North American Registry (NAR); New England Power Pool Generation Information System (NEPOOL-GIS); New York Generation Attribute Tracking System (NYGATS); North Carolina Renewable Energy Tracking System (NC-RETS); PJM Generation Attribute Tracking System (PJM-GATS); and Western Electric Coordinating Council (WREGIS).

Proposed § 1.45V-4(d)(2)(vi) would define the term “region” to mean a United States region derived from the National Transmission Needs Study (DOE Needs Study) that was released by the DOE on Oct. 30, 2023.11 The DOE has mapped the DOE, Needs Study regions to actual balancing authorities. The data file and map of the resulting United States regions can be found in Guidelines to Determine Well-to-Gate Greenhouse Gas (GHG) Emissions of Hydrogen Production Pathways using 45VH2-GREET (GREET User Manual) as of Dec. 26, 2023. The location of an electricity generation source and the location of a hydrogen production facility will be based on the balancing authority to which it is electrically interconnected (not its geographic location), with each balancing authority linked to a single region. The MISO balancing authority is an exception because it is split into two U.S. regions as shown in the map located at GREET User Manual as of Dec. 26, 2023. Alaska, Hawaii, and each U.S. territory will be treated as separate regions.

### 2. Eligible Energy Attribute Certificate Requirements

Proposed § 1.45V-4(d)(3) would provide that an EAC meets the requirements to be a qualifying EAC if it meets the requirements for incrementality, temporal matching, and deliverability. The incrementality requirement in proposed § 1.45V-4(d)(3)(i) would require qualifying EACs to represent incremental source electricity, such as electricity from an electricity generating facility that has a recent COD. As discussed in more detail later in this section, the Treasury Department and the IRS are requesting comments on whether and under what circumstances electricity generated by an existing electricity generating facility (that is, with a less recent COD) that is dedicated to hydrogen production may be treated as satisfying the incrementality requirement. The temporal matching requirement in proposed § 1.45V-4(d)(3)(ii) would require that qualifying EACs are retired that represent electricity produced in the same time period in which the hydrogen production facility consumes electricity in the production of hydrogen. The deliverability requirement in proposed § 1.45V-4(d)(3)(iii) would require qualifying EACs to represent electricity that was produced by an electricity generating facility that is in the same region as the relevant hydrogen production facility.

The Treasury Department and the IRS, in consultation with the EPA and the DOE, have preliminarily determined that these qualifying EAC requirements are consistent with the requirements of section 45V(c)(1)(A) and (B) of the Code.¹² The EPA has advised that, based on its prior implementation of section 211(o)(1)(H) of the Clean Air Act in other contexts, it would be reasonable and consistent with the EPA's precedent for the Treasury Department and the IRS to determine that induced grid emissions are an anticipated real-world result of electrolytic hydrogen production that must be considered in lifecycle GHG analyses for purposes of the section 45V credit. Such interpretation would be consistent with the EPA's long-standing interpretation and application of section 211(o)(1)(H) of the Clean Air Act in the context of the Renewable Fuel Standard (RFS) program. The EPA has also noted that EACs are an established means for documentation and verification of the electricity generation and purchase of zero-GHG electricity. Moreover, the EPA has advised that it believes it would be reasonable for the Treasury Department and the IRS to use EACs that possess specific attributes that meet certain criteria as a means of reducing the risk of induced grid emissions resulting from new load from electrolytic hydrogen production being added to an existing grid. Such requirements would mitigate the risk of inappropriately crediting hydrogen production that does not meet the lifecycle GHG levels required by section 45V.

DOE has published a technical paper, Assessing Lifecycle Greenhouse Gas Emissions Associated with Electricity Use for the Section 45V Clean Hydrogen Production Tax Credit, which the Treasury Department and the IRS have reviewed, and which has informed the development of the proposed regulations. As discussed therein, incrementality, temporal matching, and deliverability requirements are important guardrails to ensure that hydrogen producers' electricity use can be reasonably deemed to reflect the emissions associated with the specific generators from which the EACs were purchased and retired. If hydrogen producers rely on EACs without attributes that meet these three criteria there is a significant risk that hydrogen production would significantly increase induced grid GHG emissions beyond the allowable levels required to qualify for the section 45V credit.

Electricity from a specific generator will have a GHG emissions profile that results from both its direct and indirect emissions. EACs with attributes that meet the three criteria are intended to address indirect GHG emissions resulting from the dynamics of the electricity market and the electric grid. If a hydrogen producer purchases zero GHG-emitting electricity that is represented by such EACs it is relatively straightforward to verify both the direct and indirect emissions resulting from such purchase and use. However, for minimal-emitting sources of electricity, additional considerations may be necessary to verify the full range of direct and indirect emissions. The Treasury Department and the IRS request comment on what information is needed to document and verify GHG emissions related to minimal-emitting electricity generation that is purchased and used for hydrogen production for purposes of claiming the section 45V credit.

While the Treasury Department and the IRS are soliciting comment on the type of information that hydrogen producers must provide in order to document and verify the direct and indirect GHG emissions associated with purchased electricity generally, we are also seeking input on two specific types of electricity generation for which GHG emissions can be highly variable or uncertain: fossil fuel-powered electricity generation with CCS and biomass-powered electricity generation. With regard to non-minimally emitting electricity generation, and fossil fuel-powered generation and biomass powered generation with or without CCS in particular, the Treasury Department and the IRS request comment on mechanisms to verify accurately real-world emissions related to hydrogen production. This includes mechanisms for, among other things, verification of the origin of the feedstock, rate of carbon capture, and other parameters that are relevant to accurate lifecycle analysis, as well as the ability of EAC instruments to represent accurately such attributes. The Treasury Department and the IRS also request comment on specific lifecycle GHG emissions considerations, including the use of counterfactual scenarios, that should be considered in evaluating direct and indirect emissions associated with specific types of biomass and its consumption. The Treasury Department and the IRS also request comment on the extent and manner in which incrementality, temporal matching, and deliverability should be applied in accounting for existing or new electricity generation from biomass or fossil feedstock. These comments may inform future versions of 45VH2-GREET.

a. Incrementality

Proposed § 1.45V-4(d)(3)(i)(A) would provide that an EAC meets the incrementality requirement if the electricity generating facility that produced the unit of electricity to which the EAC relates has a COD (as defined in proposed § 1.45V-4(d)(2)(i)) that is no more than 36 months before the hydrogen production facility for which the EAC is retired was placed in service.

The Treasury Department and the IRS understand that EAC tracking systems capture the COD of each electricity generating facility during the registration process (often using data also reported to the Energy Information Administration), inclusive of month and year, which can be cross-referenced based on project identification codes included on those EACs. That COD should represent the initial date of operation for the relevant electricity generating facility. Third-party verifiers should use this data to confirm the eligibility of purchased and retired EACs.

The Treasury Department and the IRS note that there are circumstances in which an existing higher-emitting electricity generating facility may make upgrades to subsequently deliver minimal-emitting electricity. For example, an existing fossil-fuel electricity generating facility may add CCS capability, thereby reducing its lifecycle emissions rate as determined in 45VH2-GREET. The Treasury Department and the IRS request comments on whether the electricity generated by such a facility should be considered incremental under circumstances such as if an existing fossil fuel electricity-generating facility after the addition of CCS (after upgrade), had a COD that is no more than 36 months before the relevant hydrogen production facility was placed in service. Comment is also requested on the related question of whether, depending on its carbon dioxide capture rate, it would be appropriate to treat such a facility as a new source of minimal-emitting generation on the grid that would not be associated with induced grid emissions. Relevant to these questions, the Treasury Department and the IRS additionally request comment on what information would be needed to allow for qualifying EACs representing existing fossil fuel-powered electricity from facilities that have added CCS. In particular, comment is requested on whether there are safeguards that can ensure that a hydrogen producer's purchase and use of electricity from an existing fossil fuel-fired electricity generating facility that installs CCS does not result in indirect GHG emissions due to the dynamics of the electricity market and electric grid. The Treasury Department and the IRS request comment on the direct and induced emissions impacts of making such a facility eligible, and whether and under what circumstances it would be appropriate to do so.

Proposed § 1.45V-4(d)(3)(i)(B) would provide an alternative test for establishing incrementality for electricity generating facilities that undergo an uprate. Proposed § 1.45V-4(d)(3)(i)(B) would provide that an EAC satisfies this alternative test if the electricity represented by the EAC is produced by an electricity generating facility that had an uprate no more than 36 months before the hydrogen production facility with respect to which the EAC is retired was placed in service and such electricity is part of such electricity generating facility's uprated production.

Proposed § 1.45V-4(d)(3)(i)(B) would provide rules for determining uprated production. Specifically, proposed § 1.45V-4(d)(3)(i)(B) would provide that an uprated electricity generating facility's production must be prorated to each hour or year, consistent with the requirements in proposed § 1.45V-4(d)(3)(ii), of such facility's generation by multiplying each hour's production by the uprated production rate to determine the electricity to which the uprate relates. Proposed § 1.45V-4(d)(3)(i)(B) would define key terms, including: (i) “uprate,” which means an increase in an electricity generating facility's rated nameplate capacity (in nameplate megawatts); (ii) “pre-uprate capacity,” which means the nameplate capacity of an electricity generating facility immediately before an uprate;
(iii) “post-uprate capacity,” which means the nameplate capacity of an electricity generating facility immediately after an uprate; (iv) “incremental generation capacity,” which means the increase in an electricity generating facility's rated nameplate capacity from the pre-uprate capacity to the post-uprate capacity; (v) “uprated production rate,” which means the incremental generation capacity (in nameplate megawatts) divided by the post-uprate capacity (in nameplate megawatts); and (vi) “uprated production,” which means the uprated production rate of an electricity generating facility multiplied by its total generation output in a given hour (in megawatt hours). Proposed § 1.45V-4(d)(3)(i)(C) would provide an example to illustrate the application of the alternative test for establishing incrementality due to uprates.

The DOE has advised that there are circumstances during which diversion of existing minimal (that is, zero or near-zero) emissions power generation to hydrogen production is unlikely to result in significant induced GHG emissions.¹³ Such circumstances may include generation from minimal-emitting power plants (i) that would retire absent the ability to sell electricity for qualified clean hydrogen production,
(ii) during periods in which minimal-emitting generation would have otherwise been curtailed, if marginal emissions rates are minimal, or (iii) in locations where grid-electricity is 100 percent generated by minimal-emitting generators or where increases in load do not increase grid emissions, for example, due to State policy capping total GHG emissions such that new load must be met with minimal-emitting generators. The Treasury Department and the IRS seek comments on whether and how to provide alternative approaches to identifying circumstances in which there is minimal risk of significant induced grid emissions for certain existing electricity generating facilities.

The Treasury Department and the IRS are considering providing, in the final regulations, alternative circumstances under which an EAC may be deemed to satisfy the incrementality requirement. The Treasury Department and the IRS request comments on these specific circumstances as described in part V.C.2.a.i through iii of this Explanation of Provisions.

i. Avoided Retirements Approach

The Treasury Department and the IRS seek comments on whether to recognize an avoided retirements approach that would treat EACs from an existing electricity generating facility as satisfying the incrementality requirement if the facility is likely to avoid retirement because of its relationship with a hydrogen production facility. With respect to this potential approach, the Treasury Department and the IRS request comments on the following: (i) the appropriate criteria that should be considered to assess retirement risk; (ii) the extent to which demonstration of financial loss, projected or actual local electricity market conditions, presence of out-of-market financial support (which could potentially include financial support driven by Federal or State policy, bilateral contracts for EACs or above-market electricity sales, or revenue provided by cost-of-service regulation), or upcoming relicensing decisions, in combination, are appropriate criteria to assess risk; (iii) industry best practices for estimating financial loss and the documentation necessary to support those estimates;
(iv) the appropriate criteria that should be taken into account to assess the likelihood that an electricity generator's relationship with a hydrogen production facility avoids retirement of the generator (for example, size of electrolyzer, co-location, contract length, or otherwise); (v) the appropriate criteria that should be taken into account to ensure that only electricity generation supplying the minimum hydrogen production necessary to avoid retirement is counted as incremental, and, in particular, whether there should be a cap on the amount of generation from a given facility that qualifies as incremental and how such a cap should be determined; (vi) the period during which any determination of incrementality of existing electricity generators would be maintained before a new showing would be required; (vii) the process by which eligibility for this approach should be determined and any related administrability considerations; and (viii) what role, if any, EAC tracking systems should play in the verification or tracking of eligible EACs from such electricity generators.

With respect to processes that may be used to implement this approach, the Treasury Department and the IRS request comments on whether such approach should allow existing minimal-emitting generators that wish to provide EACs to hydrogen producers to demonstrate incrementality through submission to the IRS or another Federal agency, such as the DOE, specific information that supports a conclusion that the electricity generator is at risk of retirement that may be mitigated by sales to hydrogen producers, and, if so, what information and information submission process should be required.

The available data on retirement risk indicates this approach may be warranted. Some clean power plants, primarily nuclear plants, have retired in recent years. Based on data from the Energy Information Administration (EIA), from 2013 through 2022, 10,800 megawatts (MW) of nuclear, 1,700 MW of wind, 950 MW of hydropower, and 360 MW of solar have retired.¹⁴ Studies have shown that there is risk of continued retirement in the years ahead.¹⁵ The EIA, for example, estimates that an additional 4,600 MW of existing nuclear plants may retire through 2032, equivalent to five percent of the existing nuclear fleet (1,900 gigawatts (GW) of renewable power plants may retire as well).¹⁶ Some of these plant owners (primarily owners of nuclear plants) may decide whether to retire the plants based on the finances of continuing to operate the plants. It is likely that for some plants, additional revenue from selling EACs and electricity to hydrogen producers may improve the financial outlook of the plant and help avert retirement, thereby keeping the minimal-emitting power plant in operation and not resulting in induced grid emissions compared to a scenario in which the plant retires.

ii. Zero or Minimal Induced Grid Emissions Through Modeling or Other Evidence

The Treasury Department and the IRS seek comments on whether to provide an opportunity to demonstrate zero or minimal induced grid emissions through modeling or other evidence under specific circumstances. A demonstrated or modeled minimal-emission approach could treat electricity produced by certain existing electricity generating facilities under certain circumstances as satisfying the incrementality requirement if it is demonstrated that such sources and circumstances would not give rise to significant induced grid emissions. Such a showing could be based on modeling or potentially be deemed to be made in certain circumstances based on regional grid characteristics, state policy, or facility history.

The Treasury Department and the IRS request comments on this demonstrated or modeled minimal-emission approach, including: (i) the circumstances in which it should be available and the criteria that are appropriate to evaluate and determine whether those circumstances occur; (ii) who should apply under this approach, the electricity generation facility, the hydrogen producer, or both; (iii) what data or modeling should be submitted;
(iv) best practices for making such demonstrations, including for ensuring the impartiality and replicability of calculation approaches; (v) how an administrator of such a program would validate the accuracy of applicant submissions; (vi) under what circumstances, if any, it would be appropriate to deem generation to satisfy the incrementality requirement without modeling, and what documentation should be provided in these cases; (vii) the process by which eligibility for this approach should be determined and any related administrability considerations; (viii) the period during which any determination of incrementality would be maintained before a new showing would be required; and (ix) the circumstances and capability of EACs and tracking systems to track and verify energy attributes from such sources.

There are several circumstances that may be covered under this pathway. Periods of curtailment or zero or negative pricing is one such circumstance. Hydropower plants sometimes “spill” water, a form of curtailment. Curtailment of minimal-emitting electricity generation tends to occur during times when wholesale electricity prices are zero or negative on a system-wide basis. Purchasing EACs from existing minimal-emitting electricity generators under these conditions would have limited or no induced grid emissions as these are times during which increased load would tend to be met by the otherwise curtailed minimal-emitting electricity generators rather than inducing increased generation from emitting electricity generators, and so is unlikely to significantly increase induced grid emissions.

Similarly, if in a particular region, all generation—including imported generation—comes from minimal-emitting electricity generators, then increased load is unlikely to significantly increase induced grid emissions. The same may be true if a region is subject to a state or local policy that ensures that new load is met with minimal-emitting electricity generation.

There may be limited risk of significant induced GHG emissions for islanded generation systems. Diversion of generation from a minimal-emitting electricity generator that has never been connected to the grid generally may not have the same induced GHG emissions effects as diversion from an electricity generator that is connected to the grid. Induced GHG emissions could occur, however, if the energy demand that the existing minimal-emitting electricity generator previously met is instead met by a different, emitting, energy source. For example, an onsite minimal-emitting electricity generator that powers an industrial facility could be diverted for hydrogen production, in which case the induced GHG emissions would depend on what happens at the site to meet the power needs of the industrial facility (unless the industrial facility ceases operation).

iii. Formulaic Approaches to Addressing Incrementality from Existing Clean Generators

The Treasury Department and the IRS recognize the difficulty in reliably identifying the specific electricity generators and specific times and places in which the circumstances described in part V.C.2.a.i and ii of this Explanation of Provisions might occur. Therefore, the Treasury Department and the IRS are also considering alternative approaches that would serve as proxy for all the pathways described in part V.C.2.a.i and part V.C.2.a.ii of this Explanation of Provisions. EACs that satisfy the incrementality requirement through this pathway would still be required to meet temporal matching and deliverability requirements.

One such approach would deem five percent of the hourly generation from minimal-emitting electricity generators (for example, wind, solar, nuclear, and hydropower facilities) placed in service before Jan. 1, 2023, as satisfying the incrementality requirement. This pathway may be appropriate because some circumstances (including periods of curtailment or times when generation from minimal-emitting electricity generation is on the margin) may make the resulting incremental generation difficult to anticipate or identify, or because the process for identifying the circumstances (such as avoided retirement risk or modeling of minimal-emissions) may be overly burdensome to evaluate for specific electricity generators or require data that is not available. In some instances, for example, in determining whether EACs come from electricity generation that would otherwise have been curtailed, these circumstances require understanding of counterfactual “what if” scenarios that depend on numerous assumptions. In other circumstances, for example, in determining whether EACs come from minimal-emitting electricity generators that otherwise would have retired or if policy regimes restrict increases in grid emissions in the face of growing electricity demand, they may require detailed assessment and pre-qualification based on applicant-submitted information and forecasts with related concerns about information accuracy. In still other cases, they may require complex geographically and temporally granular modeling and data (such as for marginal emission rates that consider operational and structural effects 17) in concert with hourly EAC tracking infrastructure that is not yet widely available.

The Treasury Department and the IRS are mindful of the risk that an allowance without further temporal, spatial, and circumstantial precision results in hydrogen production facilities receiving credits for which they should not be eligible given their induced emissions rates. Given the risks of induced GHG emissions, the Treasury Department and the IRS believe that a broadly available allowance that is not tailored to specific geographic or other conditions should not be greater than the national average rate of the occurrence of the above circumstances and instead should be a conservative lower bound of the national average. The DOE reports that wind curtailment in 2022 averaged 5.3 percent of total wind generation nationwide (data are only available for Independent System Operator (ISO) regions),¹⁸ and Lawrence Berkeley National Laboratory reports curtailment rates for solar photovoltaics at over 10 percent of solar generation in ERCOT and over 3 percent in California Independent System Operator (CAISO).

Purchasing EACs from existing minimal-emission electricity generators, whether or not from the electricity generators that would otherwise curtail their output, under these conditions would have limited risk of induced grid emissions. As noted earlier, curtailment is most likely to occur in the face of negative wholesale electricity prices if the marginal grid emissions rate is minimal or zero. Based on a data tool developed by Lawrence Berkeley National Laboratory that considers over 50,000 wholesale pricing nodes across the nation, negative wholesale prices occurred during roughly five percent of hours over the last several years (6.3 percent of hours in 2022, 5.8 percent in 2021, 4.8 percent in 2020, 3.3 percent in 2019, and 2.3% in 2018).¹⁹ These are times during which increased load is unlikely to increase significantly induced grid emissions.²⁰ Modeled data from the National Renewable Energy Laboratory (NREL) is broadly consistent with these trends. Specifically, NREL's Cambium data set for 2024 shows that long-run marginal emissions rates on a national basis are projected to be at or near zero for about five percent of hours, times during which minimal-emitting electricity generators are on the margin and often curtailed.²¹ In addition, some minimal-emitting electricity generators are at risk of retirement, including about five percent of the nuclear fleet according to EIA estimates. A percentage allowance can also serve as proxy for avoided retirements.

The Treasury Department and the IRS seek comments on this five percent-allowance approach, including the merits of this approach compared to the targeted pathways described, particularly with respect to balancing administrative feasibility and burden with accuracy of identifying circumstances with a low risk of induced grid emissions. The Treasury Department and the IRS also seek comments on whether 5 percent is the appropriate magnitude for an allowance. In particular, as noted earlier, data show that curtailment rates have increased in recent years, and NREL's Cambium model predicts additional increases going forward. In light of these data and projections, the Treasury Department and the IRS seek comments on whether a higher amount, such as up to 10 percent, would be appropriate, either in general or in certain cases or circumstances. The Treasury Department and the IRS also seek comments on: (i) how a five-percent allowance should be tracked, allocated, and administered and how feasible it is for EAC tracking systems to incorporate data on such an allowance; (ii) whether the five percent should apply to all existing minimal-emitting electricity generators in all locations or a subset and for what reasons; (iii) whether such an allowance should be assessed at the individual plant level or across an operator's fleet within the same deliverability region; and (iv) any other administrability considerations. The Treasury Department and the IRS seek comments specifically on whether and how the “averaging” approach of a proxy appropriately captures the circumstances in which generation is incremental or does not generate induced grid emissions. The Treasury Department and the IRS also seek comments on how and whether the targeted alternative approaches or the other proxy approaches described subsequently in this part V.C.2.a.iii of this Explanation of Provisions might replace the five-percent allowance or might be coordinated with the allowance.

The Treasury Department and the IRS invite comments on alternative formulaic, proxy approaches that might better capture conditions under which using existing minimal-emitting electricity generation to produce hydrogen does not significantly impact induced grid emissions. The Treasury Department and the IRS request comments on whether there would be an appropriate, more formulaic approach to capturing retirement risk, instead of the application-based process or the five-percent allowance.

Comments are specifically requested on whether such an alternative approach should be limited to facilities with specific technical, market, or geographic characteristics corresponding with a greater risk of retirement (for example, participation in a wholesale market, lack of state support for a facility, nuclear plants with a single reactor) and higher likelihood that using a subset of electricity generation and related EACs for hydrogen production would minimize the risk.

In particular, the Treasury Department and the IRS seek comments on whether existing nuclear and hydroelectric facilities that need to undertake a relicensing process are generally at higher risk of retirement without additional financial assistance and, if so, what considerations should be integrated into a potential formulaic approach. Comments are further requested on whether there are particular characteristics of hydrogen production facilities associated with existing generators at risk of retirement that should be considered (i) to demonstrate that the hydrogen production reduces retirement risk, such as co-location of hydrogen production with an existing generator and (ii) to assess the minimum hydrogen production necessary to reduce retirement risk, such as limitations on project size, electrolyzer capacity, or percent of generation used by the hydrogen production. Comments are further requested on how to determine the portion of such electricity generation and related EACs, which is generally likely to be sufficient to minimize that risk. Similarly, with respect to the modeled or demonstrated approach described in part V.C.2.a.ii of this Explanation of Provisions, the Treasury Department and the IRS request comments on whether there are formulaic approaches that might be used instead of an application-based pre-qualification process and the broad five-percent allowance. For each of these possible alternative approaches to establish incrementality, the Treasury Department and the IRS request comments on how eligibility for the approach may be reliably verified by an unrelated party and administered by the IRS.

b. Temporal Matching

Proposed § 1.45V-4(d)(3)(ii)(A) would provide the general rule that an EAC satisfies the temporal matching requirement if the electricity represented by the EAC is generated in the same hour that the taxpayer's hydrogen production facility uses electricity to produce hydrogen.

Proposed § 1.45V-4(d)(3)(ii)(B) would provide a transition rule to allow an EAC that represents electricity generated before Jan. 1, 2028 to fall within the general rule provided in proposed § 1.45V-4(d)(3)(ii)(A) if the electricity represented by the EAC is generated in the same calendar year that the taxpayer's hydrogen production facility uses electricity to produce hydrogen. The DOE has advised that hourly matching is necessary to properly address significant indirect emissions from electricity use and that the tracking systems and related contractual structures for hourly matching will take some time to develop to an appropriate level of maturity.²² This transition rule is intended to provide time for the EAC market to develop the hourly tracking capability necessary to verify compliance with this requirement.

Hourly tracking systems for EACs are not yet broadly available across the country and will take some time to develop.²³ In a recent survey of nine existing tracking systems,²⁴ two of the tracking systems indicated that they are already tracking on an hourly basis, although software functionality in these two systems remains limited. Fully developing the functionality of these systems will take time, as will creating and developing the functionality of hourly tracking infrastructure in other regions of the country. Of the other tracking systems, assuming that challenges are overcome, four gave a timeline of less than one year to two years, and one gave a timeline of three to five years; in the latter case, the respondent noted that the timeline could be closer to three years if there is full state agency buy-in, clear instructions are received from federal or state agencies, and funding for stakeholder participation is made available. Two tracking systems declined to give a timeline to develop this functionality. In the same survey, tracking systems identified a number of challenges to hourly tracking that will need to be overcome, including cost, regulatory approval, interactions with state policy, sufficient stakeholder engagement, data availability and management, and user confusion. Moreover, once the tracking software infrastructure is in place nationally, it may take additional time for transactional structures and efficient hourly EAC markets to develop. Among the issues that require resolution as EAC tracking systems move to hourly resolution is the treatment of electricity storage.²⁵

Given the state of tracking systems, the expected responses to this proposed rule, and the impact of demand to drive development of the tracking systems, the Treasury Department and the IRS anticipate that the proposed duration of the transition rule would allow sufficient time for systems to develop hourly tracking mechanisms and for the associated trading markets to develop. The Treasury Department and the IRS acknowledge uncertainty in the timing of implementing an hourly matching requirement, however, and request comments on the appropriate duration of this transition rule to hourly matching, including specific data regarding current industry practices, the predicted timelines for development of hourly tracking mechanisms, and the predicted timeline for market development for hourly EACs.

c. Deliverability

Proposed § 1.45V-4(d)(3)(iii) would provide that an EAC meets the deliverability requirements if the electricity represented by the EAC is generated by a source that is in the same region (as defined in proposed § 1.45V-4(d)(2)(vi)) as the relevant hydrogen production facility. This approach provides reasonable assurances of deliverability of electricity because the regions, as defined earlier, were developed by the DOE in consideration of transmission constraints and congestion and, in many cases, match power-systems operation. The Treasury Department and the IRS recognize that transmission limitations also exist within these specified regions but are not aware of readily administrable options to reflect those grid constraints. The DOE has generally found that inter-regional transmission constraints tend to be greater than within-region constraints.²⁶ The Treasury Department and the IRS request comments on whether there are additional ways to establish deliverability, such as circumstances indicating that electricity is actually deliverable from an electricity generating facility to a hydrogen production facility, even if the two are not located in the same region or if the clean electricity generator is located outside of the United States.

v. Procedures for Verification of Qualified Clean Hydrogen Production and Sale or Use

Section 45V(c)(2)(B)(ii) provides that hydrogen is not qualified clean hydrogen unless “the production and sale or use of such hydrogen is verified by an unrelated party.”

### A. Requirements for Verification Reports

Proposed § 1.45V-5(a) would provide that a verification report must be attached to the taxpayer's Form 7210, Clean Hydrogen Production Credit, or any successor form(s), and included with the taxpayer's Federal income tax return or information return for each qualified clean hydrogen production facility and for each taxable year in which the taxpayer claims the section 45V credit. Proposed § 1.45V-5(b) would provide that the verification report specified in § 1.45V-5(a) must be prepared by a qualified verifier (as defined in § 1.45V-5(h)) under penalties of perjury. Proposed § 1.45V-5(b)(1) through (6) would describe the following information that a verification report must contain: (i) an attestation from the qualified verifier regarding the taxpayer's production of qualified clean hydrogen for sale or use during the taxable year (production attestation), (ii) an attestation from the qualified verifier regarding the amount of such qualified clean hydrogen sold or used (sale or use attestation), (iii) an attestation from the qualified verifier regarding conflicts of interest (conflict attestation), (iv) certain information regarding the qualified verifier, including documentation of the qualified verifier's qualifications (qualified verifier statement), (v) certain general information about the taxpayer's hydrogen production facility where the hydrogen production undergoing verification occurred, and (vi) any documentation necessary to substantiate the verification process given the standards and best practices prescribed by the qualified verifier's accrediting body and the circumstances of the taxpayer and the taxpayer's hydrogen production facility.

### B. Requirements for Production Attestation

Proposed § 1.45V-5(c)(1) would provide that a production attestation must state, under penalties of perjury, that the qualified verifier performed a verification sufficient to determine that the operation, during the applicable taxable year, of the hydrogen production facility that produced the hydrogen for which the section 45V credit is claimed, and any EACs applied pursuant to proposed § 1.45V-4(d), are accurately reflected in: (i) the amount of qualified clean hydrogen produced by the taxpayer that is claimed on the Form 7210, Clean Hydrogen Production Credit, or any successor form(s), to which the verification report is attached; and (ii) either the data the taxpayer entered into the most recent GREET model (as defined in proposed § 1.45V-1(a)(8)(ii)) to determine the lifecycle GHG emissions rate that is claimed on the Form 7210, or the data the taxpayer submitted in the PER petition relating to the hydrogen for which the section 45V credit is claimed, and which was provided to the DOE in support of the taxpayer's request for the emissions value provided in the PER petition. For any acquisition and retirement of qualifying EACs, the verification must include validation that any purchases of EACs from specified sources as entered into the most recent GREET model or used as part of a PER application meet all requirements for being qualifying EACs, and that any required technical parameters of the generating source (for example, CCS capture rate, or sources of biomass) as entered into 45VH2-GREET or as part of a PER application are accurate.

Proposed § 1.45V-5(c)(2) would provide that, if the production attestation attests to the information specified in proposed § 1.45V-5(c)(1)(ii)(B), then the production attestation must also specify the emissions value received from the DOE that was calculated using such data, expressed in kilograms of CO2e per kilogram of hydrogen.

Proposed § 1.45V-5(c)(3) would provide that the production attestation must specify the lifecycle GHG emissions rate (expressed in kilograms of CO2e per kilogram of hydrogen) and the amount of qualified clean hydrogen produced by the taxpayer, (expressed in kilograms), that are claimed on the Form 7210, Clean Hydrogen Production Credit, or any successor form(s), to which the verification report is attached.

### C. Requirements for Sale or Use Attestation

Proposed § 1.45V-5(d)(1) would provide that the sale or use attestation must be an attestation, made under penalties of perjury, that the qualified verifier performed a verification sufficient to determine that the amount of qualified clean hydrogen that is specified in the production attestation (described in proposed § 1.45V-5(c)), and that is claimed on the Form 7210, Clean Hydrogen Production Credit, or any successor form(s), to which the verification report is attached, has been sold or used.

Proposed § 1.45V-5(d)(2) would provide that, for purposes of section 45V(c)(2)(B)(ii) and § 1.45V-1(a)(9)(ii), the hydrogen specified in proposed § 1.45V-5 (d)(1) has been used if a person makes a verifiable use of such hydrogen. Section 45V does not deny a section 45V credit if the hydrogen is sold or used outside the United States (as defined in section 638(1) or a United States territory (having the meaning of the term “possession” as defined in section 638(2)). Thus, a verifiable use can occur within or outside the United States. A verifiable use can be made by the taxpayer or a person other than the taxpayer. For example, in a tolling arrangement pursuant to which a service recipient provides raw materials or inputs such as water or electricity to a third-party service provider that owns a hydrogen production facility (the toller), and the toller produces hydrogen for the service recipient using the service recipient's raw materials or inputs in exchange for a fee, use of the hydrogen by the service recipient would be a verifiable use. However, a verifiable use includes neither (i) use of hydrogen to generate electricity that is then directly or indirectly used in the production of more hydrogen, nor (ii) venting or flaring hydrogen.

Excluding those activities from qualifying as a verifiable use is intended to prevent the wasteful production of hydrogen and abusive section 45V credit generation schemes. For example, without this restriction, the section 45V credit could be exploited through the production of qualified clean hydrogen that is used to generate electricity that is, in turn, used to produce additional qualified clean hydrogen. The primary purpose of these arrangements would be the exploitation of the section 45V credit and possibly other Federal income tax credits. Such arrangements are inconsistent with the intent of section 45V and with the statutory “use” requirement because they would incentivize the inefficient production of qualified clean hydrogen for unproductive use and would result in excessive claims of the section 45V credit. The Treasury Department and the IRS request comments on whether there are additional safeguards that the regulations could adopt to prevent this or similar types of abusive section 45V credit claims, including section 45V credit claims arising if such circular arrangements are coordinated among multiple parties.

### D. Requirements for Conflict Attestation

Proposed § 1.45V-5(e)(1) would provide that the verification report must also include a conflict attestation, made under penalties of perjury, that (i) the qualified verifier has not received a fee based to any extent on the value of any section 45V credit that has been or is expected to be claimed by any taxpayer and no arrangement has been made for such fee to be paid at some time in the future; (ii) the qualified verifier was not a party to any transaction in which the taxpayer sold qualified clean hydrogen it had produced or in which the taxpayer purchased inputs for the production of such hydrogen; (iii) the qualified verifier is not related, within the meaning of section 267(b) or 707(b) (1), to, or an employee of, the taxpayer; (iv) the qualified verifier is not married to an individual described in proposed § 1.45V-5(e)(1)(iii); and (v) if the qualified verifier is acting in his or her capacity as a partner in a partnership, an employee of any person, whether an individual, corporation, or partnership, or an independent contractor engaged by a person other than the taxpayer, the attestations under proposed § 1.45V-5(e)(1)(i) through (iv) must be made with respect to the partnership or the person who employs or engages the qualified verifier.

E. Proposed § 1.45V-5(e)(2) would provide that, if a transfer election has been made under section 6418(a) of the Code with respect to the section 45V credit, then the attestation requirements under proposed § 1.45V-5(e)(1) would need to be made with respect to the qualified verifier's independence from both the eligible taxpayer (as defined in section 6418(f)(2) and § 1.6418-1(b)) and the transferee taxpayer (as described in section 6418(a) and defined in § 1.6418-1(m)).

### F. Requirements for Qualified Verifier Statement

Proposed § 1.45V-5(f) would provide that the qualified verifier statement must contain (i) the qualified verifier's name, address, and taxpayer identification number; (ii) the qualified verifier's qualifications to conduct the verification, including the qualified verifier's education and experience and a photocopy of the qualified verifier's certificate received from their accrediting body; (iii) if the qualified verifier is acting in his or her capacity as a partner in a partnership, an employee of any person, whether an individual, corporation, or partnership, or an independent contractor engaged by a person other than the taxpayer, the name, address, and taxpayer identification number of the partnership or the person who employs or engages the qualified verifier; (iv) the signature of the qualified verifier and the date signed by the qualified verifier; and (v) a statement that the verification was conducted for Federal income tax purposes.

### G. General Information Required to Be Included in Verification Report

Proposed § 1.45V-5(g) would provide that the verification report must include (i) the location of the hydrogen production facility; (ii) a description of the hydrogen production facility, including its method of producing hydrogen; (iii) the type(s) of feedstock(s) used by the hydrogen production facility during the taxable year of production; (iv) the amount(s) of feedstock(s) used by the hydrogen production facility during the taxable year of production; and (v) a list of the metering devices used to record any data used by the qualified verifier to support the production attestation along with a statement that the qualified verifier is reasonably assured that the device(s) underwent industry-appropriate quality assurance and quality control, and that the accuracy and calibration of the device has been tested in the last year.

### H. Definitions Related to Verifications

Proposed § 1.45V-5(h) would define the term “qualified verifier” to mean any individual or organization with active accreditation (i) as a validation and verification body from the American National Standards Institute National Accreditation Board; or (ii) as a verifier, lead verifier, or verification body under the California Air Resources Board Low Carbon Fuel Standard program. The Treasury Department and the IRS request comment on this definition of “qualified verifier,” including on whether additional accreditations that demonstrate sufficient expertise for verification of lifecycle analysis for the section 45V credit should be included.

Proposed § 1.45V-5(i) would define the term “unrelated party” (as described in section 45V(c)(2)(B)(ii)) to mean a qualified verifier who meets the conflict attestation requirements as provided in proposed § 1.45V-5(e).

### I. Requirements for Taxpayers Claiming Both the Section 45V Credit and the Section 45 Credit or the Section 45U Credit

Proposed § 1.45V-5(j) would provide requirements that, in the case of a taxpayer who produces electricity for which either the section 45 credit or section 45U credit is claimed and the taxpayer or a related person (as defined in section 45(e)(4)) uses such electricity (and related EACs) to produce hydrogen for which the section 45V credit is claimed, the verification report must also contain attestations that the qualified verifier performed a verification sufficient to determine that
(i) the electricity used to produce hydrogen was produced at the relevant facility for which either the section 45 credit or section 45U credit was claimed, (ii) the given amount of such electricity (in kilowatt hours) used to produce hydrogen at the relevant qualified clean hydrogen production facility is reasonably assured of being accurate, and (iii) the electricity for which a section 45 or section 45U credit was claimed is represented by EACs that are retired in connection with the production of such hydrogen.

### J. Required Time for Filing a Verification Report

Proposed § 1.45V-5(k) would provide that a verification report must be signed and dated by the qualified verifier no later than (i) the due date, including extensions, of the Federal income tax return or information return for the taxable year during which the hydrogen undergoing verification is produced; or
(ii) in the case of a section 45V credit first claimed on an amended return or administrative adjustment request (AAR), the date on which the amended return or AAR is filed.
   VI. Placed in Service Date for Existing Facility that is Modified or Retrofitted to Produce Qualified Clean Hydrogen

### A. Modification of an Existing Facility

Under section 45V(d)(4), in the case of any facility that was originally placed in service before Jan. 1, 2023, and, prior to the modification (described in section 45V(d)(4)(B)), did not produce qualified clean hydrogen, and after the date the facility was originally placed in service (i) is modified to produce qualified clean hydrogen, and (ii) amounts paid or incurred with respect to the modification are properly chargeable to the taxpayer's capital account, the facility will be deemed to have been originally placed in service as of the date the property required to complete the modification is placed in service. The rule in section 45V(d)(4) for modification of existing facilities applies to modifications made after Dec. 31, 2022. See section 13204(a)(5)(C) of the IRA.

Proposed § 1.45V-6(a)(1) would incorporate the statutory provisions of section 45V(d)(4). Proposed § 1.45V-6(a)(2) would further provide that an existing facility will not be deemed to have been originally placed in service as of the date the property required to complete the modification is placed in service unless the modification is made for the purpose of enabling the facility to produce qualified clean hydrogen and the taxpayer pays or incurs an amount with respect to such modification that is properly chargeable to the taxpayer's capital account for the facility. Proposed § 1.45V-6(a)(2) would also provide that a modification is made for the purpose of enabling the facility to produce qualified clean hydrogen if the facility could not produce hydrogen with a lifecycle GHG emissions rate that is less than or equal to 4 kilograms of CO2e per kilogram hydrogen but for the modification. Changing fuel inputs to the hydrogen production process, such as switching from conventional natural gas to renewable natural gas, would not qualify as a facility modification for purposes of proposed § 1.45V-6(a)(2).

Examples 1, 2, and 3 of proposed § 1.45V-6(c) would provide examples illustrating the application of the rules provided by section 45V(d)(4) and proposed § 1.45V-6(a).

B. Retrofit of an Existing. Facility (80/20 Rule)

Proposed § 1.45V-6(b) would provide that an existing facility may establish a new date on which it is considered originally placed in service for purposes of section 45V, even though the facility contains some used property, provided the fair market value of the used property is not more than 20 percent of the facility's total value (the cost of the new property plus the value of the used property) (80/20 Rule). Proposed § 1.45V-6(b) would further provide that for purposes of the 80/20 Rule, the cost of new property includes all properly capitalized costs of the new property included within the facility. Proposed § 1.45V-6(b) would provide that, if a facility satisfies the requirements of the 80/20 Rule, then the date on which such facility is considered originally placed in service for purposes of section 45V(a)(1) is the date on which the new property added to the facility is placed in service. Proposed § 1.45V-6(b) would also provide that the 80/20 Rule applies to any existing facility, regardless of whether the facility previously produced qualified clean hydrogen and regardless of when the facility was originally placed in service (before application of proposed § 1.45V-6(b)). Examples 4 and 5 of proposed § 1.45V-6(c) would provide examples illustrating the application of the 80/20 Rule.

### VII. Election to Treat a Clean Hydrogen Production Facility as Energy Property for Purposes of the Section 48 Credit

### A. Overview

Section 48(a)(15) allows a taxpayer that owns and places in service a specified clean hydrogen production facility (as defined in section 48(a)(15)(C)) to make an irrevocable election to claim the section 48 credit in lieu of the section 45V credit for any qualified property (as defined in section 48(a)(5)(D)) that is part of the facility. This provision is effective for property placed in service after Dec. 31, 2022. For any property that is placed in service after Dec. 31, 2022, and the construction of which begins before Jan. 1, 2023, section 13204(c)(3) of the IRA provides that section 48(a)(15) applies only to the extent of the basis of such property that is attributable to construction, reconstruction, or erection occurring after Dec. 31, 2022.

Proposed § 1.48-15(a) would provide that a taxpayer that owns and places in service a specified clean hydrogen production facility (as defined in section 48(a)(15)(C) and proposed § 1.48-15(b)) can make an irrevocable election under section 48(a)(15)(C)(ii)(II) to treat any qualified property (as defined in section 48(a)(5)(D)) that is part of the facility as energy property for purposes of section 48.

Proposed § 1.48-15(b) would define the term “specified clean hydrogen production facility” to mean any qualified clean hydrogen production facility (within the meaning of section 45V(c)(3)) and proposed § 1.45V-1(a)(10)): (i) that is placed in service after Dec. 31, 2022; (ii) with respect to which no section 45V credit or section 45Q credit has been allowed, and for which the taxpayer makes an irrevocable election to have section 48(a)(15) apply; and (iii) for which an unrelated party has verified in the manner specified in proposed § 1.48-15(e) that such facility produces hydrogen through a process that results in lifecycle GHG emissions that are consistent with the hydrogen that such facility was designed and expected to produce under section 48(a)(15)(A)(ii) and proposed § 1.48-15(c).

Proposed § 1.48-15(c)(1) would provide the energy percentage (used by a taxpayer to calculate a section 48 credit) for a specified clean hydrogen production facility that is designed and reasonably expected to produce qualified clean hydrogen through a process that results in a lifecycle GHG emissions rate of not greater than 4 kilograms of CO2e per kilogram of hydrogen. Proposed § 1.48-15(c)(2) would further provide that “designed and reasonably expected to produce” means hydrogen produced through a process that results in the lifecycle GHG emissions rate specified in the annual verification report for the taxable year in which the section 48(a)(15) election is made. The Treasury Department and the IRS request comments on this proposed rule and whether there are any challenges to using the lifecycle GHG emissions rate achieved in the taxable year in which the section 48(a)(15) election is made to determine the facility's energy percentage for purposes of calculating the section 48 credit amount.

### B. Election Procedures

1. Time and Manner of Making Election Proposed § 1.48-15(d)(1) would provide that, to make an election under section 48(a)(15)(c)(ii)(II), a taxpayer must claim the section 48 credit with respect to a specified clean hydrogen production facility on a Form 3468, Investment Credit, or any successor form(s), and file the form with the taxpayer's Federal income tax return or information return for the taxable year in which the specified clean hydrogen production facility is originally placed in service. Proposed § 1.48-15(d)(1) would provide that the taxpayer must also attach a statement to its Form 3468, Investment Credit, or any successor form(s), filed with its Federal income tax return or information return that includes all the information required by the instructions to Form 3468, Investment Credit, or any successor form(s), for each specified clean hydrogen production facility subject to an election. Proposed § 1.48-15(d)(1) would provide that a separate election must be made for each specified clean hydrogen production facility that meets the requirements provided in section 48(a)(15) to treat the qualified property that is part of the facility as energy property.
2. Proposed § 1.48-15(d)(1) would further provide that, if any taxpayer owning an interest in a specified clean hydrogen production facility makes an election with respect to the facility, then that election would be binding on all taxpayers that directly or indirectly own an interest in the facility. Thus, consistent with section 48(a)(15)(B), if a taxpayer owning an interest in a specified clean hydrogen production facility makes an election under section 48(a)(15)(C)(ii)(II), then no other taxpayer owning an interest in the same facility will be allowed a section 45V credit or section 45Q credit with respect to the facility.
3. The Treasury Department and the IRS request comments on whether, in the context of a specified clean hydrogen production facility that is directly owned through an arrangement properly treated as a tenancy-in-common for Federal income tax purposes or through an organization that has made a valid election under section 761 (a) of the Code, each co-owner's or member's undivided ownership share of the qualified property comprised in the facility should be treated for purposes of section 48(a)(15)(C)(ii)(II) as a separate facility owned by such co-owner or member, with each such co-owner or member eligible to make a separate election under section 48(a)(15)(C)(ii)(II) to claim the section 48 credit in lieu of the section 45V credit with respect to its undivided ownership interest in the facility or share of the underlying qualified property.
4. Special Rule for Partnerships and S Corporations

Proposed § 1.48-15(d)(2) would provide that, in the case of a specified clean hydrogen production facility owned by a partnership or an S corporation, the election under section 48(a)(15)(C)(ii)(II) would be made by the partnership or S corporation and would be binding on all ultimate credit claimants (as defined in § 1.50-1(b)(3)(ii)). Proposed § 1.48-15(d)(2) would provide that the partnership or S corporation must file a Form 3468, Investment Credit, or any successor forms(s), with its partnership or S corporation return for the taxable year in which the specified clean hydrogen production facility is placed in service to indicate that it is making the election, and attach a statement that includes all the information required by the instructions to Form 3468, Investment Credit, or any successor form(s), for each specified clean hydrogen production facility subject to the election. Proposed § 1.48-15(d)(2) would provide that the ultimate credit claimant's section 48 must be based on each claimant's share of the basis (as defined in § 1.46-3(f)) of the specified clean hydrogen production facility on a completed Form 3468, Investment Credit, or any successor forms(s), and file such form with a Federal income tax return or information return for the taxable year that ends with or within the taxable year in which the partnership or S corporation made the election.

Proposed § 1.48-15(d)(2) would provide that the partnership or S corporation making the election must provide the ultimate credit claimants with the necessary information to complete Form 3468, Investment Credit, or any successor forms(s), to claim the section 48 credit.
5. Election Irrevocable

Proposed § 1.48-15(d)(3) would provide that the election to treat any qualified property that is part of a specified clean hydrogen production facility as energy property would be irrevocable.
6. Election Availability Date Proposed § 1.48-15(d)(4) would provide that the election to treat any qualified property that is part of a specified clean hydrogen production facility as energy property would be available for property placed in service after Dec. 31, 2022, and, for any property that began construction before Jan. 1, 2023, only to the extent of the basis thereof attributable to the construction, reconstruction, or erection after Dec. 31, 2022.

### C. Third-Party Verification

Proposed § 1.48-15(e)(1) would provide that, in the case of a taxpayer that makes an election under section 48(a)(15)(c)(ii)(II) to treat any qualified property that is part of a specified clean hydrogen production facility as energy property for purposes of the section 48 credit, the taxpayer must obtain an annual verification report for the taxable year in which the election is made and for each taxable year thereafter of the recapture period specified in proposed § 1.48-15(f)(3). Proposed § 1.48-15(e)(1) would further provide that the taxpayer must also submit the annual verification report as an attachment to the Form 3468, Investment Credit, or any successor form(s), for the taxable year in which the election is made.

Further, proposed § 1.48-15(e)(2)(i) would provide that the annual verification report must be signed under penalties of perjury by a qualified verifier (as defined in proposed § 1.45V-5(h)) and contain (i) the information specified in §§ 1.45V-5(b) and 1.45V-5(d) through § 0.1.45V-5(h); (ii) a statement attesting to the lifecycle GHG emissions rate (determined under section 45V(c) and § 1.45V-4) of the hydrogen produced at the specified clean hydrogen production facility for the taxable year to which the annual verification report relates and that the operation, during such taxable year, of the specified clean hydrogen production facility, and any EACs applied pursuant to § 1.45V-4(d) for the purpose of accounting for such facility's emissions, are accurately reflected in the data the taxpayer entered into the most recent GREET model (as defined in § 1.45V-1(a)(8)(ii)) (or in the data the taxpayer provided to the DOE in support of the taxpayer's request for an emissions value), to determine the lifecycle GHG emissions rate of the hydrogen undergoing verification; and (iii) an attestation that the facility produced hydrogen through a process that results in a lifecycle GHG emissions rate that is consistent with, or lower than, the lifecycle GHG emissions rate of the hydrogen that such facility was designed and expected to produce.

Proposed § 1.48-15(e)(2)(ii) would provide that if a transfer election has been made under section 6418(a) of the Code with respect to the section 48 credit for a specified clean hydrogen production facility, then the conflict attestation containing the information specified in proposed § 1.45V-5(e)(1) must be made with respect to the qualified verifier's independence from both the eligible taxpayer (as defined in section 6418(f)(2) and § 1.6418-1(b)) and the transferee taxpayer (as described in section 6418(a) and defined in § 1.6418-1(m)), and without regard to the requirements under proposed § 1.45V-5(e)(2).

Proposed § 1.48-15(e)(2)(iii) would provide that in the event the facility produces qualified clean hydrogen through a process that results in a lifecycle GHG emissions rate greater than the lifecycle GHG emissions rate such facility was designed and expected to produce (and thus the qualified verifier cannot provide the attestation specified in proposed § 1.48-15(e)(2)(i)(B)), resulting in a reduced energy percentage under section 48(a)(15)(A)(ii) with respect to such facility, an emissions tier recapture event under proposed § 1.48-15(f)(2) will occur. Proposed § 1.48-15(e)(2)(iv) would provide that the hydrogen a facility was “designed and expected to produce” would mean hydrogen produced through a process that results in the lifecycle GHG emissions rate specified in proposed § 1.48-15(c)(2).

Additionally, proposed § 1.48-15(e)(2)(v) would require that the annual verification report must be signed and dated by the qualified verifier no later than the due date, including extensions, of the Federal income tax return or information return for the taxable year in which the hydrogen undergoing verification was produced. Proposed § 1.48-15(e)(2)(vi) would provide that in addition to the recordkeeping requirements set forth in § 1.48-15(g), the taxpayer must retain the annual verification report for at least six years after the due date, with extensions, for filing the Federal income tax return or information return for the taxable year in which the hydrogen undergoing verification was produced.

### D. Credit Recapture

Section 48(a)(15)(E) directs the Secretary to issue such regulations or other guidance as determined necessary to carry out the purposes of section 48, including regulations or other guidance addressing recapture of so much of the credit allowed under section 48 as exceeds the amount of the credit that would have been allowed if the expected production were consistent with the actual verified production or all of the credit so allowed in the absence of such verification.

1. Emissions Tier Recapture Events Under Section 48(a)(15)(E)

Proposed § 1.48-15(f)(1), would provide that, for purposes of section 48(a)(15)(E), in any taxable year of the recapture period specified in proposed § 1.48-15(f)(3) in which an emissions tier recapture event (as defined in proposed § 1.48-15(f)(2)) occurs, the tax imposed on the taxpayer under chapter 1 of the Code for the taxable year of the emissions tier recapture event is increased by the recapture amount specified in proposed § 1.48-15(f)(4).

Proposed § 1.48-15(f)(2) would provide that an emissions tier recapture event under section 48(a)(15)(E) occurs during any taxable year of the recapture period specified in proposed § 1.48-15(f)(3) under the following circumstances: (i) the taxpayer fails to obtain an annual verification report by the deadline for filing its Federal income tax return or information return (including extensions) for any taxable year in which an annual verification report was required under proposed § 1.48-15(e)(1); (ii) the specified clean hydrogen production facility actually produced hydrogen through a process that results in a lifecycle GHG emissions rate that can only support a lower energy percentage than the energy percentage used to calculate the amount of the section 48 credit for such facility for the year in which the facility is placed in service; or (iii) the specified clean hydrogen production facility actually produced hydrogen through a process that results in a lifecycle GHG emissions rate of greater than 4 kilograms of CO2e per kilogram of hydrogen.

2. Recapture Period Under Section 48(a)(15)(E)

Proposed § 1.48-15(f)(3) would provide that the recapture period begins on the first day of the first taxable year after the taxable year in which the facility was placed in service and ends on the last day of the fifth taxable year after the close of the taxable year in which the facility was placed in service. For example, if a calendar-year taxpayer places in service a specified clean hydrogen production facility on Jun. 1, 2023, then the last day of the fifth taxable year following the close of the taxable year in which the facility was placed in service is Dec. 31, 2028. Therefore, the recapture period is Jan. 1, 2024, through Dec. 31, 2028.

### 3. Recapture Amount

Proposed § 1.48-15(f)(4) would provide that, if an emissions tier recapture event has occurred under proposed § 1.48-15(f)(2), the recapture amount for the taxable year in which the emissions tier recapture event occurred is equal to 20 percent of the excess of (i) the section 48 credit allowed to the taxpayer for the specified clean hydrogen production facility for the taxable year in which the facility was placed in service, over (ii) the section 48 credit that would have been allowed to the taxpayer for the facility if the taxpayer had used the energy percentage supported by the actual production to calculate the amount of the section 48 credit. Proposed § 1.48-15(f)(4)(ii) would provide that, in the case of any emissions tier recapture event described in proposed § 1.48-15(f)(2), the carrybacks and carryovers under section 39 must be adjusted by reason of the emissions tier recapture event. Proposed § 1.48-15(f)(4)(iii) would further provide that, if the specified clean hydrogen production facility produced hydrogen through a process that results in a lifecycle GHG emissions rate of greater than 4 kilograms of CO2e per kilogram of hydrogen, or if the taxpayer fails to submit an annual verification report with its Federal income tax return or information return with respect to a specified clean hydrogen production facility for any taxable year of the recapture period, then the section 48 credit that would have been allowed to the taxpayer for the facility would be zero. Thus, in that case, the recapture amount in the taxable year of the emissions tier recapture event would be 20 percent of the section 48 credit allowed to the taxpayer with respect to such specified clean hydrogen production facility. Proposed § 1.48-15(f)(5) would provide an example illustrating the application of proposed § 1.48-15(f)(1) through (4).

Unless modified in future guidance, any reporting of emissions tier recapture under proposed § 1.48-15(f) is made on the taxpayer's annual tax return. The Secretary may issue future guidance and/or prescribe tax forms and instructions to address the reporting of emissions tier recapture under proposed § 1.48-15(f) and any additional annual reporting obligations. The Treasury Department and IRS therefore request comments on the reporting of recapture and any additional annual reporting obligations.

4. Coordination With Recapture Rules Under Sections 50 and 48(a)(10)(C)

Proposed § 1.48-15(f)(6) would provide that, during any taxable year of the recapture period for any credit allowed under section 48(a) with respect to qualified property that is part of a specified clean hydrogen production facility, the recapture rules would be applied, if applicable, in the following order: (i) section 50(a) (recapture in case of dispositions, etc.); (ii) section 48(a)(10)(C) (recapture relating to the prevailing wage requirements); and (iii) section 48(a)(15)(E) (emissions tier recapture).

### E. Recordkeeping Requirements

Proposed § 1.45V-2(c) would provide that a taxpayer claiming the section 45V credit would need to meet the general recordkeeping requirements under section 6001 necessary to substantiate the amount of the section 45V credit claimed by the taxpayer. Section 6001 provides that every person liable for any tax imposed by the Code, or for the collection thereof, must keep such records as the Secretary may from time to time prescribe. Section 1.6001-1(a) provides that any person subject to income tax must keep such permanent books of account or records as are sufficient to establish the amount of gross income, deductions, credits, or other matters required to be shown by such person in any return of such tax.

Section 1.6001-1(e) provides that the books and records required by § 1.6001-1 must be retained so long as the contents thereof may become material in the administration of any internal revenue law. Proposed § 1.45V-2(c) would also provide that taxpayers must retain all raw data used for submission of the request for an emissions value to the DOE for at least six years after the due date (including extensions) for filing the Federal income tax return or information return to which the PER petition is ultimately attached. Proposed § 1.48-15(g) would provide corresponding recordkeeping rules.

### VIII. Renewable Natural Gas and Fugitive Sources of Methane

The Treasury Department and the IRS intend to provide rules addressing hydrogen production pathways that use renewable natural gas (RNG) or other fugitive sources of methane (for example, from coal mine operations) for purposes of the section 45V credit. In the context of this guidance, the term RNG refers to biogas that has been upgraded to be equivalent in nature to fossil natural gas. Fugitive methane refers to the release of methane through, for example, equipment leaks, or venting during the extraction, processing, transformation, and delivery of fossil fuels to the point of final use, such as coal mine methane or coal bed methane. Such rules would apply to all RNG used for the purposes of the section 45V credit and would provide conditions that must be met before certificates for RNG or fugitive methane (representations of the environmental attributes of the methane) and the GHG emissions benefits they are meant to represent may be taken into account in determining lifecycle GHG emissions rates for purposes of the section 45V credit. Such conditions would be logically consistent with but not identical to the incrementality, temporal matching, and deliverability requirements for electricity derived EACs, in that they would be designed to reflect the ways in which additional RNG or demand for fugitive methane can impact lifecycle GHG emissions and also to address the differences between electricity and methane, including but not limited to the different sources of emissions, markets, available tracking and verification methods, and potential for perverse incentives.

The Treasury Department and the IRS anticipate requiring that for purposes of the section 45V credit, for biogas or biogas-based RNG to receive an emissions value consistent with that gas (and not standard natural gas), the RNG used during the hydrogen production process must originate from the first productive use of the relevant methane. For any specific source of biogas,²⁷ productive use is generally defined as any valuable application of biogas (including to provide heat or cooling, generate electricity, or upgraded to RNG), and specifically excludes venting to the atmosphere or capture and flaring. The Treasury Department and the IRS further propose to define “first productive use” of the relevant methane as the time when a producer of that gas first begins using or selling it for productive use in the same taxable year as (or after) the relevant hydrogen production facility was placed in service. The implication of this proposal is that biogas from any source that had been productively used in a taxable year prior to taxable year in which the relevant hydrogen production facility was placed in service would not receive an emission value consistent with biogas-based RNG but would instead receive a value consistent with natural gas in the determination of the emissions value for that specific hydrogen production pathway. This proposal would limit emissions associated with the diversion of biogas or RNG from other pre-existing productive uses.

For existing biogas sources that typically productively use or sell a portion of the biogas and flare or vent the remaining excess, the flared or vented portion may be eligible for first productive use as defined above if the flaring or venting volume can be adequately demonstrated and verified. In such circumstances, the flared or vented volume may be determined based on the previous taxable year's flared or vented volume as demonstrated via reported data to programs such as the Greenhouse Gas Reporting Program. Requirements would be established to reduce the risk that entities will deliberately generate additional biogas for purposes of the section 45V credit, above historic and expected future levels or an equivalent metric, for example by generating biogas through the intentional generation of waste, and to ensure that other factors affecting the emissions rate of hydrogen produced with biogas-based RNG or RNG procurement via RNG certificates are taken into account. The Treasury Department and the IRS request comment on these and other potential conditions. Any fugitive sources of methane would be treated in the same fashion as described above for RNG.

For purposes of the section 45V credit, hydrogen producers using RNG or fugitive methane would be required to acquire and retire corresponding attribute certificates through a book-and-claim system that can verify in an electronic tracking system that all applicable requirements are met. Hydrogen producers would also be required to have a pipeline interconnection and measurement using a revenue grade meter. These rules would apply to the use of certificates with both direct and non-direct claims of RNG or fugitive methane use. Direct use would involve the production of hydrogen with a direct exclusive pipeline connection to a facility that generates RNG or from which fugitive methane is being sourced, while non-direct use would involve producing hydrogen using RNG or fugitive methane sourced from a commercial or common-carrier natural gas pipeline. In all cases, attribute certificates would need to document the RNG or fugitive methane procurement for qualified clean hydrogen production claims and that the environmental attributes of the RNG or fugitive methane being used are not sold to other parties or used for compliance with other policies or programs.

The Treasury Department and the IRS request comments on these and other rules related to RNG and fugitive methane. Regarding fugitive methane, the Treasury Department and the IRS request comment on the appropriate lifecycle analysis considerations associated with specific fugitive methane sources, such as counterfactual scenarios, to account for direct and significant indirect emissions, and also the manner in which to assess methane from these sources if the current practice is flaring. These comments may inform future versions of 45VH2-GREET. In particular, the Treasury Department and the IRS request comments on the following questions:
(1) What data sources and peer reviewed studies provide information on RNG production systems (including biogas production and reforming systems), markets, monitoring, reporting, and verification processes, and GHG emissions associated with these production systems and markets?
(2) What conditions for the use of biogas and RNG would ensure that emissions accounting for purposes of the section 45V credit reflects and reduces the risk of indirect emissions effects from hydrogen production using biogas and RNG? How can taxpayers verify that they have met these requirements?
(3) How broadly available and reliable are existing electronic tracking systems for RNG certificates in book and claim systems? What developments may be required, if any, before such systems are appropriate for use with RNG certificates used to claim the section 45V credit?
(1) How should RNG or fugitive methane resulting from the first productive use of methane be defined, documented, and verified? What industry best practices or alternative methods would enable such verification to be reflected in an RNG or methane certificate or other documentation? What additional information should be included in RNG certificates to help certify compliance?
(2) What are the emissions associated with different methods of transporting RNG or fugitive methane to hydrogen producers (for example, vehicular transport, pipeline)?
(3) How can the section 45V regulations reflect and mitigate indirect emissions effects from the diversion of biogas or RNG or fugitive methane from potential future productive uses? What other new uses of biogas or RNG or fugitive methane could be affected in the future if more gas from new capture and productive use of methane from these sources is used in the hydrogen production process?
(4) How can the potential for the generation of additional emissions from the production of additional waste, waste diversion from lower-emitting disposal methods, and changes in waste management practices be limited through emissions accounting or rules for biogas and RNG use established for purposes of the section 45V credit?
(5) To limit the additional production of waste, should the final regulations limit eligibility to methane sources that existed as of a certain date or waste or waste streams that were produced before a certain date, such as the date that the IRA was enacted? If so, how can that be documented or verified? How should any changes in volumes of waste and waste capacity at existing methane sources be documented and treated for purposes of the section 45V credit? How should additional capture of existing waste or waste streams be documented and treated?
(6) Are geographic or temporal deliverability requirements needed to reflect and reduce the risk of indirect emissions effects from biogas and RNG or fugitive methane use in the hydrogen production process? If so, what should these requirements be and are electronic tracking systems able to capture these details?
(7) How should variation in methane leakage across the existing natural gas pipeline system be taken into account in estimating the emissions from the transportation of RNG or fugitive methane or establishing rules for RNG or fugitive methane use? How should methane leakage rates be estimated based on factors such as the location where RNG or fugitive methane is injected and withdrawn, the distance between the locations where RNG or fugitive methane is injected and withdrawn, season of year, age of pipelines, or other factors? Are data or analysis available to support this?
(1) What counterfactual assumptions and data should be used to assess the lifecycle GHG emissions of hydrogen production pathways that rely on RNG? Is venting an appropriate counterfactual assumption for some pathways? If not, what other factors should be considered?
(2) What criteria should be used in assessing biogas and RNG-based PERs? What practices should be put in place to reduce the risk of unintended consequences (for example, gaming)? Should conservative default parameters and counterfactuals be used unless proven otherwise by a third party?

The Treasury Department and the IRS understand that, before final regulations addressing the section 45V credit are issued, taxpayers will use 45VH2-GREET or the PER process to determine a lifecycle GHG emissions rate for hydrogen production facilities that rely on direct use of landfill gas or any fugitive methane feedstock, provided they meet the requirement that the gas being used results from the first productive use of methane from the landfill source or fugitive methane source. The term “direct use” means that there is a direct, exclusive pipeline connection between the hydrogen production facility and the source of the gas that is procured (for example, the upgrading or processing facility that produces RNG from landfill gas).

Relative to a book-and-claim system, the direct connection between a gas supplier and a hydrogen production facility can reduce the uncertainty of pipeline leakage, tracking, and verification. The Treasury Department and the IRS are considering providing a rule that taxpayers would need to provide and maintain documentation to substantiate that (i) the RNG being used results from the first productive use of the methane at the landfill source and is not displacing a previous productive use; and (ii) the environmental attributes of the RNG being used, including those of the underlying biogas, are not sold to other parties or used for compliance with other policies or programs. When additional conditions addressing hydrogen production pathways that use RNG or fugitive methane for purposes of the section 45V credit are determined at a later date, taxpayers would also be required to maintain documentation that the RNG or fugitive methane being used meets those requirements and to acquire and retire any RNG or fugitive methane certificates that are established. The Treasury Department and IRS are also considering providing rules for using RNG certificates and documentation required in the event additional conditions for use of RNG are later imposed.

Tracking and verification mechanisms for RNG or fugitive methane specific to the needs of the section 45V credit are not yet available, and existing systems have limited capabilities for tracking and verifying RNG pathways, especially in the part of the production process before the methane has been reformed to RNG. Existing tracking and verification systems do not clearly distinguish between inputs, verify or require verification of underlying practices claimed by RNG production sources, require proof of generator interconnection or revenue-quality metering, provide validation of generation methodology, include exclusively United States based-generation, verify generator registration, and track the vintage of generator interconnection. The Treasury Department and IRS are considering providing rules to address whether or how book-and-claim systems with sufficient tracking and verification mechanisms may be used to attribute the environmental benefits of RNG or fugitive methane to hydrogen producers in the final regulations. Additional certainty is also needed to accurately account for emissions from pathways that do not yet exist in 45VH2-GREET and from RNG that is injected into a commercial or common-carrier pipeline. The Treasury Department and IRS understand that, before final regulations are issued, taxpayers will determine a lifecycle GHG emissions rate for hydrogen production pathways using landfill gas by using 45VH2-GREET in cases in which the hydrogen production facility is receiving RNG through a direct dedicated pipeline connection and measurement using a revenue grade meter. The PER process will not address other hydrogen production pathways using biogas and RNG until after the final regulations are issued.

### Proposed Applicability Dates

These regulations are proposed to apply to taxable years beginning after these proposed regulations are published in the Federal Register. Taxpayers may rely on these proposed regulations for taxable years beginning after Dec. 31, 2022, and before the date the final regulations are published in the Federal Register, provided the taxpayers follow the proposed regulations in their entirety and in a consistent manner.

### Special Analyses

### I. Regulatory Planning and Review

Pursuant to the Memorandum of Agreement, Review of Treasury Regulations under Executive Order 12866 (Jun. 9, 2023), tax regulatory actions issued by the IRS are not subject to the requirements of section 6 of Executive Order 12866, as amended. Therefore, a regulatory impact assessment is not required.

### II. Paperwork Reduction Act

The Paperwork Reduction Act of 1995 (44 U.S.C. 3501-3520) (PRA) generally requires that a Federal agency obtain the approval of the Office of Management and Budget (OMB) before collecting information from the public, whether such collection of information is mandatory, voluntary, or required to obtain or retain a benefit. A Federal agency may not conduct or sponsor, and a person is not required to respond to, a collection of information unless the collection of information displays a valid control number.

The collections of information in these proposed regulations would include reporting, third-party disclosure, and recordkeeping requirements. These collections are necessary for taxpayers to claim the section 45V credit, or the section 48 credit with respect to a specified clean hydrogen production facility, and for the IRS to validate that taxpayers have met the regulatory requirements and are entitled to claim either credit.

The recordkeeping requirements in these proposed regulations would include the requirement that taxpayers claiming the section 45V credit, or the section 48 credit with respect to a specified clean hydrogen production facility, need to meet the general recordkeeping provisions under section 6001 necessary to substantiate the amount of the section 45V credit or section 48 credit claimed by the taxpayer as detailed in proposed §§ 1.45V-2(c) and 1.48-15(g). These recordkeeping requirements are considered general tax records under § 1.6001-1(e). For PRA purposes, general tax records are already approved by OMB under 1545-0074 for individuals/sole proprietors, 1545-0123 for business entities, and 1545-0047 for tax-exempt organizations, and 1545-0092 for trust and estate filers.

The proposed regulations would reference the DOE's process for applicants to request an emissions value from the DOE that could then be used to file a petition with the Secretary for a PER determination as detailed in proposed § 1.45V-4. The petition made to IRS will be performed by attaching the emissions value obtained from the DOE to the filing of Form 7210. The burden for these requirements will be included within the Form and Instructions for 7210. Form 7210 will be approved by OMB, in accordance with 5 CFR 1320.10, under the following OMB Control Numbers: 1545-0074 for individuals, 1545-0123 for businesses, 1545-0047 for tax-exempt organizations, and 1545-NEW for trust and estate filers.

The proposed regulations mention the collection of information associated with the process for taxpayers to request an emissions value from the DOE and is reflected in the DOE's Paperwork Reduction Act Submission relating to such process. These proposed regulations are not creating or changing any of the collection requirements submitted by DOE to OMB for approval. Approval of the DOE's Paperwork Reduction Act Submission is pending with OMB. These proposed regulations are not creating or changing any of the collection requirements being approved by OMB under the DOE OMB Control Number 1910-XXXX.

The proposed regulations would include reporting requirements that taxpayers claiming the section 45V credit provide a verification report with their annual Federal income tax return or information return for each taxable year in which they claim the section 45V credit as detailed in proposed § 1.45V-5. The proposed regulation also includes a third-party disclosure requirement that a verification report must be certified by an unrelated third party. The verification report must contain an attestation regarding the taxpayer's production of qualified clean hydrogen for sale or use, the amount of qualified clean hydrogen sold or used by the taxpayer, conflicts of interest, the verifier's qualifications, and documentation necessary to substantiate the verification process. The taxpayer must submit the verification report to the IRS by attaching it to Form 7210, Clean Hydrogen Production Credit, or any successor form(s). The burden for these requirements will be included within the Form and Instructions for Form 7210. Form 7210 will be approved by OMB, in accordance with 5 CFR 1320.10, under the following OMB Control Numbers: 1545-0074 for individuals, 1545-0123 for businesses, 1545-0047 for tax-exempt organizations, and 1545-NEW for trust and estate filers.

The proposed regulations include reporting, third-party disclosure, and recordkeeping requirements that taxpayers making the election under section 48(a)(15) to claim the energy credit under section 48 with respect to a specified clean hydrogen production facility. The reporting requirement is that taxpayers submit an annual verification report with their Federal income tax return or information return for the year in which they claim the section 48 credit. The third-party disclosure requirement is that an annual verification report must be certified by an unrelated third-party. The annual verification report must contain an attestation regarding the taxpayer's production of qualified clean hydrogen for sale or use, the amount of qualified clean hydrogen sold or used by the taxpayer, conflicts of interest, the verifier's qualifications, the lifecycle GHG emissions rate of the hydrogen that the specified clean hydrogen production facility produced, and documentation necessary to substantiate the verification process. The proposed regulations also include a requirement that the taxpayer obtain and retain an annual verification report for each taxable year of the recapture period. The taxpayer must obtain the annual verification report by the return filing deadline (with extensions) for the taxable year to which the annual verification report relates.

The annual verification report must contain an attestation regarding the taxpayer's production of qualified clean hydrogen for sale or use during the taxable year, the amount of qualified clean hydrogen sold or used by the taxpayer during the taxable year, the lifecycle GHG emissions rate of the hydrogen that the specified clean hydrogen production facility produced during the taxable year, conflicts of interest, the verifier's qualifications, and documentation necessary to substantiate the verification process. The annual verification report for the taxable year in which the section 48(a)(15) election is made will be attached to Form 3468.

The annual verification report for each taxable year of the recapture period will be retained by the taxpayer for at least six years after the due date (with extensions) for filing the Federal income tax return or information return for the year to which the report relates. The burden for these requirements will be included within the Form and Instructions for 3468. The revisions to Form 3468 will be approved by OMB, in accordance with 5 CFR 1320.10, under the following OMB Control Numbers: 1545-0074 for individuals, 1545-0123 for businesses, 1545-0047 for tax exempt organizations, and 1545-0155 for trust and estate filers.

### III. Regulatory Flexibility Act

The Regulatory Flexibility Act (5 U.S.C. 601 et seq.) (RFA) imposes certain requirements with respect to Federal rules that are subject to the notice and comment requirements of section 553(b) of the Administrative Procedure Act (5 U.S.C. 551 et seq.) and that are likely to have a significant economic impact on a substantial number of small entities. Unless an agency determines that a proposal is not likely to have a significant economic impact on a substantial number of small entities, section 603 of the RFA requires the agency to present an initial regulatory flexibility analysis (IRFA) of the proposed rule. The Treasury Department and the IRS have not determined whether the proposed rule, when finalized, will likely have a significant economic impact on a substantial number of small entities.

This determination requires further study. However, because there is a possibility of significant economic impact on a substantial number of small entities, an IRFA is provided in these proposed regulations. The Treasury Department and the IRS invite comments on both the number of entities affected and the economic impact on small entities. Pursuant to section 7805(f), this notice of proposed rulemaking has been submitted to the Chief Counsel of the Office of Advocacy of the Small Business Administration for comment on its impact on small business.

### A. Need for and Objectives of the Rule

The proposed regulations provide guidance to taxpayers intending to claim the section 45V credit for the production of qualified clean hydrogen or make the election under section 48(a)(15) to treat qualified property that is part of a specified clean hydrogen production facility as energy property and claim the section 48 credit. The proposed regulations would provide needed guidance for taxpayers on use of the GREET model to determine the lifecycle GHG emissions rate resulting from the hydrogen production process, procedures for petitioning the Secretary for a PER determination, requirements for the verification of the production and sale or use of the hydrogen, requirements for modifications to an existing hydrogen production facility, and procedures for making the election under section 48(a)(15).

### B. Affected Small Entities

The RFA directs agencies to provide a description of, and if feasible, an estimate of, the number of small entities that may be affected by the proposed rules, if adopted. The Small Business Administration's Office of Advocacy estimates in its 2023 Frequently Asked Questions that 99.9 percent of American businesses meet the definition of a small business. The applicability of these proposed regulations does not depend on the size of the business, as defined by the Small Business Administration. As described more fully in the preamble to this proposed regulation and in this IRFA, sections 45V and 48(a)(15) and these proposed regulations may affect a variety of different businesses across several different industries. Because the potential credit claimants can vary widely, it is difficult to estimate at this time the impact of these proposed regulations, if any, on small businesses. Although there is uncertainty as to the exact number of small businesses within this group, the current estimated number of respondents to these proposed rules is between 800 and 1000 taxpayers.

The Treasury Department and the IRS expect to receive more information on the impact on small businesses through comments on these proposed rules and again when taxpayers start using the guidance and procedures provided in these proposed regulations to claim the section 45V credit, or the section 48 credit with respect to a specified clean hydrogen production facility.

### C. Impact of the Rules

The proposed regulations provide rules for how taxpayers can claim the section 45V credit, or the section 48 credit with respect to a specified clean hydrogen production facility. Taxpayers that claim the section 45V credit, or the section 48 credit with respect to a specified clean hydrogen production facility, will have administrative costs related to reading and understanding the rules as well as recordkeeping and reporting requirements because of the verification and Federal income tax return or information return requirements. The costs will vary across different-sized entities and across the type of project(s) in which such entities are engaged.

To claim a section 45V credit, a taxpayer must determine the lifecycle GHG emissions rate for all hydrogen produced at a qualified clean hydrogen production facility during the taxable year. If the hydrogen production technology or feedstock used by the taxpayer to produce hydrogen is addressed in the most recent 45VH2-GREET, the taxpayer must use 45VH2-GREET to determine the emissions rate for the hydrogen produced during that taxable year at the qualified clean hydrogen production facility. If the hydrogen production technology or feedstock used by the taxpayer to produce hydrogen is not included in the most recent 45VH2-GREET, the taxpayer must petition the Secretary for a provisional emissions rate (PER). As part of the process for a taxpayer to petition for a PER, a taxpayer must submit an application to the DOE for an emissions value that it may use to claim the section 45V credit.

In addition to determining the lifecycle GHG emissions rate for hydrogen produced by the taxpayer at a qualified clean hydrogen production facility during the taxable year, before claiming the section 45V credit, a taxpayer must submit a verification report, certified by an unrelated third party, attesting to the taxpayer's production of qualified clean hydrogen for sale or use, the amount of qualified clean hydrogen sold or used by the taxpayer, conflicts of interest, the verifier's qualifications, and documentation necessary to substantiate the verification process. The process for claiming the section 48 credit with respect to a specified clean hydrogen production facility requires a taxpayer to submit an annual verification report with its Federal income tax return or information return for the taxable year in which it claims the section 48 credit, as well as to obtain an annual verification report for the five taxable years following the taxable year in which the section 48(a)(15) election is made. Additionally, the taxpayer would need to retain records sufficient to establish compliance with these proposed regulations for as long as may be relevant.

Although the Treasury Department and the IRS do not have sufficient data to determine precisely the likely extent of the increased costs of compliance, the estimated burden of complying with the recordkeeping and reporting requirements are described in the Paperwork Reduction Act section of the preamble.

### D. Alternatives Considered

The Treasury Department and the IRS considered alternatives to the proposed regulations. The proposed regulations were designed to minimize burdens for taxpayers while ensuring that the statutory requirements of sections 45V and 48(a)(15) are met. For example, in providing rules related to the information required to be submitted to claim the section 45V credit, or the section 48 credit with respect to a specified hydrogen production facility, the Treasury Department and the IRS considered whether the production and sale or use of the hydrogen could be verified by an unrelated party without requiring the unrelated party to possess certain qualifications or conflict of interest characteristics. Such an option would, however, increase the opportunity for fraud or excessive payments under section 45V or section 48. Section 45V(f) specifically authorizes the IRS to promulgate regulations or other guidance providing for requirements for recordkeeping or information reporting for purposes of administering the requirements of section 45V. As described in the preamble to these proposed regulations, these proposed rules carry out that Congressional intent as the verification requirements allow the IRS to verify the taxpayer's entitlement to the section 45V credit.

Additionally, the Treasury Department and the IRS considered whether to require taxpayers to submit an annual verification report with their Federal income tax returns or information returns claiming the section 45V credit. Section 45V requires the taxpayer to obtain an annual verification report, and the Treasury Department and the IRS determined that requiring the taxpayer to attach such a report to their federal income tax return or information return is the most efficient way of ensuring the completion and accuracy of the report.

Additionally, the Treasury Department and the IRS considered allowing taxpayers to treat the section 45V credit as determined in the taxable year of hydrogen production or verification. However, such an option would create administrability issues and potentially a mismatch between the taxable year in which the hydrogen is produced and the taxable year in which the section 45V credit for such production is claimed. Thus, the proposed regulations would require the credit to be determined in the taxable year of production.

Comments are requested on the requirements in the proposed regulations, including specifically whether there are less burdensome alternatives that do not increase the risk of duplication, fraud, or improper payments under section 45V.

### E. Duplicative, Overlapping, or Conflicting Federal Rules

The proposed regulations would not duplicate, overlap, or conflict with any relevant Federal rules. As discussed above, the proposed regulations would merely provide procedures and definitions to allow taxpayers to claim the section 45V credit, or the section 48 credit with respect to a specified clean hydrogen production facility. The Treasury Department and the IRS invite input from interested members of the public on identifying and avoiding overlapping, duplicative, or conflicting requirements.

### IV. Unfunded Mandates Reform Act

Section 202 of the Unfunded Mandates Reform Act of 1995 (UMRA) requires that agencies assess anticipated costs and benefits and take certain other actions before issuing a final rule that includes any Federal mandate that may result in expenditures in any one year by a State, local, or Tribal government, in the aggregate, or by the private sector, of $100 million (updated annually for inflation). This proposed rule does not include any Federal mandate that may result in expenditures by State, local, or Tribal governments, or by the private sector in excess of that threshold.

### V. Executive Order 13132:

Federalism Executive Order 13132 (Federalism) prohibits an agency from publishing any rule that has federalism implications if the rule either imposes substantial, direct compliance costs on State and local governments, and is not required by statute, or preempts State law, unless the agency meets the consultation and funding requirements of section 6 of the Executive order. This proposed rule does not have federalism implications and does not impose substantial direct compliance costs on State and local governments or preempt State law within the meaning of the Executive order.

### Comments and Public Hearing

Before these proposed regulations are adopted as final regulations, consideration will be given to comments regarding the notice of proposed rulemaking that are submitted timely to the IRS as prescribed in the preamble under the ADDRESSES section. The Treasury Department and the IRS request comments on all aspects of the proposed regulations. All comments will be made available at https://www.regulations.gov. Once submitted to the Federal eRulemaking Portal, comments cannot be edited or withdrawn.

A public hearing has been scheduled for Mar. 25, 2024, beginning at 10 a.m. (ET), in the Auditorium at the Internal Revenue Building, 1111 Constitution Avenue NW, Washington, DC. Due to building security procedures, visitors must enter at the Constitution Avenue entrance. In additional, all visitors must present photo identification to enter the building. Because of access restrictions, visitors will not be admitted beyond the immediate entrance area more than 30 minutes before the hearing starts. Participants may alternatively attend the public hearing by telephone.

The rules of 26 CFR 601.601(a)(3) apply to the hearing. Persons who wish to present oral comments at the hearing must submit an outline of the topics to be discussed and the time to be devoted to each topic by Mar. 4, 2024. A period of 10 minutes will be allotted to each person for making comments. An agenda showing the scheduling of the speakers will be prepared after the deadline for receiving outlines has passed. Copies of the agenda will be available free of charge at the hearing.

If no outline of the topics to be discussed at the hearing is received by Mar. 4, 2024, the public hearing will be cancelled. If the public hearing is cancelled, a notice of cancellation of the public hearing will be published in the Federal Register.

Individuals who want to testify in person at the public hearing must send an email to publichearings@irs.gov to have your name added to the building access list. The subject line of the email must contain the regulation number REG-117631-23 and the language TESTIFY in Person. For example, the subject line may say: Request to TESTIFY in Person at Hearing for REG-117631-23.

Individuals who want to testify by telephone at the public hearing must send an email to publichearings@irs.gov to receive the telephone number and access code for the hearing. The subject line of the email must contain the regulation number RE-117631-23 and the language TESTIFY Telephonically. For example, the subject line may say: Request to TESTIFY Telephonically at Hearing for REG-117631-23.

Individuals who want to attend the public hearing in person without testifying must also send an email to publichearings@irs.gov to have your name added to the building access list. The subject line of the email must contain the regulation number REG-117631-23 and the language ATTEND In Person. For example, the subject line may say: Request to ATTEND Hearing in Person for REG-117631-23. Requests to attend the public hearing must be received by 5:00 p.m. EST on Mar. 18, 2024.

Hearings will be made accessible to people with disabilities. To request special assistance during a hearing please contact the Publications and Regulations Branch of the Office of Associate Chief Counsel (Procedure and Administration) by sending an email to publichearings@irs.gov (preferred) or by telephone at (202) 317-6901 (not a toll-free number) by at least Mar. 18, 2024.

### Statement of Availability of IRS Documents

IRS guidance cited in this preamble is published in the Internal Revenue Bulletin and is available from the Superintendent of Documents, U.S. Government Publishing Office, Washington, DC 20402, or by visiting the IRS website at https://www.irs.gov.

### Drafting Information

The principal author of these proposed regulations is the Office of the Associate Chief Counsel (Passthroughs and Special Industries). However other personnel from the Treasury Department, the DOE, the EPA, and the IRS participated in the development of the proposed regulations.

### List of Subjects in 26 CFR Part 1

Income taxes, Reporting and recordkeeping requirements.

### Proposed Amendments to the Regulations

Accordingly, the Treasury Department and the IRS propose to amend 26 CFR part 1 as follows:

### Part 1—Income Taxes

Paragraph 1. The authority citation for part 1 is amended by adding entries in numerical order for §§ 1.45V-1 through 1.45V-6 and 1.48-15 to read in part as follows: Authority: 26 U.S.C. 7805, Section 1.45V-1 also issued under 26 U.S.C. 45V(f).Section 1.45V-2 also issued under 26 U.S.C. 45V(f). Section 1.45V-3 also issued under 26 U.S.C. 45V(e) and (f). Section 1.45V-4 also issued under 26 U.S.C. 45V(f). Section 1.45V-5 also issued under 26 U.S.C. 45V(f). Section 1.45V-6 also issued under 26 U.S.C. 45V(c) and (d). Section 1.48-15 also issued under 26 U.S.C. 48(a)(15).
Par. 2. Sections 1.45V-0 through 1.45V-6 are added to read as follows: Sec. 1.45V-0 Table of contents. 1.45V-1 Credit for production of qualified clean hydrogen. 1.45V-2 Special rules. 1.45V-3 [Reserved] 1.45V-4 Procedures for determining lifecycle greenhouse gas emissions rates for qualified clean hydrogen. 1.45V-5 Procedures for verification of qualified clean hydrogen production and sale or use. 1.45V-6 Rules for determining the placed in service date for an existing facility that is modified to produce qualified clean hydrogen.
§ 1.45V-0 Table of contents. This section lists the captions contained in §§ 1.45V-1 through 1.45V-6. § 1.45V-1 Credit for production of qualified clean hydrogen. Overview. (1) In general. (2) Applicable amount. (i) In general. (ii) Inflation adjustment. (3) Applicable percentage. (4) Claim. (5) Code. (6) DOE. (7) Facility. (i) In general. (ii) Treatment of certain indirect production and post-production equipment. (iii) Multipurpose components. (iv) Example. (8) Lifecycle GHG emissions. (i) In general. (ii) Most recent GREET model. (iii) Emissions through the point of production (well-to-gate). (9) Qualified clean hydrogen. (i) In general.) (ii) For sale or use. (10) Qualified clean hydrogen production facility. (11) Secretary. (12) Section 45V credit. (13) Section 45V regulations. (b) Amount of credit. (1) In general. (2) Producer of qualified clean hydrogen. (3) Increased credit amount for qualified clean hydrogen production facilities. (d) Applicability date.
§ 1.45V-2 Special rules. (a) Coordination with credit for carbon oxide sequestration. (b) Anti-abuse rule. (1) In general. (2) Example. (i) Facts. (ii) Analysis. (c) Recordkeeping. (d) Applicability date.

### § 1.45V-3 [Reserved].

§ 1.45V-4 Procedures for determining lifecycle greenhouse gas emissions rates for qualified clean hydrogen. (a) In general. (b) Use of the most recent GREET model. (c) Provisional emissions rate (PER). (1) In general. (ii) Subsequent inclusion in 45VH2-GREET. (3) Process for filing a PER petition. (4) PER determination. (5) Department of Energy emissions value request process. (6) Effect of PER. (d) Use of Energy Attribute Certificates (EACs). (1) In general. (2) Definitions. (i) Commercial operations date. (ii) Energy attribute certificate. (iii) Eligible EAC. (iv) Qualifying EAC. (v) Qualified EAC registry or accounting system; (vi) Region. (3) Qualifying EAC requirements. (i) Incrementality. (ii) Temporal Matching. (iii) Deliverability. (e) Applicability date.

§ 1.45V-5 Procedures for verification of qualified clean hydrogen production and sale or use. (a) In general. (b) Requirements for verification reports. (c) Requirements for the production attestation. (d) Requirements for the sale or use attestation. (1) In general. (2) Verifiable use. (e) Requirements for the conflict attestation. (1) In general. (2) Special rule for transfer elections. (f) Requirements for the qualified verifier statement. (g) General information on the taxpayer's hydrogen production facility. (h) Qualified verifier. (i) Unrelated party. (j) requirements for taxpayers claiming both the section 45V credit and the section 45 credit or the section 45 U credit.

§ 1.45V-6 Rules for determining the placed in service date for an existing facility that is modified to produce qualified clean hydrogen. (a) Modification of an existing facility. (1) In general. (2) Modification requirements. (b) Retrofit of an Existing Facility (80/20 Rule). (c) Examples. (1) Example 1: Modification of an existing facility. (i) Facts. (ii) Analysis. (2) Example 2: Modification of an existing facility; coordination with the section 45Q credit previously allowed. (i) Facts. (ii) Analysis. (3) Example 3: Modification of an existing facility and coordination with section 45Q credit not previously allowed. (i) Facts. (ii) Analysis. (4) Example 4: Retrofit of an Existing Facility (80/20 Rule) and coordination with section 45Q credit previously allowed. (i) Facts. (ii) Analysis. (5) Example 5: Retrofit of an Existing Facility (80/20 Rule) and coordination with section 45Q credit previously allowed. (i) Facts. (ii) Analysis. (d) Applicability date.

### § 1.45V-1 Credit for Production of Clean Hydrogen.

### (a) Overview—

### (1) In General.

For purposes of section 38 of the Code, the section 45V credit is determined under section 45V of the Code, so much of sections 6417 and 6418 of the Code that relate to section 45V, and the section 45V regulations (as defined in paragraph (a)(13) of this section). Paragraphs (a)(2) through (13) of this section provide generally applicable definitions of terms that, unless otherwise provided, apply for purposes of section 45V, the section 45V regulations, and any provision of the Code or this chapter that expressly refers to any provision of section 45V or the section 45V regulations. Paragraph. (b) of this section provides rules for determining the amount of the section 45V credit for any taxable year, which generally depends on the kilograms of qualified clean hydrogen produced during the taxable year and the emissions intensity of the process used to produce such hydrogen, as well as whether certain requirements, including the requirements under § 1.45V-3, are satisfied. Paragraph (c) of this section provides rules regarding the taxable year for which a section 45V credit is determined. See § 1.45V-2 for special rules, including rules to coordinate the section 45V credit with the credit for carbon oxide sequestration determined under section 45Q of the Code, an anti-abuse rule, and recordkeeping requirements. See § 1.45V-3 for rules relating to the increased credit amount for satisfying the prevailing wage and apprenticeship requirements. See § 1.45V-4 for procedures to determine lifecycle greenhouse gas (GHG) emissions rates for qualified clean hydrogen and § 1.45V-5 for procedures for verification of qualified clean hydrogen production and sale or use. See § 1.45V-6 for rules to determine the placed in service date for an existing facility that is modified or retrofitted to produce qualified clean hydrogen. See also § 1.48-15 for procedures to elect to treat any qualified property that is part of a specified clean hydrogen production facility as energy property for purposes of section 48 of the Code.

### (2) Applicable Amount—

### (i) In General.

The term applicable amount means the amount equal to the applicable percentage of $0.60, provided that if any such amount is not a multiple of 0.1 cent, such amount is rounded to the nearest multiple of 0.1 cent.

### (ii) Inflation Adjustment.

The $0.60 amount specified in section 45V(b)(1) and paragraph (a)(2)(i) of this section is adjusted annually by multiplying such amount by the inflation adjustment factor (as determined under section 45(e)(2) of the Code, determined by substituting “2022” for “1992” in section 45(e)(2)(B)) for the calendar year in which the qualified clean hydrogen is produced, provided that if any such amount as adjusted is not a multiple of 0.1 cent, such amount is rounded to the nearest multiple of 0.1 cent.

### (2) Applicable Percentage.

The term applicable percentage means the percentage set forth in paragraphs (a)(3)(i) through (iv) of this section, which is determined according to the lifecycle GHG emissions rate of the process by which the qualified clean hydrogen is produced:
(i) In the case of any qualified clean hydrogen that is produced through a process that results in a lifecycle GHG emissions rate of not greater than 4 kilograms of carbon dioxide equivalent (CO2e) per kilogram of hydrogen, and not less than 2.5 kilograms of CO2e per kilogram of hydrogen, the applicable percentage is 20 percent.
(ii) In the case of any qualified clean hydrogen that is produced through a process that results in a lifecycle GHG emissions rate of less than 2.5 kilograms of CO2e per kilogram of hydrogen, and not less than 1.5 kilograms of CO2e per kilogram of hydrogen, the applicable percentage is 25 percent.
(iii) In the case of any qualified clean hydrogen that is produced through a process that results in a lifecycle GHG emissions rate of less than 1.5 kilograms of CO2e per kilogram of hydrogen, and not less than 0.45 kilograms of CO2e per kilogram of hydrogen, the applicable percentage is 33.4 percent.
(iv) In the case of any qualified clean hydrogen that is produced through a process that results in a lifecycle GHG emissions rate of less than 0.45 kilograms of CO2e per kilogram of hydrogen, the applicable percentage is 100 percent.

### (3) Claim.

With respect to the section 45V credit determined for qualified clean hydrogen produced by the taxpayer at a qualified clean hydrogen production facility, the term claim means the filing of a completed Form 7210, Clean Hydrogen Production Credit, or any successor form(s), with the taxpayer's Federal income tax return or annual information return for the taxable year in which the credit is determined, and includes the making of an election under section 6417 or 6418 and the regulations in this chapter under section 6417 or 6418, as applicable, with respect to such section 45V credit on the applicable entity's or eligible taxpayer's timely filed (including extensions) Federal income tax return or annual information return.

### (3) Code.

The term Code means the Internal Revenue Code.

### (4) DOE.

The term DOE means the U.S. Department of Energy.

### (5) Facility—

### (i) In General.

For purposes of the definition of qualified clean hydrogen production facility provided at section 45V(c)(3) and paragraph (a)(10) of this section, unless otherwise specified, the term facility means a single production line that is used to produce qualified clean hydrogen. A single production line includes all components of property that function interdependently to produce qualified clean hydrogen. Components of property function interdependently to produce qualified clean hydrogen if the placing in service of each component is dependent upon the placing in service of each of the other components to produce qualified clean hydrogen.

### (ii) Treatment of Certain Indirect Production and Post-Production Equipment.

The term facility does not include—
(A) Equipment that is used to condition or transport hydrogen beyond the point of production; or
(B) Notwithstanding paragraph (a)(7)(iii) of this section, electricity production equipment used to power the hydrogen production process, including any carbon capture equipment associated with the electricity production process.
   (iii) Multipurpose Components.

Components that have a purpose in addition to the production of qualified hydrogen may be part of a facility if such components function interdependently with other components to produce qualified clean hydrogen.

### (iv) Example.

The following example illustrates the definition of facility provided in this paragraph (a)(7). A hydrogen production facility is equipped with carbon capture equipment (as defined in § 1.45Q-2(c)), as distinguished from the carbon capture equipment described in paragraph (a)(7)(ii)(B) of this section. One purpose of this equipment is the capture of carbon oxides. The facility produces hydrogen through a process that results in a lifecycle GHG emissions rate falling within the range specified in section 45V(b)(2)(C). Without the carbon capture equipment, the facility could not produce hydrogen through a process that results in a lifecycle GHG emissions rate falling within the range specified in section 45V(b)(2)(C). Because the carbon capture equipment is functionally interdependent with other components of property to produce qualified clean hydrogen within the meaning of paragraph (a)(9)(i) of this section, the carbon capture equipment is part of the facility for purposes of section 45V(c)(3) and the regulations in this part under section 45V, along with all other components of property that function interdependently with the carbon capture equipment to produce qualified clean hydrogen.

### (6) Lifecycle GHG Emissions—

### (i) In General.

Subject to section 45V(c)(1)(B) and paragraphs (a)(8)(ii) and (iii) of this section, and unless otherwise specified in the section 45V regulations, the term lifecycle GHG emissions has the meaning given the term lifecycle greenhouse gas emissions by 42 U.S.C. 7545(o)(1)(H), as in effect on Aug. 16, 2022. For purposes of section 45V, lifecycle GHG emissions include emissions only through the point of production (well-to-gate), as determined under the most recent Greenhouse gases, Regulated Emissions, and Energy use in Transportation model (GREET model) developed by Argonne National Laboratory, or a successor model.

### (ii) Most Recent GREET Model.

Unless otherwise specified in the section 45V regulations, for purposes of the section 45V credit, the term most recent GREET model means the latest version of 45VH2-GREET developed by Argonne National Laboratory that is publicly available, as provided in the instructions to the latest version of Form 7210, Clean Hydrogen Production Credit, or any successor form(s), on the first day of the taxable year during which the qualified clean hydrogen for which the taxpayer is claiming the section 45V credit was produced. If a version of 45VH2-GREET becomes publicly available after the first day of the taxable year of production (but still within such taxable year), then the taxpayer may, in its discretion, treat such later version of 45VH2-GREET as the most recent GREET model.

(iii) Emissions Through the Point of Production (Well-to-Gate).

The term emissions through the point of production (well-to-gate) means the aggregate lifecycle GHG emissions related to hydrogen produced at a hydrogen production facility during the taxable year through the point of production. It includes emissions associated with feedstock growth, gathering, extraction, processing, and delivery to a hydrogen production facility. It also includes the emissions associated with the hydrogen production process, inclusive of the electricity used by the hydrogen production facility and any capture and sequestration of carbon dioxide generated by the hydrogen production facility.

### (7) Qualified Clean Hydrogen—

### (i) In General.

The term qualified clean hydrogen means hydrogen that is produced through a process that results in a lifecycle GHG emissions rate of not greater than 4 kilograms of CO2e per kilogram of hydrogen. Such term does not include any hydrogen unless the production and sale or use of such hydrogen is verified by an unrelated party in accordance with, and satisfying the requirements of, § 1.45V-5, and such hydrogen is produced—
(A) In the United States (as defined in section 638(1) of the Code) or a United States territory, which, for purposes of section 45V and the regulations in this part under section 45V, has the meaning of the term possession provided in section 638(2) of the Code;
(B) In the ordinary course of a trade or business of the taxpayer; and
(C) For sale or use.

### (ii) for Sale or Use.

The term for sale or use means for the primary purpose of making ready and available for sale or use. Storage of hydrogen following production does not disqualify such hydrogen from being considered produced for sale or use.

### (8) Qualified Clean Hydrogen Production Facility.

The term qualified clean hydrogen production facility means a facility—
(i) Owned by the taxpayer;
(ii) That produces qualified clean hydrogen; and
(iii) The construction of which begins before Jan. 1, 2033.

### (9) Secretary.

The term Secretary means the Secretary of the Treasury or her delegate.

### (10) Section 45V Credit.

The term section 45V credit means the credit for-production of clean hydrogen determined under section 45V of the Code, so much of sections 6417 and 6418 of the Code that relate to section 45V, and the section 45V regulations.

### (11) Section 45V Regulations.

The term section 45V regulations means this section, §§ 1.45V-2 through 1.45V-6, and the regulations in this chapter under sections 6417 and 6418 of the Code that relate to the section 45V credit.

### (b) Amount of Credit—

### (1) In General.

The amount of the section 45V credit determined under section 45V(a) and the section 45V regulations for any taxable year is the product of the kilograms of qualified clean hydrogen produced by the taxpayer during such taxable year at a qualified clean hydrogen production facility during the 10-year period beginning on the date such facility was originally placed in service, multiplied by the applicable amount with respect to such hydrogen.

### (2) Producer of Qualified Clean Hydrogen.

The term taxpayer means the taxpayer that owns the qualified clean hydrogen production facility at the time of the facility's production of hydrogen for which the section 45V credit is claimed, regardless of whether such taxpayer is treated as a producer under section 263A of the Code or under any other provision of law with respect to such hydrogen.

(3) Increased Credit Amount for Qualified Clean Hydrogen Production facilities.

Pursuant to section 45V(e)(1),
§ 1.45V-3 provides rules that permit the amount of the section 45V credit determined under section 45V(a) and paragraph (b) (1) of this section to be multiplied by five if certain requirements related to prevailing wages and apprenticeships are met. See
§ 1.45V-3 (a).

### (c) Determination of Credit.

Subject to any applicable sections of the Code that may limit the section 45V credit amount, the section 45V credit for any taxable year of a taxpayer who produces qualified clean hydrogen and claims such credit is determined with respect to the qualified clean hydrogen produced by the taxpayer during that taxable year, regardless of whether the verification of the production and sale or use of that hydrogen occurs in a later taxable year. Although the section 45V credit is determined with respect to the taxable year in which the qualified clean hydrogen is produced, a taxpayer is not eligible to claim the section 45V credit with respect to the production of that hydrogen until all relevant verification requirements, and the verification itself, have been completed for both the production of the hydrogen and the sale or use of that hydrogen. Accordingly, although the sale or use of the hydrogen and the verification thereof may occur in a taxable year after the taxable year of production, the section 45V credit is properly claimed with respect to the taxable year of production and is subject to the general period of limitations for filing a claim for credit or refund under section 6511 and other applicable provisions of the Code.

### (d) Applicability Date.

This section applies to taxable years beginning after Dec. 26, 2023.

### § 1.45V-2 Special Rules.

(a) Coordination with Credit for Carbon Oxide Sequestration.

In the case of any qualified clean hydrogen produced at a qualified clean hydrogen production facility that includes carbon capture equipment for which a credit is allowed to any taxpayer under section 45Q of the Code (section 45Q credit) for the taxable year or any prior taxable year, no section 45V credit is allowed under section 45V of the Code. However, if the 80/20 Rule provided in
§ 1.45Q-2(g)(5) is satisfied with respect to such carbon capture equipment, and no new section 45Q credit has been allowed to any taxpayer for such carbon capture equipment, then the unit of carbon capture equipment (as defined in
§ 1.45Q-2(c)(3)) for which the 80/20 rule is satisfied will not be treated as carbon capture equipment for which a section 45Q credit was allowed to any taxpayer for any prior taxable year for purposes of section 45V(d)(2) and this paragraph (a).

### (b) Anti-Abuse Rule—

### (1) In General

The rules of section 45V of the Code (and so much of sections 6417 and 6418 of the Code related to the section 45V credit) and the section 45V regulations (as defined in § 1.45V-1(a)(13)) must be applied in a manner consistent with the purposes of section 45V and the section 45V regulations. A purpose of section 45V and the regulations in this part under section 45V (and so much of sections 6417 and 6418 and the regulations in this chapter under sections 6417 and 6418 related to the section 45V credit) is to provide taxpayers an incentive to produce qualified clean hydrogen for a productive use. Accordingly, the section 45V credit is not allowable if the primary purpose of the production and sale or use of qualified clean hydrogen is to obtain the benefit of the section 45V credit in a manner that is wasteful, such as the production of qualified clean hydrogen that the taxpayer knows or has reason to know will be vented, flared, or used to produce hydrogen. A determination of whether the production and sale or use of qualified clean hydrogen is inconsistent with the purposes of section 45V and the regulations in this part under section 45V of the Code is based on all facts and circumstances.

### (2) Example

### (i) Facts.

Taxpayer is a C corporation that has a calendar year taxable year. In 2031, Taxpayer places Facility in service in the United States. Facility produces qualified clean hydrogen that qualifies for the highest applicable amount of the section 45V credit at a production cost of $2 per kilogram of hydrogen (assuming Taxpayer also claims the increased credit under section 45V(e), without taking into account any future inflation adjustment, the amount of the section 45V credit would be $3 per kilogram of qualified clean hydrogen). The cost of producing each kilogram of qualified clean hydrogen is less than the amount of the section 45V credit that would be available if Taxpayer qualified for the section 45V credit. In 2031, Taxpayer sells all the qualified clean hydrogen produced at Facility that year to Customer at a price that is well below the current market price. Taxpayer knows or reasonably expects that Customer will vent or flare a portion of the qualified clean hydrogen it purchased from Taxpayer. In addition, Taxpayer intends to obtain the benefit from the section 45V credit by claiming such credit itself or monetizing such credits through an election under section 6417 or 6418 of the Code.

### (ii) Analysis.

Based on all the facts and circumstances, the primary purpose of Taxpayer's production and sale of qualified clean hydrogen is to obtain the benefit of the section 45V credit in a manner that is wasteful. Taxpayer is not eligible for the section 45V credit with respect to the qualified clean hydrogen that Taxpayer produced and sold in 2031 to Customer that is subsequently vented or flared by Customer.

### (a) Recordkeeping.

Consistent with section 6001 of the Code, a taxpayer claiming the section 45V credit for qualified clean hydrogen produced at a qualified clean hydrogen production facility must maintain and preserve records sufficient to establish the amount of the section 45V credit claimed by the taxpayer. At a minimum, those records must include records to substantiate the information required to be included in the verification report under § 1.45V-5, records establishing that the facility meets the definition of
a qualified clean hydrogen production facility under section 45V(c)(3) and
§ 1.45V-1(a)(10), records of past credit claims under section 45Q by any taxpayer with respect to carbon capture equipment included at the facility, and records establishing the date the qualified clean hydrogen production facility was placed in service. If the requirements under section 45V(e) and
§ 1.45V-3(b) for the increased credit amount were satisfied, then the taxpayer must also maintain records in accordance with § 1.45-12. Taxpayers must also retain all raw data used for submission of a request for an emissions value to the DOE for at least six years after the due date (including extensions) for filing the Federal income tax return or information return to which the provisional emissions rate (PER) (as defined in § 1.45V-4(c)(1)) petition is ultimately attached.

### (c) Applicability Date.

This section applies to taxable years beginning after Dec. 26, 2023.

### § 1.45V-3 [Reserved]

§ 1.45V-4 Procedures for determining lifecycle greenhouse gas emissions rates for qualified clean hydrogen.

### (a) In General.

The amount of the section 45V credit is determined under section 45V(a) of the Code and § 1.45V-1(b) according to the lifecycle GHG emissions rate of all hydrogen produced at a hydrogen production facility during the taxable year. The lifecycle GHG emissions rate of such hydrogen is determined under the most recent GREET model. In the case of any hydrogen for which a lifecycle GHG emissions rate has not been determined under the most recent GREET model for purposes of section 45V, a taxpayer producing such hydrogen may file a petition for a provisional emissions rate (PER) with the IRS for the Secretary's determination of the lifecycle GHG emissions rate with respect to such hydrogen.

### (b) Use of the Most Recent GREE Model.

For each taxable year during the period described in section 45V(a)(1), a taxpayer claiming the section 45V credit determines the lifecycle GHG emissions rate of hydrogen produced at a hydrogen production facility under the most recent GREET model separately for each hydrogen production facility the taxpayer owns. This determination is made following the close of each such taxable year and must include all hydrogen production during the taxable year. In using the most recent GREET model to calculate the lifecycle GHG emissions rate for purposes of determining the amount of the section 45V credit under section 45V(a) and
§ 1.45V-1(b), the taxpayer must accurately enter all information about its facility requested within the interface of 45VH2-GREET (as described in § 1.45V-1(a)(8)(ii)). Information regarding where taxpayers may access 45VH2-GREET and accompanying documentation will be included in the instructions to the Form 7210, Clean Hydrogen Production Credit, or any successor form(s).

### (c) Provisional Emissions Rate (PER)—

### (1) In General—

For purposes of section 45V(c)(2)(C) and paragraph (a) of this section, the term provisional emissions rate or PER means the lifecycle GHG emissions rate of the process by which qualified clean hydrogen is produced by the taxpayer at a hydrogen production facility as determined by the Secretary under this paragraph (c).

### (2) Rate not Determined—

### (i) In General.

For purposes of section 45V(c)(2)(C), a taxpayer may not file a petition for a PER unless a lifecycle GHG emissions rate has not been determined under the most recent GREET model with respect to hydrogen produced by the taxpayer at a hydrogen production facility. A lifecycle GHG emissions rate has not been determined under the most recent GREET model with respect to hydrogen produced by the taxpayer at a hydrogen production facility if either the feedstock used by such facility or the facility's hydrogen production technology is not included in the most recent GREET model. A facility's hydrogen production pathway is not included in the most recent GREET model if the feedstock used by such facility or the facility's hydrogen production technology is not included in the most recent GREET model. If a taxpayer's request for an emissions value pursuant to paragraph (c)(5) of this section with respect to the hydrogen produced by the taxpayer at a hydrogen production facility is pending at the time such facility's hydrogen production pathway becomes included in an updated version of 45VH2-GREET, the taxpayer's request for an emissions value will be automatically denied. In such case, the taxpayer must determine the lifecycle GHG emissions rate with respect to such hydrogen under paragraph (c)(2)(ii) of this section.

### (ii) Subsequent Inclusion in 45VH2-GREET.

Notwithstanding the definition of the most recent GREET model provided at § 1.45V-1(a)(8)(ii), for the taxable year in which the hydrogen production facility's hydrogen production pathway is first included in an updated version of 45VH2-GREET, the updated version of 45VH2-GREET will be considered the most recent GREET model with respect to the hydrogen produced by the taxpayer at the hydrogen production facility during such taxable year, and for purposes of section 45V(c)(2)(C), a lifecycle GHG emissions rate for such hydrogen will be considered to have been determined.

### (3) Process for Filing a PER Petition.

To file a PER petition with the Secretary, a taxpayer must submit a PER petition attached to the taxpayer's Federal income tax return for the first taxable year of hydrogen production ending within the 10-year period described in section 45V(a)(1) for which the taxpayer claims the section 45V credit for hydrogen to which the PER petition relates and for which a lifecycle GHG emissions rate has not been determined, as defined under paragraph (c)(2)(i) of this section. A PER petition must contain an emissions value obtained from the DOE setting forth DOE's analytical assessment of the lifecycle GHG emissions associated with the facility's hydrogen production pathway, which must be consistent with the lifecycle GHG emissions framework provided in the section 45V regulations, and a copy of the taxpayer's request to the DOE for an emissions value, including any information provided by the taxpayer to the DOE pursuant to the emissions value request process provided in paragraph (c)(5) of this section. If the taxpayer obtained more than one emissions value from the DOE, the PER petition must contain the emissions value setting forth the lifecycle GHG emissions rate of the hydrogen for which the section 45V credit is claimed on the Form 7210, Clean Hydrogen Production Credit, to which the PER petition is attached.

### (2) PER Determination.

Upon the IRS's acceptance of the taxpayer's Federal income tax return containing a PER petition, the emissions value of the hydrogen specified on such petition will be deemed accepted. A taxpayer would be able to rely upon an emissions value provided by the DOE for purposes of calculating and claiming a section 45V credit, provided that any information, representations, or other data provided to the DOE in support of the request for an emissions value are accurate. The IRS's deemed acceptance of such emissions value is the Secretary's determination of the PER. However, the production and sale or use of such hydrogen must be verified by an unrelated party under section 45V(c)(2)(B)(ii) and § 1.45V-5. Such verification and any information, representations, or other data provided to the DOE in support of the request for an emissions value are subject to later examination by the IRS.

### (3) Department of Energy (DOE) Emissions Value Request Process.

An applicant that submits a request for an emissions value must follow the procedures specified by the DOE to request and obtain such emissions value. Emissions values will be evaluated using the same well-to-gate system boundary that is employed in 45VH2-GREET. Additionally, if applicable, background data parameters in 45VH2-GREET will also be treated as background data (with fixed values that an applicant cannot change) in the emissions value request process. Treatment of EACs and other proposals outlined in the regulations in this part under section 45V will be consistently applied in the emissions value request process. An applicant may request an emissions value from the DOE only after a front-end engineering and design (FEED) study or similar indication of project maturity, as determined by the DOE, such as project specification and cost estimation sufficient to inform a final investment decision has been completed for the hydrogen production facility. The DOE may decline to review applications that are not responsive, including those applications that use a hydrogen production technology and feedstock already in 45VH2-GREET or applications that are incomplete.
(4) Guidance and procedures for applicants to request and obtain an emissions value from the DOE will be published by the DOE, including a process for, under limited circumstances, a revision to the DOE's initial analytical assessment of an emissions value on the basis of revised technical information or facility design and operation.

### (4) Effect of PER.

A taxpayer may use a PER determined by the Secretary to calculate the amount of the section 45V credit under section 45V(a) and § 1.45V-1(b) with respect to qualified clean hydrogen produced at a qualified clean hydrogen production facility, provided all other requirements of section 45V are met, until the lifecycle GHG emissions rate of such hydrogen has been determined (for purposes of section 45V(c)(2)(C)) under the most recent GREET model. The Secretary's PER determination is not an examination or inspection of books of account for purposes of section 7605(b) of the Code and does not preclude or impede the IRS (under section 7605(b) or any administrative provisions adopted by the IRS) from later examining a return or inspecting books or records with respect to any taxable year for which the section 45V credit is claimed. For example, the verification report submitted under section 45V(c)(2)(B)(ii) and § 1.45V-5 and any information, representations, or other data provided to the DOE in support of the request for an emissions value are still subject to examination. Further, a PER determination does not signify that the IRS has determined that the requirements of section 45V have been satisfied for any taxable year.

### (d) Use of Energy Attribute Certificates (EACs)—

### (1) In General.

For purposes of the section 45V credit, if a taxpayer determines a lifecycle GHG emissions rate for hydrogen produced at a hydrogen production facility using the most recent GREET model or the Secretary determines a provisional emissions rate for hydrogen produced at a hydrogen production facility subject to a PER petition, then the taxpayer may treat such hydrogen production facility's use of electricity as being from a specific electricity generating facility rather than being from the regional electricity grid (as represented in 45VH2-GREET) only if the taxpayer acquires and retires qualifying EACs (as defined in paragraph (d)(2)(iv) of this section) for each unit of electricity that the taxpayer claims from such source. For example, one megawatt-hour of electricity use to produce hydrogen would need to be matched with one megawatt-hour of qualifying EACs.
(e) Further, to satisfy this requirement, a taxpayer's acquisition and retirement of qualifying EACs must also be recorded in a qualified EAC registry or accounting system (as defined in paragraph (d)(2)(v) of this section) so that the acquisition and retirement of such EACs may be verified by a qualified verifier (as defined in § 1.45V-5(h)). The requirements of this paragraph (d)(1) apply regardless of whether the electricity generating facility is grid connected, directly connected, or co-located with the hydrogen production facility.

### (2) Definitions.

For purposes of this section—

(i) Commercial operations date.

The term commercial operations date or COD means the date on which a facility that generates electricity begins commercial operations.

### (ii) Energy Attribute Certificate.

The term energy attribute certificate (EAC) means a tradeable contractual instrument, issued through a qualified EAC registry or accounting system (as defined in paragraph (d)(2)(v) of this section), that represents the energy attributes of a specific unit of energy produced. An EAC may be traded with or separately from the underlying energy it represents. An EAC can be retired by or on behalf of its owner, which is the party that has the right to claim the underlying attributes represented by an EAC. Renewable energy certificates (RECs) and other similar energy certificates issued through a registry or accounting system are forms of EACs.

(iii) Eligible EAC.

The term eligible EAC means an EAC that, with respect to the electricity to which the EAC relates, provides, at a minimum, the information described in paragraphs (d)(2)(iii)(A) through (F) of this section—
(A) A description of the facility, including the technology and feedstock used to generate the electricity;
(B) The amount and units of electricity;
(C) The COD of the facility that generated the electricity;
(D) For electricity that is generated before Jan. 1, 2028, the calendar year in which such electricity was generated;
(E) For electricity that is generated after Dec. 31, 2027, the date and hour in which such electricity was generated; and
(F) The project identification number or assigned identifier.

### (iv) Qualifying EAC.

The term qualifying EAC means an eligible EAC that meets the requirements of paragraph (d)(3) of this section and for which the satisfaction of those requirements has been verified by a qualified verifier (as defined in § 1.45V-5(h)).

### (v) Qualified EAC Registry or Accounting System.

The term qualified EAC registry or accounting system means a tracking system that—
(A) Assigns a unique identification number to each EAC tracked by such system;
(B) Enables verification that only one EAC is associated with each unit of electricity;
(C) Verifies that each EAC is claimed and retired only once;
(D) Identifies the owner of each EAC; and
(E) Provides a publicly accessible view (for example, through an application programming interface) of all currently registered generators in the tracking system to prevent the duplicative registration of generators.

### (vi) Region.

The term region means a region derived from the National Transmission Needs Study that was released by the DOE on Oct. 30, 2023. Alaska, Hawaii, and each U.S. territory will be treated as separate regions.

### (3) Qualifying EAC Requirements.

An eligible EAC meets the requirements of this paragraph (d)(3) if it meets the requirements of paragraphs (d)(3)(i) through (iii) of this section.

### (i) Incrementality.

An EAC meets the requirements of this paragraph (d)(3)(i) if it meets the requirements of paragraph (d)(3)(i)(A) or (B) of this section. Paragraph (d)(3)(i)(C) of this section provides an example that illustrates the application of paragraph (d)(3)(i)(B) of this section.
(A) An EAC meets the requirements of this paragraph (d)(3)(i)(A) if the electricity generation facility that produced the unit of electricity to which the EAC relates has a COD that is no more than 36 months before the hydrogen production facility for which the EAC is retired was placed in service.
(B) Uprates. An EAC meets the requirements of this paragraph (d)(3)(i)(B) if the electricity represented by the EAC is produced by an electricity generating facility that had an uprate no more than 36 months before the hydrogen production facility with respect to which the EAC is retired was placed in service and such electricity is part of such electricity generating facility's uprated production. The term uprate means an increase in an electricity generating facility's rated nameplate capacity (in nameplate megawatts). The term pre-uprate capacity means the nameplate capacity of an electricity generating facility immediately before an uprate. The term post-uprate capacity means the nameplate capacity of an electricity generating facility immediately after an uprate. The term incremental generation capacity means the increase in an electricity generating facility's rated nameplate capacity from the pre-uprate capacity to the post-uprate capacity. The term uprated production rate means the incremental generation capacity (in nameplate megawatts) divided by the post-uprate capacity (in nameplate megawatts). The term uprated production means the uprated production rate of an electricity generating facility multiplied by its total generation output (in megawatt hours). An uprated electricity generating facility's production must be prorated to each hour of such facility's generation by multiplying the production for each hour or each year, consistent with the requirements in paragraph (d)(3)(ii) of this section, by the uprated production rate to determine the electricity to which the uprate relates.

### (A) Example.

Power Plant undergoes an uprate that expands its rated nameplate capacity from a pre-uprate capacity of 10 megawatts (MW) to a post-uprate capacity of 12 MW. After the uprate, its generation output increases to a total of 40,000 MW hours for the year. Power Plant's incremental generation capacity is 2 MW, its uprated production rate is 0.167 (2 MW divided by 12 MW), and its total uprated production for the year is 6,667 megawatt hours (MWh) (2 megawatts divided by 12 MW multiplied by 40,000 MWh). Two-twelfths (0.167) of each hour of the Power Plant's production may be considered uprated production.

### (ii) Temporal Matching—

### (A) In General.

An EAC meets the requirements of this paragraph (d)(3)(ii) if the electricity represented by the EAC is generated in the same hour that the taxpayer's hydrogen production facility uses electricity to produce hydrogen.

### (B) Transition Rule.

For EACs that represent electricity generated before Jan. 1, 2028, the EAC will be considered generated in the same hour that the taxpayer's hydrogen production facility uses electricity to produce hydrogen as required in paragraph (d)(3)(ii)(A) of this section if the electricity represented by the EAC is generated in the same calendar year that the taxpayer's hydrogen production facility uses electricity to produce hydrogen.

(iii) Deliverability.

An EAC meets the requirements of this paragraph (d)(3)(iii) if the electricity represented by the EAC is generated by a facility that is in the same region (as defined in paragraph (d)(2)(vi) of this section) as the hydrogen production facility.

### (f) Applicability Date.

This section applies to taxable years beginning after Dec. 26, 2023.

§ 1.45V-5 Procedures for verification of qualified clean hydrogen production and sale or use.

### (a) In General.

For each qualified clean hydrogen production facility for which a taxpayer claims a section 45V credit, a verification report must be attached to the taxpayer's Form 7210, Clean Hydrogen Production Credit, or any successor form(s), for each qualified clean hydrogen production facility and for each taxable year in which the taxpayer claims the section 45V credit.

### (b) Requirements for Verification Reports.

A verification report specified in paragraph (a) of this section must be prepared by a qualified verifier under penalties of perjury and must contain—
(1) An attestation from the qualified verifier regarding the taxpayer's production of qualified clean hydrogen for sale or use (production attestation);
(2) An attestation from the qualified verifier regarding the amount of qualified clean hydrogen sold or used (sale or use attestation);
(3) An attestation from the qualified verifier regarding conflicts of interest (conflict attestation);
(4) Certain information regarding the qualified verifier, including documentation of the qualified verifier's qualifications (qualified verifier statement);
(5) Certain general information about the taxpayer's hydrogen production facility where the hydrogen production undergoing verification occurred; and
(6) Any documentation necessary to substantiate the verification process given the standards and best practices prescribed by the qualified verifier's accrediting body and the circumstances of the taxpayer and the taxpayer's hydrogen production facility.

### (c) Requirements for the Production Attestation.

The following requirements apply to the production attestation.
(1) The production attestation must be an attestation, made under penalties of perjury, that the qualified verifier performed a verification sufficient to determine that the operation, during the applicable taxable year, of the hydrogen production facility that produced the hydrogen for which the section 45V credit is claimed, and any energy attribute certificates (EACs) applied pursuant to § 1.45V-4(d) for the purpose of accounting for such facility's emissions, are accurately reflected in—
(i) The amount of qualified clean hydrogen produced by the taxpayer that is claimed on the Form 7210, Clean Hydrogen Production Credit, or any successor form(s), to which the verification report is attached; and
(ii) Either—
(A) The data the taxpayer entered into the most recent GREET model to determine the lifecycle GHG emissions rate that is claimed on the Form 7210, Clean Hydrogen Production Credit, or any successor form(s), to which the verification report is attached; or
(B) The data the taxpayer submitted in the PER petition relating to the hydrogen for which the section 45V credit is claimed, and which was provided to the DOE in support of the taxpayer's request for the emissions value provided in the PER petition.
(2) If the production attestation attests to the information specified in paragraph (c)(1)(ii)(B) of this section, then the production attestation must also specify the emissions value received from the DOE that was calculated using such data, expressed in kilograms of CO2e per kilogram of hydrogen.
(3) The production attestation must specify the lifecycle GHG emissions rate (expressed in kilograms of CO2e per kilogram of hydrogen) and the amount of qualified clean hydrogen produced by the taxpayer (expressed in kilograms), that are claimed on the Form 7210, Clean Hydrogen Production Credit, or any successor form(s), to which the verification report is attached.

### (d) Requirements for the Sale or Use Attestation—

### (1) In General.

The sale or use attestation must be an attestation, made under penalties of perjury, that the qualified verifier performed a verification sufficient to determine that the amount of qualified clean hydrogen that is specified in the production attestation pursuant to paragraph (c)(1)(i) of this section, and that is claimed on the Form 7210, Clean Hydrogen Production Credit, or any successor form(s), to which the verification report is attached, has been sold or used by a person who makes a verifiable use of such hydrogen.

### (2) Verifiable Use.

For purposes of section 45V(c)(2)(B)(ii) of the Code and the section 45V regulations (as defined in § 1.45V-1(a)(13)), a person's verifiable use of the hydrogen specified in paragraph (d)(1) of this section can occur within or outside the United States. A verifiable use can be made by the taxpayer or a person other than the taxpayer. For example, a verifiable use includes a tolling arrangement pursuant to which a service recipient provides raw materials or inputs, such as water or electricity, to a toller (that is, a third-party service provider that owns a hydrogen production facility), and the toller produces hydrogen for the service recipient using the service recipient's raw materials or inputs in exchange for a fee, use of the hydrogen by the service recipient would be a verifiable use.

However, a verifiable use does not include—
(i) Use of hydrogen to generate electricity that is then directly or indirectly used in the production of more hydrogen; or
(ii) Venting or flaring of hydrogen.

### (e) Requirements for the Conflict Attestation—

### (1) In General.

The conflict attestation must include attestations, made under penalties of perjury, that—
(i) The qualified verifier has not received a fee based to any extent on the value of any section 45V credit that has been or is expected to be claimed by any taxpayer and no arrangement has been made for such fee to be paid at some time in the future;
(ii) The qualified verifier was not a party to any transaction in which the taxpayer sold qualified clean hydrogen it had produced or in which the taxpayer purchased inputs for the production of such hydrogen;
(iii) The qualified verifier is not related, within the meaning of section 267(b) or 707(b)(1) of the Code, to, or an employee of, the taxpayer;
(iv) The qualified verifier is not married to an individual described in paragraph (e)(1)(iii) of this section; and
(v) If the qualified verifier is acting in his or her capacity as a partner in a partnership, an employee of any person, whether an individual, corporation, or partnership, or an independent contractor engaged by a person other than the taxpayer, the attestations under paragraphs (e)(1)(i) through (iv) of this section must also be made with respect to the partnership or the person who employs or engages the qualified verifier.

### (2) Special Rule for Transfer Elections.

If an election has been made under section 6418(a) of the Code with respect to the section 45V credit, then the attestations under paragraph (e)(1) of this section must be made with respect to the qualified verifier's independence from both the eligible taxpayer and the transferee taxpayer (as those terms are defined in section 6418 and the regulations in this chapter thereunder).

### (a) Requirements for the Qualified Verifier Statement.

The qualified verifier statement must include the following—
(1) The qualified verifier's name, address, and taxpayer identification number;
(2) The qualified verifier's qualifications to conduct the verification, including a description of the qualified verifier's education and experience and a photocopy of the qualified verifier's certificate received from their accrediting body;
(3) If the qualified verifier is acting in his or her capacity as a partner in a partnership, an employee of any person, whether an individual, corporation, or partnership, or an independent contractor engaged by a person other than the taxpayer, the name, address, and taxpayer identification number of the partnership or the person who employs or engages the qualified verifier;
(4) The signature of the qualified verifier and the date signed by the qualified verifier; and
(5) A statement that the verification was conducted for Federal income tax purposes.

### (b) General Information on the Taxpayer's Hydrogen Production Facility.

The verification report must include the following information for the taxpayer's hydrogen production facility where the hydrogen production undergoing verification occurred:
(1) The location of the hydrogen production facility;
(2) A description of the hydrogen production facility, including its method of producing hydrogen;
(3) The type(s) of feedstock(s) used by the hydrogen production facility during the taxable year of production;
(4) The amount(s) of feedstock(s) used by the hydrogen production facility during the taxable year of production; and
(5) A list of the metering devices used to record any data used by the qualified verifier to support the production attestation under paragraph (c) of this section along with a statement that the qualified verifier is reasonably assured that the device(s) underwent industry-appropriate quality assurance and quality control, and the accuracy and calibration of the device has been tested in the last year.

### (c) Qualified Verifier.

The term qualified verifier means any individual or organization with active accreditation—
(1) As a validation and verification body from the American National Standards Institute National Accreditation Board; or
(2) As a verifier, lead verifier, or verification body under the California Air Resources Board Low Carbon Fuel Standard program.

### (i) Unrelated Party.

For purposes of section 45V(c)(2)(B)(ii), the term unrelated party means a qualified verifier who meets the requirements of paragraph (e) of this section.

### (j) Requirements for Taxpayers Claiming Both the Section 45V Credit and the Section 45 Credit or the Section 45U Credit.

In the case of a taxpayer who produces electricity for which either the section 45 or section 45U credit is claimed and the taxpayer or a related person uses such electricity to produce hydrogen for which the section 45V credit is claimed, the verification report must also contain attestations that the qualified verifier performed a verification sufficient to determine that—
(1) The electricity used to produce such hydrogen was produced at the relevant facility for which a section 45 or section 45U credit is claimed;
(2) The given amount of electricity (in kilowatt hours) used to produce such hydrogen at the relevant hydrogen production facility is reasonably assured of being accurate; and
(3) The electricity for which a section 45 or 45U credit was claimed is represented by EACs that are retired in connection with the production of such hydrogen.

### (k) Timely Verification Report.

A verification report must be signed and dated by the qualified verifier no later than—
(1) The due date, including extensions, of the Federal income tax return or information return for the taxable year during which the hydrogen undergoing verification is produced; or
(2) In the case of a credit first claimed on an amended return or administrative adjustment request, the date on which the amended return or administrative adjustment request is filed.

### (l) Applicability Date.

This section applies to taxable years beginning after Dec. 26, 2023.

§ 1.45V-6 Rules for determining the placed in service date for an existing facility that is modified or retrofitted to produce qualified clean hydrogen.

### (a) Modification of an Existing Facility

### (1) In General.

Under section 45V(d)(4) of the Code, in the case of an existing facility that—
(i) Was originally placed in service before Jan. 1, 2023, and, prior to the modification described in this paragraph (a), did not produce qualified clean hydrogen, and after the date such facility was originally placed in service—
(A) Is modified to produce qualified clean hydrogen; and
(B) Amounts paid or incurred with respect to such modification are properly chargeable to the taxpayer's capital account for the facility.
(ii) Such facility will be deemed to have been originally placed in service as of the date the property required to complete the modification described in this paragraph (a) is placed in service.

### (2) Modification Requirements.

For purposes of section 45V(d)(4) and paragraph (a)(1) of this section, an existing facility will not be deemed to have been originally placed in service as of the date the property required to complete the modification is placed in service unless the modification is made for the purpose of enabling the facility to produce qualified clean hydrogen and the taxpayer pays or incurs an amount that is properly chargeable to the taxpayer's capital account with respect to the facility. A modification is made for the purpose of enabling the facility to produce qualified clean hydrogen if the facility could not produce hydrogen with a lifecycle greenhouse gas (GHG) emissions rate that is less than or equal to 4 kilograms of CO2e per kilogram of hydrogen but for the modification. For example, if a taxpayer solely pays or incurs capital expenses to modify existing components of a hydrogen production facility that are not necessary for the production of hydrogen with a lifecycle GHG emissions rate that is less than or equal to 4 kilograms of CO2e per kilogram of hydrogen, such modification does not entitle the facility to a new placed in service date.

### (b) Retrofit of an Existing Facility (80/20 Rule)

For purposes of section 45V(a)(1), a facility may establish a new date on which it is considered originally placed in service, even though the facility contains some used property, provided the fair market value of the used property is not more than 20 percent of the facility's total value, calculated by adding the cost of the new property to the value of the used property (80/20 Rule). For purposes of the 80/20 Rule, the cost of new property includes all properly capitalized costs of the new property included within the facility. The 80/20 Rule applies to any existing facility, regardless of whether the facility previously produced qualified clean hydrogen and regardless of when the facility was originally placed in service (before application of this paragraph (b)). If a facility satisfies the requirements of the 80/20 Rule, then the date on which such facility is considered originally placed in service for purposes of section 45V(a)(1) is the date on which the new property added to the facility is placed in service.

### (c) Examples

The following examples illustrate the application of paragraphs
(a) and (b) of this section:

### (1) Example 1: Modification of an Existing Facility

### (i) Facts.

Facility X, a hydrogen production facility that was originally placed in service on Jan. 1, 2018, could not produce qualified clean hydrogen as described in section 45V(c)(2). After Jan. 1, 2023, Facility X was modified to produce qualified clean hydrogen, and all amounts paid or incurred with respect to such modifications were properly chargeable to the taxpayer's capital account for Facility X. The property required to complete the modification was placed in service on Jun. 1, 2023.

### (ii) Analysis.

Under section 45V(d)(4) and paragraph (a) of this section, because Facility X was originally placed in service before Jan. 1, 2023, and before the modification could not produce qualified clean hydrogen, it is deemed to be originally placed in service as of the date the property required to complete the modification is placed in service. Accordingly, for purposes of section 45V(a)(1) and (d)(4), Facility X is deemed to have been originally placed in service on Jun. 1, 2023.

### (2) Example 2: Modification of an Existing Facility; Coordination with the Section 45Q Credit Previously Allowed

### (i) Facts.

The facts are the same as in paragraph (c)(1) of this section (Example 1), except that taxpayer was allowed a section 45Q credit with respect to carbon capture equipment (CCE) included at Facility X before Jun. 1, 2023.

### (ii) Analysis.

Under paragraph (a) of this section and § 1.45V-2(a), although Facility X is deemed to have been originally placed in service on Jun. 1, 2023, because taxpayer had previously been allowed a section 45Q credit with respect to the CCE included at Facility X, no section 45V credit is allowable for qualified clean hydrogen produced at Facility X, despite the modification.

### (3) Example 3: Modification of an Existing Facility and Coordination with Section 45Q Credit not Previously Allowed

### (i) Facts.

Facility Y, a hydrogen production facility that was originally placed in service on Feb. 1, 2020, could not previously produce qualified clean hydrogen as described in section 45V(c)(2). On Feb. 1, 2026, Facility Y was modified to produce qualified clean hydrogen by adding new CCE to allow Facility Y to capture, process, and prepare carbon dioxide for transport for disposal, injection, or utilization. All amounts paid or incurred with respect to such modifications were properly chargeable to the taxpayer's capital account for Facility Y. The property required to complete the modification of Facility Y was placed in service on Feb. 1, 2026, and as a result, Facility Y, including the new CCE, is deemed to be originally placed in service on Feb. 1, 2026, for purposes of sections 45V and 45Q. No section 45Q credit has been allowed to any taxpayer with respect to the new carbon capture equipment located at Facility Y.

### (ii) Analysis.

Under paragraph (a) of this section and § 1.45V-2(a), because no section 45Q credit has been allowed to any taxpayer with respect to the new CCE located at Facility Y, a section 45V credit is allowable for the qualified clean hydrogen produced at Facility Y, assuming all other requirements of section 45V are met.

### (1) Example 4: Retrofit of an Existing Facility (80/20 Rule)

### (i) Facts.

Facility Z, a hydrogen production facility that was originally placed in service on Feb. 1, 2023, does not produce qualified clean hydrogen as described in section 45V(c)(2). On Jan. 1, 2026, Facility Z was retrofitted to produce qualified clean hydrogen. After the retrofit, the cost of the new property included in Facility Z is greater than 80 percent of Facility Z's total value.

### (ii) Analysis.

Even though Facility Z does not satisfy the requirements of section 45V(d)(4) because Facility Z was not originally placed in service before Jan. 1, 2023, under paragraph (b) of this section, Facility Z is deemed to be originally placed in service on Jan. 1, 2026, because Facility Z meets the 80/20 Rule. Thus, a section 45V credit is allowable for qualified clean hydrogen produced at Facility Z during the 10-year period beginning on Jan. 1, 2026, assuming all other requirements of section 45V are met.

### (2) Example 5: Retrofit of an Existing Facility (80/20 Rule) and Coordination with Section 45Q Credit Previously Allowed

### (i) Facts.

The facts are the same as in paragraph (c)(4) of this section (Example 4), except that before the retrofit, Facility Z included CCE for which a section 45Q credit was allowed to a taxpayer.

### (ii) Analysis.

Under paragraph (b) of this section and § 1.45V-2(a), Facility Z is deemed to be originally placed in service on Jan. 1, 2026, because Facility Z meets the 80/20 Rule. However, a section 45V credit is not allowable for qualified clean hydrogen produced at Facility Z during the 10-year period beginning on Jan. 1, 2026, because a section 45Q credit has been allowed to a taxpayer with regard to the CCE included in Facility Z.

### (d) Applicability Date.

This section applies to taxable years beginning after Dec. 26, 2023.

Par. 3. Section 1.48-15 is added to read as follows:

§ 1.48-15 Election to treat clean hydrogen production facility as energy property.

### (a) In General.

Under section 48(a)(15) of the Internal Revenue Code (Code), a taxpayer that owns and places in service a specified clean hydrogen production facility (as defined in section 48(a)(15)(C) and paragraph (b) of this section) can make an irrevocable election under section 48(a)(15)(C)(ii)(II) to treat any qualified property (as defined in section 48(a)(5)(D)) that is part of the facility as energy property for purposes of section 48.

### (b) Specified Clean Hydrogen Production Facility.

The term specified clean hydrogen production facility means any qualified clean hydrogen production facility—
(1) That is placed in service after Dec. 31, 2022;
(2) With respect to which no credit has been allowed under section 45V or 45Q of the Code, and for which the taxpayer makes an irrevocable election to have section 48(a)(15) apply; and
(3) For which an unrelated party has verified in the manner specified in paragraph (e) of this section that such facility produces hydrogen through a process that results in lifecycle greenhouse gas (GHG) emissions that are consistent with the hydrogen that such facility was designed and expected to produce under section 48(a)(15)(A)(ii) and paragraph (c) of this section.

### (c) Energy Percentage—

### (1) In General.

In the case of a specified clean hydrogen production facility that is designed and reasonably expected to produce qualified clean hydrogen through a process that results in a lifecycle GHG emissions rate of:
(i) Not greater than 4 kilograms of carbon dioxide equivalent (CO2e) per kilogram of hydrogen, and not less than 2.5 kilograms of CO2e per kilogram of hydrogen, the energy percentage is 1.2 percent;
(ii) Less than 2.5 kilograms of CO2e per kilogram of hydrogen, and not less than 1.5 kilograms of CO2e per kilogram of hydrogen, the energy percentage is 1.5 percent;
(iii) Less than 1.5 kilograms of CO2e per kilogram of hydrogen, and not less than 0.45 kilograms of CO2e per kilogram of hydrogen, the energy percentage is 2 percent; and
(iv) Less than 0.45 kilograms of CO2e per kilogram of hydrogen, the energy percentage is 6 percent.

### (2) Designed and Reasonably Expected to Produce.

Hydrogen that a facility is designed and reasonably expected to produce means hydrogen produced through a process that results in the lifecycle GHG emissions rate specified in the annual verification report described in paragraph (e) (2) of this section for the taxable year in which the election is made.

### (d) Time and Manner of Making the Election—

### (1) In General.

To make an election under section 48(a)(15)(C)(ii)(II), a taxpayer must claim the section 48 credit with respect to a specified clean hydrogen production facility on a completed Form 3468, Investment Credit, or any successor form(s), and file the form with the taxpayer's Federal income tax return or information return for the taxable year in which the specified clean hydrogen production facility is placed in service. The taxpayer must also attach a statement to its Form 3468, Investment Credit, or any successor form(s), filed with its Federal income tax return or information return that includes the information required by the instructions to Form 3468, Investment Credit, or any successor form(s), for each specified clean hydrogen production facility subject to an election. A separate election must be made for each specified clean hydrogen production facility that meets the requirements provided in section 48(a)(15) to treat the qualified property that is part of the facility as energy property. If any taxpayer owning an interest in a specified clean hydrogen production facility makes an election under section 48(a)(15)(C)(ii)(II) with respect to the specified clean hydrogen production facility, then that election is binding on all taxpayers that directly or indirectly own an interest in the specified clean hydrogen production facility.

### (2) Special Rule for Partnerships and S Corporations.

In the case of a specified clean hydrogen production facility owned by a partnership or an S corporation, the election under section 48(a)(15)(C)(ii)(II) is made by the partnership or S corporation and is binding on all ultimate credit claimants (as defined in § 1.50-1(b)(3)(ii)). The partnership or S corporation must file a Form 3468, Investment Credit, or any successor forms(s), with its partnership or S corporation return for the taxable year in which the specified clean hydrogen production facility is placed in service to indicate that it is making the election, and attach a statement that includes all the information required by the instructions to Form 3468, Investment Credit, or any successor form(s), for each specified clean hydrogen production facility subject to the election. The ultimate credit claimant's section 48 credit must be based on each claimant's share of the basis (as defined in § 1.46-3(f)) of the specified clean hydrogen production facility on a completed Form 3468, Investment Credit, or any successor form(s), and file such form with a Federal income tax return for the taxable year that ends with or within the taxable year in which the partnership or S corporation made the election. The partnership or S corporation making the election must provide the ultimate credit claimants with the necessary information to complete Form 3468, Investment Credit, or any successor form(s), to claim the section 48 credit.

### (3) Election Irrevocable.

The election to treat qualified property that is part of a specified clean hydrogen production facility as energy property is irrevocable.

### (4) Election Availability Date.

The election to treat qualified property that is part of a specified clean hydrogen production facility as energy property is available for property placed in service after Dec. 31, 2022. In the case of any property placed in service after Dec. 31, 2022, for which construction began before Jan. 1, 2023, the election under section 48(a)(15)(C)(ii)(II) applies only to the extent of the basis of such property that is attributable to construction, reconstruction, or erection occurring after Dec. 31, 2022.

### (e) Third Party Verification—

### (1) In General.

In the case of a taxpayer that makes an election under section 48(a)(15)(C)(ii)(II) to treat any qualified property that is part of a specified clean hydrogen production facility as energy property for purposes of the section 48 credit, the taxpayer must obtain an annual verification report for the taxable year in which the election under section 48(a)(15)(C)(ii)(II) is made for the facility and for each taxable year thereafter during the recapture period specified in paragraph (f)(3) of this section. The taxpayer must also submit the annual verification report as an attachment to the Form 3468, Investment Credit, or any successor form(s), for the taxable year in which the election under section 48(a)(15)(C)(ii)(II) is made for the facility.

### (2) Annual Verification Report—

### (i) in General.

For purposes of paragraph (e)(1) of this section, the annual verification report must be signed under penalties of perjury by a qualified verifier (as defined in § 1.45V-5(h)) and contain an attestation providing all of the following—
(A) The information specified in § 1.45V-5(b) and (d) through (h);
(B) A statement attesting to the lifecycle GHG emissions rate (determined under section 45V(c) and § 1.45V-4) of the hydrogen produced at the specified clean hydrogen production facility for the taxable year to which the annual verification report relates and that the operation, during such taxable year, of the specified clean hydrogen production facility, and any energy attribute certificates (EACs) applied pursuant to § 1.45V-4(d) for the purpose of accounting for such facility's emissions, are accurately reflected in the data that the taxpayer entered into the most recent GREET model (as defined in § 1.45V-1(a)(8)(ii)) (or that the taxpayer provided to the Department of Energy (DOE) in support of the taxpayer's request for an emissions value), to determine the lifecycle GHG emissions rate of the hydrogen undergoing verification; and
(C) A statement attesting that the facility produced hydrogen through a process that results in a lifecycle GHG emissions rate that is consistent with, or lower than, the lifecycle GHG emissions rate of the hydrogen that such facility was designed and expected to produce.

### (ii) Conflict Attestation in the Case of a Transfer Election.

If a transfer election has been made under section 6418(a) of the Code with respect to the section 48 credit for a specified clean hydrogen production facility, then a conflict attestation containing the information specified in § 1.45V-5(e)(1), must be made with respect to the qualified verifier's independence from both the eligible taxpayer (as defined in section 6418(f)(2) and § 1.6418-1(b)) and the transferee taxpayer (as described in section 6418(a) and defined in § 1.6418-1(m)), and without regard to the requirements under § 1.45V-5(e)(2).

(iii) Inconsistent Lifecycle GHG Emissions.

In the event the facility produces hydrogen through a process that results in a lifecycle GHG emissions rate that is greater than the lifecycle GHG emissions rate that such facility was designed and expected to produce (and thus the qualified verifier cannot provide the attestation specified in paragraph (e) (2)(i)(C) of this section), resulting in a reduced energy percentage under section 48(a)(15)(A)(ii) with respect to such facility, an emissions tier recapture event under paragraph (f)(2) of this section will occur.

### (iv) Designed and Expected to Produce.

Hydrogen that the facility was designed and expected to produce means hydrogen specified in paragraph (c)(2) of this section.

### (v) Timely Annual Verification Report.

The annual verification report must be signed and dated by the qualified verifier no later than the due date, including extensions, of the Federal income tax return for the taxable year in which the hydrogen undergoing verification was produced.

### (vi) Records Retention.

In addition to the recordkeeping requirements set forth paragraph (g) of this section, the taxpayer must retain the annual verification report for at least six years after the due date, with extensions, for filing the Federal income tax return for the taxable year in which the hydrogen undergoing verification was produced.

### (f) Recapture—

### (1) In General.

For purposes of section 48(a)(15)(E), in any taxable year of the recapture period specified in paragraph (f)(3) of this section in which an emissions tier recapture event (as defined in paragraph (f)(2) of this section) occurs, the tax imposed on the taxpayer under chapter 1 of the Code for the taxable year of the emissions tier recapture event is increased by the recapture amount specified in paragraph (f)(4) of this section.

### (2) Emissions Tier Recapture Event.

For purposes of paragraph (f)(1) of this section, an emissions tier recapture event occurs in any taxable year of the recapture period specified in paragraph (f)(3) of this section under the following circumstances
(i) The taxpayer fails to obtain an annual verification report by the deadline for filing its Federal income tax return (including extensions) for any taxable year in which an annual verification report is required under paragraph (e)(1) of this section;
(ii) The specified clean hydrogen production facility actually produced hydrogen through a process that results in a lifecycle GHG emissions rate that can only support a lower energy percentage than the energy percentage used to calculate the amount of the section 48 credit for the facility for the taxable year in which the facility is placed in service; or
(iii) The specified clean hydrogen production facility actually produced hydrogen through a process that results in a lifecycle GHG emissions rate of greater than 4 kilograms of CO2e per kilogram of hydrogen.

### (3) Recapture Period.

For purposes of paragraph (f) of this section, the recapture period begins on the first day of the taxable year after the taxable year in which the facility was placed in service and ends on the close of the fifth taxable year following the close of the taxable year in which the facility was placed in service.

### (4) Recapture Amount—

### (i) In General.

In the case of an emissions tier recapture event under paragraph (f)(2) of this section, the recapture amount for the taxable year in which the emissions tier recapture event occurred is equal to 20 percent of the excess of the section 48 credit allowed to the taxpayer for the specified clean hydrogen production facility for the taxable year in which the facility was placed in service, over the section 48 credit that would have been allowed to the taxpayer for the facility if the taxpayer had used the energy percentage supported by the actual production to calculate the amount of the section 48 credit. Such increase in tax is the recapture amount.

### (ii) Carrybacks and Carryovers.

In the case of any emissions tier recapture event described in paragraph (f)(2) of this section, the carrybacks and carryovers under section 39 must be adjusted by reason of the emissions tier recapture event.

(iii) Recapture Amount in Case of Recapture Events Under Paragraph (f)(2)(i) or (iii) of this Section.

For purposes of paragraph (f)(4)(i) of this section, in the case of an emissions tier recapture event under paragraph (f)(2)(i) or (iii), the amount of the section 48 credit that would have been allowed to the taxpayer for the specified clean hydrogen production facility if the taxpayer had used the energy percentage supported by the actual production is zero. Accordingly, the recapture amount in the taxable year of an emissions tier recapture event under paragraph (f)(2)(i) or (iii) is 20 percent of the section 48 credit allowed to the taxpayer for such specified clean hydrogen production facility.

### (5) Example.

The following example illustrates the application of paragraphs (f)(1) through (4) of this section.

### (i) Facts.

On Jun. 1, 2023, Taxpayer, a calendar-year taxpayer, originally places in service Facility X, a specified clean hydrogen production facility. At such time, Taxpayer's basis in qualified property that is part of Facility X is $100,000,000. In the taxable year in which Facility X was originally placed in service (taxable year 2023), Facility X produces qualified clean hydrogen through a process that results in a lifecycle GHG emissions rate of 0.44 kg/CO2e per kilogram of hydrogen. Taxpayer submits with its 2023 Federal income tax return an annual verification report attesting that, for the taxable year 2023, Facility X produced hydrogen through a process that resulted in a lifecycle GHG emissions rate of 0.44 kg/CO2e, which is consistent with the lifecycle GHG emissions rate of the hydrogen that the facility was designed and expected to produce. Taxpayer makes a valid election under section 48(a)(15)(C)(ii)(II) with respect to Facility X on its Federal income tax return for the taxable year 2023. In the first year of the recapture period (taxable year 2024), Taxpayer fails to obtain an annual verification report by the deadline (including extensions) for filing its 2024 Federal income tax return. In the second year of the recapture period (taxable year 2025), Facility X produces qualified clean hydrogen through a process that results in a lifecycle GHG emissions rate of 1.4 kg/CO2e per kilogram of hydrogen and obtains an annual verification report attesting to such lifecycle GHG emissions rate. In the third, fourth, and fifth years of the recapture period (taxable years 2026, 2027, and 2028), Facility X produces qualified clean hydrogen through a process that results in a lifecycle GHG emissions rate of 0.44 kg/CO2e per kilogram of hydrogen and obtains an annual verification report attesting to such lifecycle GHG emissions rate, and attesting that such lifecycle GHG emissions rate is consistent with the lifecycle GHG emissions rate of the hydrogen that the facility was designed and expected to produce, by the deadline (including extensions) for filing its 2026, 2027, and 2028 Federal income tax returns, respectively.

### (i) Analysis.

Facility X is designed and reasonably expected to produce hydrogen through a process that results in a lifecycle GHG emissions rate of 0.44 kg/CO2e, which is the rate specified in Taxpayer's annual verification report submitted with Taxpayer's Federal income tax return for the taxable year in which the election under section 48(a)(15)(C)(ii)(II) with respect to Facility X was made. Under paragraph (c)(1)(iv) of this section, Facility X's energy percentage is therefore 6 percent. For the taxable year 2023, the year in which Taxpayer places in service Facility X, Taxpayer claims a section 48 credit for its basis in qualified property that is part of Facility X in the amount of $6,000,000 (6 percent of $100,000,000). In taxable year 2024, there is an emissions tier recapture event under paragraph (f)(2)(i) of this section because Taxpayer failed to obtain an annual verification report. Under paragraph (f)(4)(i) of this section, the amount of the section 48 credit recaptured in 2024 is $1,200,000. This reflects 20 percent of the section 48 credit allowed ($6,000,000) for Facility X. In taxable year 2025, there is an emissions tier recapture event under paragraph (f)(2)(ii) of this section because Facility X produced hydrogen through a process that resulted in a lifecycle GHG emissions rate that could only support an energy percentage of 2 percent, which is lower than the energy percentage used to calculate the amount of the section 48 credit for Facility X. Under paragraph (f)(4)(i) of this section, the amount of the section 48 credit recaptured in 2025 is $800,000. This reflects 20 percent of the difference between the amount of the section 48 credit allowed ($6,000,000) and the amount of the section 48 credit that would have been allowed for Facility X if Taxpayer had used the energy percentage supported by the actual production ($2,000,000). There is no emissions tier recapture event in taxable years 2026, 2027, or 2028 because, in those years, Facility X produced hydrogen through a process that resulted in a lifecycle GHG emissions rate that was consistent with the lifecycle GHG emissions rate of the hydrogen that Facility X was designed and expected to produce, and Taxpayer obtained an annual verification report attesting to such by the deadline (with extensions) for filing its Federal income tax return for each of those taxable, years.

(2) Coordination with sections 50(a) and 48(a)(10)(C) of the Code.

In each taxable year of the recapture period specified in paragraph (f)(3) of this section for any credit allowed under section 48 with respect to a specified clean hydrogen production facility, the recapture rules, if applicable, apply in the following order:
(i) Section 50(a);
(ii) Section 48(a)(10)(C); and
(iii) Section 48(a)(15)(E).

### (g) Recordkeeping.

Consistent with section 6001 of the Code, a taxpayer making the election under section 48(a)(15)(C)(ii)(II) with respect to a specified clean hydrogen production facility must maintain and preserve records sufficient to establish the amount of the section 48 credit claimed by the taxpayer. At a minimum, those records include records to substantiate the information required to be included in the annual verification report under paragraph (e) (2) of this section, records establishing that the facility meets the definition of a specified qualified clean hydrogen production facility under section 48(a)(15)(C) and paragraph (b) of this section, and records establishing the date the specified clean hydrogen production facility was placed in service. If the increased section 48 credit amount was allowed under section 48(a)(9), then the taxpayer must also maintain records in accordance with § 1.45-12.

### (h) Applicability Date.

This section applies to taxable years beginning after Dec. 26, 2023.

Douglas W. O'Donnell, Deputy Commissioner for Services and Enforcement. [FR Doc. 2023-28359 Filed Dec. 22, 2023; 8:45 am]. BILLING CODE 4830-01-P.

This section is from: Assessing Lifecycle Greenhouse Gas Emissions Associated with Electricity Use for the Section 45V Clean Hydrogen Production Tax Credit, U.S. Department of Energy, www.energy.gov, Dec. 21, 2023.

### SUMMARY

The Inflation Reduction Act (IRA) conditions eligibility for the § 45V tax credit on “lifecycle greenhouse gas emissions” (GHG) from hydrogen production. In doing so, the IRA cites to Clean Air Act 211(o)(1)(H), which requires inclusion of “direct and significant indirect emissions.” In the context of hydrogen production under § 45V, a lifecycle analysis would include induced grid emissions as a source of indirect emissions, consistent with the Environmental Protection Agency's long-standing interpretation and application of this Clean Air Act section in the context of the Renewable Fuel Standard program.

Energy attribute certificates (EACs) are an established means for documenting and verifying the generation and purchase of electricity. EACs do not directly quantify emissions from specified sources or from induced generation when adding load to the grid. However, when EACs from low-GHG generators have attributes that meet three criteria (incremental generation, geographic matching, and temporal matching, as defined further in the body of this paper), they can serve as a reasonable proxy for calculating induced grid emissions. If hydrogen producers acquire and retire EACs whose attributes meet these criteria, it would be reasonable to treat induced grid emissions as zero and for hydrogen producers to deem their GHG emissions from electricity to be the lifecycle GHG emissions associated with the specific generators from which the EACs were purchased and retired. Use of such EACs is therefore an appropriate approach as part of assessing and documenting qualification for particular tiers of the § 45V production tax credit.

### 1. Introduction

Clean hydrogen can play a role in decarbonizing up to 25% of global energy-related CO2 emissions (DOE 2023a). The U.S. Department of Energy (DOE) has published a number of reports that detail the important role of hydrogen in addressing climate change, enhancing energy security and resilience, and creating economic value. These include, among others, Pathways to Commercial Liftoff (DOE 2023a) and the U.S. National Clean Hydrogen Strategy and Roadmap (DOE 2023b). The DOE is accelerating the commercial liftoff of clean hydrogen through numerous grant, loan, and market facilitation programs. This paper considers an important supply-side incentive in the larger policy framework, focused on the clean hydrogen production tax credit (PTC) created by the Inflation Reduction Act (§ 45V): specifically, the lifecycle GHG emissions impacts of electricity required for the process of producing hydrogen within a well-to-gate perspective. This well-to-gate lifecycle perspective is required by statute and focuses on production and not downstream emissions effects. Therefore, hydrogen's potential to reduce emissions by displacing incumbent fuels in various end uses is outside the scope of both § 45V and of this paper. Greater deployment of technologies like electrolyzers could also drive down technology costs, increasing the long-term cost-effective potential of clean hydrogen and resulting in greater emissions reductions potential. Such considerations are also out of scope of this paper.

The clean hydrogen PTC, referred to as § 45V, established a tiered PTC for hydrogen production. The level of the credit is based on the lifecycle greenhouse gas (“GHG”) emissions that result from the process of producing clean hydrogen. For example, the highest-value tier of the tax credit requires lifecycle GHG emissions that result from the process of producing hydrogen below 0.45 kg CO₂e per kg of hydrogen.

This paper considers the lifecycle GHG emissions impacts of electricity required for the process of producing hydrogen. One method of hydrogen production-electrolysis-relies on large amounts of electricity (see text box). There are hydrogen production pathways that primarily or exclusively use energy inputs other than electricity that can also qualify for § 45V; the lifecycle GHG impacts of those other energy inputs are not covered in this paper.

Pursuant to the statute, to determine whether hydrogen production using electricity could qualify for a given level of credit, the lifecycle GHG emissions associated with its electricity use must be assessed. These GHG emissions depend in part on whether the hydrogen producer purchases electricity from a generator that is (or was previously) connected to the broader electricity grid. Specifically, if a hydrogen producer uses only electricity from a generator that has only ever been connected to the hydrogen producer and not an electricity grid or other electricity customer, then the assessment of the grid-related or ‘induced’ lifecycle GHG emissions from electricity use is relatively straightforward: there is no broader grid interaction and the lifecycle GHG emissions of the generator will generally define the lifecycle GHG emissions of the hydrogen producer. This paper does not further address this case.

Assessing lifecycle GHG emissions from electricity used to produce hydrogen becomes more complicated when considering hydrogen producers that are connected to an electricity grid or to a specific source of electricity generation that was previously supplying other electricity customers or the broader electricity grid. Electricity cannot be physically tracked on the networked grid from specific source to specific consumption (also known as “load”). Further, adding electricity load necessitates increasing electricity supply simultaneously because the power grid must be in continuous balance. However, as the power grid is a large, interconnected system, the impact of added electricity load on this added generation and its resulting GHG emissions can be complex.

In the context of the § 45V credit, assessing the lifecycle GHG emissions associated with electricity use generally involves two issues:
1. A method for hydrogen producers to establish a contractual relationship with a specific electricity generation source (or sources); and
2. A method to assess the lifecycle GHG emissions associated with the electricity used to produce hydrogen, including the GHG emissions associated with both the specific electricity generation source (or sources) with which the hydrogen producer has a contractual relationship, as well as the broader grid-level changes in generation and capacity.

This paper addresses both issues for purposes of the § 45V credit. First, it describes how new electricity loads, such as hydrogen production processes that use electricity, result in GHG emissions from the grid due to changes in generation and capacity. Second, it describes how GHG emissions from the grid can be considered in the context of § 45V when hydrogen producers purchase electricity from specific sources substantiated with energy attribute certificates (EACs, see box) whose attributes meet three criteria:
The generation is incremental (incremental generation);
The geographic attribute of the generator matches the geographic location of the hydrogen producer (geographic matching); and,
The temporal attribute of the generation matches the time of electricity consumption by the hydrogen producer (temporal matching).

EACs do not quantify induced grid emissions. However, when EACs from low-GHG generators have attributes that meet these three criteria (as further defined and detailed later), it would be reasonable to treat induced grid emissions as zero and for hydrogen producers to deem their GHG emissions from electricity to be the lifecycle GHG emissions associated with the specific generators from which the EACs were purchased and retired. Conversely, EACs whose attributes do not meet the three specific criteria would not provide a reasonable basis for claims about the lifecycle GHG emissions associated with specific generators due to induced grid GHG emissions.

More specifically, as described further in this paper, for purposes of § 45V:
EACs are a sound mechanism to establish contractual claims of electricity purchases from specific sources, but EACs from low-GHG generators must have attributes that meet certain criteria to address the impacts of a hydrogen producer's electricity load on induced grid GHG emissions.
The three necessary EAC attribute criteria are: incremental generation, geographic matching, and granular temporal matching (as defined and detailed later). These criteria are necessary to address the impacts of a hydrogen producer's load on grid GHG emissions regardless of whether the hydrogen producer is purchasing electricity from power plant(s) located at some distance from the hydrogen producer or is instead using electricity from a co-located, behind-the-meter power plant that is (or was previously) connected to the broader electricity grid.
If a hydrogen producer's load is matched with EACs whose attributes meet these three criteria, lifecycle GHG emissions from the hydrogen producer's electricity use can be reasonably deemed to reflect the lifecycle GHG emissions associated with the specific generators from which the EACs were purchased and retired.
If hydrogen producers rely on EACs whose attributes do not meet these three criteria, and have not otherwise adequately demonstrated low induced emissions, there is a strong likelihood that the hydrogen production would in many cases significantly increase induced grid GHG emissions beyond the allowable levels required to qualify for § 45V.
An administrable and practical approach to applying these three criteria is feasible. However, time may be required to allow development of the necessary EAC tracking infrastructure and verification protocols.
   2. Understanding GHG Emissions from Electricity Load

The physical electric grid is an interconnected system that includes thousands of electricity generators that must-collectively-constantly balance electricity load. An increase in electricity load must necessarily result in an increase of the same amount of electricity supply on the grid at the same time. Constraints on the transmission network mean that load and supply must be balanced both in time and in geography: an electricity generator located in Florida is not able to meet load in Montana.

Given this context, it is important to understand how an increase in electricity load results in (also referred to as “induces”) grid GHG emissions when receiving power from the broader electricity network. (It is also important to understand how these effects change when an electricity user purchases specific types of supply—a topic explored in depth in the next section.) New electricity load (such as from new hydrogen production) can cause an increase in GHG emissions from the broader power grid. The GHG emissions from that new electricity load are the difference between the grid's total GHG emissions when including the user's load, compared to the grid's total GHG emissions had that increased load not occurred (Ekvall 2019; NESP 2020). At minimum, estimating these effects requires assessing:
how the new electricity load influences GHG emissions from currently operating electric generators (referred to as operational impacts), and
how the new electricity load influences generator retirement and new build decisions and the associated GHG emissions of those decisions (referred to as structural impacts).

Operational impacts: Consuming electricity from the electric grid can influence the output and GHG emissions from existing generators. For example, any added load from hydrogen production requires an increase in electricity generation to match that added load. In the short run, increased electric load will predominantly be met by dispatchable generators—in today's electricity grid, primarily natural gas or coal that emit GHGs (Holland et al. 2022). Even if the hydrogen producer enters a contractual arrangement to purchase electricity from a specific existing low-GHG generator, if that generator would otherwise have been running anyway, these operational impacts occur as other existing (likely emitting) generators increase their supply to serve the existing load that the low-GHG generator was previously serving. Ultimately, the amount, location, and temporal profile of electricity load influences both which generators are committed (turned on) and dispatched (turned up) to ensure that load and supply are balanced. Given these impacts, operational GHG emissions vary with time (e.g., due to changes in total load and generation dispatch) and by location (e.g., due to transmission delivery constraints).

Structural impacts: Generators are built and retired in part in response to changes in electricity load-therefore, changes to load can influence when and what type of generators are built or when generators are retired.

For example, increased electricity load for hydrogen production in a region may cause a generator to be built that otherwise would not have been or defer the retirement of a generator that would otherwise have been decommissioned.

Research has shown that both operational and structural impacts can significantly change GHG emissions, such that capturing both is important in accurately assessing the ways in which increased loads can impact GHG emissions (e.g., see Gagnon and Cole 2022). This is especially true given the current state of the U.S. electric grid: operational impacts from increased loads are likely to predominantly come from increased dispatch of existing natural gas and coal power plants, whereas structural impacts from increased load appear most likely to cause increased deployment of both GHG emitting (e.g., natural gas) and non-emitting (e.g., wind and solar) resources as well as to defer the retirement of existing generators. The GHG emissions intensity of the two can be markedly different, so capturing both operational and structural effects is necessary for comprehensive lifecycle assessment. Moreover, these impacts are dependent on the amount, location, and temporal profile of the load.

Studies have demonstrated that induced GHG emissions differ substantially both geographically and over time, with the latter varying significantly not only from month-to-month and day-to-day, but also on an hourly basis within a day.

Notably, these operational and structural impacts apply to all electric loads and generators that are (or were) connected to the broader electricity grid, even when loads and generators are co-located. For example, if an existing low-GHG power plant (other than one discussed in Section 3.3) reduces its output to the grid to support a new on-site hydrogen production facility, it would generally be expected to cause induced GHG emissions as the grid responds to the loss of one of its supply resources by dispatching electricity from existing power plants or building or deferring the retirement of other power plants.

Pursuant to the statute, to receive a § 45V credit, a clean hydrogen producer must appropriately document the lifecycle GHG emissions that result from its process of producing hydrogen. To reflect relevant GHG emissions impacts, the method needs to take into account induced GHG emissions, considering operational and structural effects. The method also needs to recognize that hydrogen producers can contract with specific sources of electricity supply and that those contracts may be part of the basis for assessing the lifecycle GHG emissions from hydrogen production. The next section describes a reasonable and administrable approach to meeting these needs, focused on electricity purchases substantiated with EACs whose attributes meet certain criteria.

### 1. A Role for Energy Attribute Certificates in Section 45V

For § 45V purposes, it is necessary to establish a reasonable and administrable approach for hydrogen producers to document the lifecycle GHG emissions of their electricity use, considering both the specific electricity generation source (or sources) with which the hydrogen producer has a contractual relationship, as well as any broader grid-level changes in generation and capacity. This section outlines an approach by which hydrogen producers can document those GHG emissions by specifically contracting for low-GHG electricity generation through the purchase and retirement of EACs whose attributes meet certain criteria as relates to load.

The approach outlined below starts with the understanding that grid emissions are addressed when an incremental unit of low-GHG electricity generation is supplied to the grid at the same location and time as an incremental unit of load consumes power from the grid. Absent other secondary effects, the attributes of the incremental load and those of the incremental generation in this case would be matched one-for-one, yielding no significant net change to the pre-existing electrical grid, and so limiting induced GHG emissions impacts. In this instance, the lifecycle GHG impacts from the process of producing hydrogen can be assumed to be the lifecycle GHG emissions of the incremental low-GHG generation.

This section of the paper discusses a reasonable methodological proxy for quantifying lifecycle GHG emissions of electricity purchases by which electricity purchases substantiated through EACs whose attributes meet certain criteria could be used by a hydrogen producer to document such load and generation matching. This would in turn allow the hydrogen producer to reasonably claim that the lifecycle GHG emissions of their electricity use reflects only the lifecycle GHG emissions associated with the specific generators from which the EACs were purchased and retired.

### 1.1 EACs are a Sound Contractual Mechanism

EACs have a long history in the form of RECs and are a sound mechanism for establishing contractual claims of electricity purchases from specific sources (EPA 2018; Jones 2023; Sumner et al. 2023). Electricity cannot be physically tracked on the networked grid from specific source to specific load, so tracking of claims of physical electricity use is not feasible. Instead, EACs serve as a widely accepted legal instrument that represents the exclusive rights to make claims regarding the attributes of a unit of electricity generation, enabling contract-based purchases of electricity with specific attributes (Jones 2023; O'Shaughnessy and Sumner 2023).

EACs (at least in the form of RECs) are currently tracked through a network of nine electronic tracking systems, with national coverage (Terada 2023). EAC tracking systems create EACs as a function of generation output, enable EACs to change ownership, and ensure that EACs are removed from circulation or “retired” once an EAC buyer has claimed the energy attribute. Importantly, EAC tracking and retirement helps prevent double counting of energy attribute claims (Braslawsky et al. 2016). Though the specific design of these tracking systems varies, each offers similar basic functionality, and each can expand its functionality as dictated by market and policy interest. The most recent of these tracking systems was launched 7 years ago; the oldest systems have been in existence for more than 20 years.

EACs have been used for various purposes, including utilities demonstrating compliance with renewable portfolio or clean energy standards; programs to support existing nuclear power plants that are otherwise at risk of retirement; retail electricity customers buying the right to make claims regarding the use of clean energy; power source disclosure to end-use customers; and corporations reporting clean energy use for GHG accounting (Sotos 2015; O'Shaughnessy et al. 2021; O'Shaughnessy and Sumner 2023; Sumner et al. 2023; Barbose 2023). EACs are broadly recognized as valid legally and practically (FTC 2012; Jones 2023; Sumner et al. 2023). Though EACs are simply a mechanism for tracking contractually transferred property, policymakers and market actors regularly establish eligibility rules for specific use cases: sometimes constraining the temporal or geographic transferability of EACs or restricting eligibility to certain generation types and vintages (Sumner et al. 2023; Barbose 2023). EAC requirements created for any specific use case are dictated by the needs of policymakers or other market actors (Sumner et al. 2023).

2.1 Use of EACs to Inform the Lifecycle GHG Emissions from Adding Load to the Grid

EACs do not directly quantify induced emissions when adding load to the grid. However, EACs whose attributes meet certain criteria can serve as a reasonable proxy for calculating induced grid emissions, enabling entities seeking tax credits under § 45V a means to verify the purchase of specific sources of electricity while taking into account induced GHG emissions from the electricity grid. This use case is different from past and current use cases because implementation of § 45V requires lifecycle assessment in consideration of GHG emissions that result from the process of producing hydrogen via an administrable, consistent, and robust framework.

Given the impacts of adding load to the grid described earlier, purchasing an EAC from any low-GHG generator is not in and of itself sufficient to justify a claim of low lifecycle GHG emissions due to the presence of induced effects. Instead, as discussed earlier, an electricity buyer can limit induced grid emissions if each incremental unit of electricity load is matched with an incremental unit of generation at the same location and time. Applying this insight to § 45V, the GHG emissions from a hydrogen producer's electricity use may in this case be reasonably deemed to be the lifecycle GHG emissions of any incremental generation purchased by the hydrogen producer. Electricity purchases from specific sources, substantiated with EACs whose attributes meet certain criteria, could be used to document this load-generation alignment.

Taken together (ensuring load-generation alignment to address induced grid emissions and tracking electricity purchases from specific sources), such EACs can inform the assessment of the lifecycle GHG emissions impacts of hydrogen production suitable for § 45V. Moreover, EACs also provide an administrable tool that can be consistently applied at scale, as has been demonstrated in existing use cases.

For EACs to accomplish these goals, there are three critical EAC criteria:
1. Incremental generation: EACs must represent electricity generation produced from an incremental source or from a source under circumstances that will not lead to induced grid emissions (whether that comes from new power plants or, under certain circumstances, existing ones).
2. Geographic matching: The generation that created the EACs must have occurred in the same grid region as, or be physically deliverable to, the EAC buyer's load.
3. Temporal matching: The generation that created the EACs must have occurred at the same time as the EAC buyer's load.

Without the three specific criteria for EAC attributes, EAC purchases associated with new hydrogen load will not reflect important ways in which added loads can impact grid GHG emissions under a lifecycle framework. To elucidate this point, the next paragraphs explore counterfactual examples where one or more of the criteria are absent.

First, consider a situation where incremental generation is a required attribute, but either the geographic attribute or the temporal attribute of the EAC did not match the hydrogen load. In this scenario, an increase in electricity use would be matched in quantity by an equal increase in electricity supply-however, that increase in supply could occur at a different location or time than the EAC buyer's load. As discussed earlier, the induced grid GHG emissions impacts of load and generation vary substantially across space (e.g., due to transmission constraints) and time (e.g., due to generator dispatch). Therefore, in this situation, because the generation can occur at a different location and/or at a different time than the buyer's load, there is risk that the buyer's load would induce significant GHG emissions from other sources of generation. This demonstrates that the absence of either geographic or temporal matching between load and generation would not reflect important ways in which new loads can impact GHG emissions.

A tangible example would be a new hydrogen producer that produces on a 24×7 basis, but buys EACs only from new solar generators that, necessarily, produce electricity only during the daytime. During the nighttime hours of hydrogen production, the GHG emissions from generating the electricity used to supply the hydrogen producer are effectively the same as if the hydrogen producer had merely made grid purchases. Or consider an example of a hydrogen producer that purchases EACs that are temporally matched and come from incremental clean generation, but without a geographic match. If the hydrogen producer operates in a grid region that is heavily dependent on high-GHG emitting generators but the clean generation operates in an otherwise low-GHG emitting region, then the net effect would be an increase in overall GHG emissions as the emissions caused by the producer would not be fully counterbalanced by the emissions displaced by the clean generation.

Second, consider EACs that are geographically and temporally matched to the buyer's load but do not come from sources of incremental generation. In this case, EACs could be sourced from existing power plants that do not increase their output (e.g., an existing wind plant) to meet the needs of the hydrogen producer. In such a circumstance, the overall load on the system is increased due to the buyer's new load but that increase is not compensated by an increase in new supply from the generator selling the EACs-thus requiring other existing generators (e.g., GHG emitting dispatchable generators such as natural gas or coal) to supply the overall increase in load immediately and causing structural effects over time to accommodate the overall increase in load. These operational and structural responses would be expected to generally yield induced grid GHG emissions from the generators that ramped up and/or were added to the grid. This demonstrates that the absence of an incremental generation attribute would yield an inaccurate assessment of induced grid GHG emissions from the incremental hydrogen load.

The three EAC attribute criteria also generally apply in cases of co-located electricity generation and hydrogen production when there is (or was) a grid connection. Even if all the electricity used for hydrogen production comes from co-located generation, if the new hydrogen load is co-located with an existing electricity generator that was previously providing electricity to the grid and that is not otherwise at risk of retirement, the same induced grid GHG emissions impacts as described above occur.

Consider an example of a hydrogen producer that locates their production facility at the site of an existing low-GHG power plant that was not otherwise at risk of retirement. To the extent the power plant reduces its electricity supply to the grid below what it would have been without the new hydrogen load, the broader power system is required to respond to the loss of one of its supply resources by dispatching and/or building other power plants to meet the existing load on the system-likely increasing induced grid GHG emissions.

Only when all three criteria are met do EACs reflect generation whose attributes match the buyer's load, thereby capturing important operational and structural GHG emissions impacts. The three attribute criteria provide guiding principles for developing a practical and administrable EAC framework discussed in the following section.

### 2.2 Implementation of the EAC Attribute Criteria

When putting the above three criteria into practice, there are choices about how to implement each one. Practical considerations may necessitate a tailored transitionary period for some of the criteria. Potential practical and administrable approaches are discussed here. First, an implementable framework for incremental generation requires administrable definitions of “incremental.” In general, potential sources of incremental generation supply include:
EACs from new low-GHG power plants: A precise definition for “new” is required, but EACs from power plants that have commercial operation dates within some specified window relative to the hydrogen producer's placed in service date (or the date on which a producer begins producing hydrogen eligible for the § 45V credit) could reasonably be deemed to be “new.”
EACs from capacity uprates from existing low-GHG plants: Buyers could purchase EACs associated with the incremental generation from power plants that have newly increased their capacity.
EACs from existing high-GHG plants that retrofit to deliver low-GHG electricity: For example, an existing fossil-fuel power plant that has recently added carbon capture and storage. Such a plant could potentially also be considered incremental (and low-GHG, if its capture rate is sufficiently high), because it is a new source of lower-GHG generation.

In addition to the above situations, there are other specific circumstances in which reliance on existing low-GHG generation would not lead to significant induced grid emissions. It may be difficult to precisely identify and predict when these circumstances occur, given data constraints. However, if these circumstances can be reliably identified, then EACs representing those circumstances could also provide a workable framework to demonstrate qualification for § 45V:
EACs from existing low-GHG plants with extended lifetimes: If the purchase of EACs from ‘at risk’ existing generators has the effect of extending those plants' lifetimes by avoiding retirement, there would not be a net increase in induced grid emissions.
EACs from existing low-GHG plants during times when low-GHG electricity is being or otherwise would have been curtailed: These times tend to occur when wholesale electricity prices are negative and low-GHG plants are on the margin, so marginal grid emissions rates are low or zero.
EACs from increased production from existing low-GHG plants without capacity uprates: Buyers could purchase EACs associated with the incremental generation from power plants that have made new investments to increase electricity production, even in the absence of capacity uprates.
EACs from existing low-GHG plants in locations where additional load does not cause induced emissions: Such conditions could potentially include locations where grid electricity is 100% generated by zero-GHG generators or where state policies ensure that total GHG emissions are capped with sufficient effectiveness and stringency to require that new load is met with zero-GHG electricity.

This list demonstrates that, in principle, new and existing low-GHG plants can be considered to meet incrementality criteria in certain circumstances if other conditions are met. To be implemented within § 45V, however, all the cases above would require specific frameworks and verification standards. Frameworks and verification standards may be feasible and relatively straightforward in some of the cases. Administration, verification, and EAC tracking for others, however, may be especially challenging or even impossible.

Absent simplified proxies, administration may require predictions of future retirement risk, counterfactual ‘what if’ assumptions, or complex geographically and temporally granular modeling and data of operational and structural effects. Further deliberation-including stakeholder feedback—is required to identify and develop administrable and effective verification procedures or appropriate potential proxy approaches for those cases.

Additionally, while some of the existing nine tracking systems capture all generators in their regions, other tracking systems currently only track renewable electricity.¹⁶ In the latter cases, tracking systems would need to expand their functionality to capture a broader suite of generators that might sell eligible EACs to clean hydrogen producers. Thus, while some practical approaches to demonstrate that incrementality criteria have been met may be readily available today, others will need to be further developed and refined over time.

Second, an implementable framework for geographic matching between load and generation requires establishing certain geographic boundaries (Millet et al. 2023). Under many renewable portfolio or clean energy standards, geographic boundaries are often established to define EAC eligibility, such as states, independent system operator regions, or collections of states. In many cases, not only are generators that are located within the defined geographic boundary allowed to sell eligible EACs but so too are generators located outside the boundary if the electricity from such generators is transmitted, scheduled, dispatched, and financially settled in the receiving market.¹⁷ Alternatively, or in addition, knowledge of transmission limitations between regions could help define geographic matching requirements (DOE 2023c).

Third, to implement temporal matching, EACs can be tagged with the time they were generated and issued and thereafter matched with load. Until relatively recently, EAC use cases have mostly required annual matching.

However, more granular, and therefore more accurate, timeframes are likely to be available nationally over time, and hourly matching of EACs will provide significantly greater certainty about lifecycle GHG emissions outcomes by ensuring that there is actual alignment between load and generation. As described earlier, an annual matching standard means that changes in supply on a month-to-month, day-to-day, and hourly basis during the year are not necessarily matched with load over those same timeframes. That unmatched load can drive induced GHG emissions because of the significant temporal variation in grid-system GHG emissions on a monthly, daily, and even hourly basis. Given hourly changes in grid GHG emissions, an hourly energy-matching standard provides much stronger assurance that changes in load are matched by changes in supply.

Hourly tracking systems for EACs are not yet broadly available across the country and, while they are in effect or under development in some regions, widespread availability and functionality will take time. The federal government is helping advance hourly matching capabilities through a 2021 Executive Order requiring federal agencies to procure hourly-matched clean energy (Exec. Order 14057; Hausman and Bird 2023). Moreover, to ensure reliable electric grid operations, power grid operators across the country already track the real-time production of all electric generators connected to the transmission system. Nonetheless, data, software, regulatory structures, and market practices will need to evolve to enable hourly matching at scale (EPRI 2022). Two of the largest EAC tracking systems, Midwest Renewable Energy Tracking System, Inc. (M-RETS) and the PJM Generation Attribute Tracking System (PJM-GATS), have recently begun offering EACs with hourly data to generators that register in the system and provide the necessary data exchange-albeit even in these cases, the systems have limited functionality (Terada 2023). The North American Registry (NAR) is also piloting hourly EACs. Fully developing the functionality of these systems will take time, as will the creation of and developing the functionality of hourly tracking infrastructure in other regions of the country. In a recent survey of nine existing EAC tracking systems, apart from the two systems mentioned above that have already initiated hourly tracking, albeit with limited functionality, two declined to give a timeline to develop this functionality, four systems gave a timeline of two years or less, and one system gave a timeline of three to five years; in the latter case, the respondent noted that the timeline could be closer to three years if there is full state agency buy-in, clear instructions are received from federal or state agencies, and funding for stakeholder participation is made available. In the same survey, tracking systems identified a number of challenges to hourly tracking that will need to be overcome, including cost, regulatory approval, interactions with state policy, sufficient stakeholder engagement, data availability and management, and user confusion (Terada 2023). Once the tracking software infrastructure is in place nationally, it may take additional time for transactional structures and efficient hourly EAC markets to develop. Among the issues that require resolution as EAC tracking systems move to hourly resolution is the treatment of electricity storage. Given the current lack of highly functional hourly tracking capabilities across the entire U.S., different requirements may be required in the near term.

### 4. Conclusion

As shown in this paper, assessing lifecycle GHG emissions from the electricity grid associated with increased electricity load requires consideration of induced GHG emissions from operational and structural effects. More specifically, for the purpose of implementing the clean hydrogen production tax credit under § 45V, this paper finds that:
EACs are a sound mechanism to establish contractual claims of electricity purchases from specific sources, but EACs from low-GHG generators must have attributes that meet certain criteria to address the impacts of a hydrogen producer's electricity load on induced grid GHG emissions.
The three necessary EAC attribute criteria are: incremental generation, geographic matching, and granular temporal matching. These attribute criteria are necessary to address the impacts of a hydrogen producer's load on grid GHG emissions regardless of whether the hydrogen producer is purchasing electricity from power plant(s) located at some distance from the hydrogen producer or is instead using electricity from a co-located, behind-the-meter power plant that is (or was previously) connected to the broader electricity grid.
If a hydrogen producer's load is matched with EACs whose attributes meet these three criteria, lifecycle GHG emissions from the hydrogen producer's electricity use can be reasonably deemed to reflect the lifecycle GHG emissions associated with the specific generators from which the EACs were purchased and retired.²⁰
If hydrogen producers rely on EACs whose attributes do not meet these three criteria, and have not otherwise adequately demonstrated low induced emissions, there is a strong likelihood that the hydrogen production would in many cases significantly increase induced grid GHG emissions beyond the allowable levels required to qualify for § 45V.²¹.

An administrable and practical approach to applying these three attribute criteria is feasible. However, time may be required to allow development of the necessary EAC tracking infrastructure and verification protocols.

### 5. References

Barbose, G. 2023. U.S. State Renewables Portfolio & Clean Electricity Standards: 2023 Status Update. Berkeley, CA: Lawrence Berkeley National Laboratory.
Braslawsky, J., T. Jones and M. Sotos. 2016. Making Credible Renewable Electricity Usage Claims. RE100. CEBI. 2022. Guide to Sourcing: Marginal Emissions Factor Data. Washington, DC: Clean Energy Buyers Institute.
CPUC. 2021. 2021 Distributed Energy Resources Avoided Cost Calculator Documentation. Prepared for the California Public Utilities Commission.
de Chalendar, J. A., J. Taggart and S. M. Benson. 2019. “Tracking emissions in the US electricity system.”
Proceedings of the National Academy of Sciences, 116 (51): 25497-25502.
DOE. 2023a. Pathways to Commercial Liftoff: Clean Hydrogen. Washington, DC: U.S. Department of Energy.
DOE. 2023b. U.S. National Clean Hydrogen Strategy and Roadmap. Washington, DC: U.S. Department of Energy.
DOE. 2023c. National Transmission Needs Study. Washington, DC: U.S. Department of Energy Ekvall, T. 2019. “Attributional and Consequential Life Cycle Assessment.” In Sustainability Assessment at the 21st Century. IntechOpen.
EPA. 2018. Guide to Purchasing Green Power. Washington, DC: U.S. Environmental Protection Agency.
EPRI. 2022. 24/7 Carbon-Free Energy: Matching Carbon-Free Energy Procurement to Hourly Electric Load. Palo Alto, California: Electric Power Research Institute.
Exec. Order No. 14057 Catalyzing Clean Energy Industries and Jobs Through Federal Sustainability, 86 Fed. Reg. 236 (Dec. 13, 2021).
FTC. 2012. Guides for the Use of Environmental Marketing Claims. Federal Trade Commission. Washington, D.C.: Federal Trade Commission.
Gagnon, P. and W. Cole. 2022. “Planning for the evolution of the electric grid with a long-run marginal emission rate.” iScience 25 (3): 103915.
Gagnon, P, B. Cowiestoll and M. Schwarz. 2023. Cambium 2022 Scenario Descriptions and Documentation. Golden, CO: National Renewable Energy Laboratory.
Hausman, N. and L. Bird. 2023. The State of 24/7 Carbon-free Energy: Recent Progress and What to Watch. Washington, DC: World Resources Institute.
Holland, S. P., M. J. Kotchen, E. T. Mansur and A. J. Yates. 2022. “Why marginal CO₂ emissions are not decreasing for US electricity: Estimates and implications for climate policy.” Proceedings of the National Academy of Sciences 119 (8): e2116632119.
Jones, T. 2023. The Legal Basis for Renewable Energy Certiicates. Version 2.0. San Francisco, CA: Center for Resource Solutions.
Khan, I., M. W. Jack and J. Stephenson. 2018. “Analysis of greenhouse gas emissions in electricity systems using time-varying carbon intensity.” Journal of Cleaner Production, 184:1091-1101.
Miller, G. J., K. Novan and A. Jenn. 2022. “Hourly accounting of carbon emissions from electricity consumption.” Environmental Research Letters, 17 (4): 044073.
Miller, G., G. Pease, W. Shi, L. Lam, K. Spees, J. Grove and I Yang. 2023. Where matters: Integrating deliverability into voluntary clean energy market boundaries. Prepared by Singularity Energy and The Brattle Group, for Google LLC.
NESP. 2020. National Standard Practice Manual For Beneit-Cost Analysis of Distributed Energy Resources. National Energy Screening Project.
O'Shaughnessy, E., J. Heeter, C. Shah and S. Koebrich. 2021. “Corporate acceleration of the renewable energy transition and implications for electric grids.” Renewable and Sustainable Energy Reviews 146:111160.
O'Shaughnessy, E. and J. Sumner. 2023. “The need for better insights into voluntary renewable energy markets.”
Frontiers in Sustainable Energy Policy 2: 1174427.
Palmer, K., B. Prest, S. Iler and S. Villanueva. 2022. Options for EIA to Publish CO₂ Emissions Rates for Electricity. Resources for the Future.
Sotos, M. 2015. GHG Protocol Scope 2 Guidance: An Amendment to the GHG Protocol Corporate Standard. World Resources Institute.
Stoll, P., N. Brandt and L. Nordstrom. 2014. “Including dynamic CO₂ intensity with demand response.” Energy Policy, 65:490-500.
Sumner, J., E. O'Shaughnessy, S. Jena and J. Carey. 2023. Status and Trends in the U.S. Voluntary Green Power Market (2021 Data). Golden, CO: National Renewable Energy Laboratory.
Synapse Energy Economics. 2021. Avoided Energy Supply Components in New England: 2021 Report.
Cambridge, MA: Prepared for the AESC 2021 Study Group.
Terada, R. 2023. Readiness for Hourly: U.S. Renewable Energy Tracking Systems. San Francisco, CA: Center for Resource Solutions.
WRI. 2007. Guidelines for Quantifying GHG Reductions from Grid-Connected Electricity Projects. World Resources Institute.

1. A system for producing hydrogen using electrolysis, comprising:
a. an electrolysis unit configured to receive electricity from a power grid;
a data processing unit configured to determine a time correlation (T_{diff}) wherein T_{diff} is the difference in time between when renewable power is produced and when renewable power is used to generate hydrogen.
b. a control unit configured to determine the amount of hydrogen to be generated by the electrolysis unit, based on the calculation of at least T_{diff}.
i. wherein T_{diff} is equal to or less than one hour, equal to or less than one day, equal to or less than one week, equal to or less than one month, equal to or less than one quarter, or equal to or less than one year.
c. A renewable power project that produces electricity

2. The system of claim 1, wherein the renewable power project is in the same region as the electrolysis unit.

3. The system of claim 1, wherein the difference in the commercial operations date of the renewable power project and the commercial operations date of the electrolysis unit is equal to or less than three years.

4. The system of claim 1, wherein the control unit determines the amount of hydrogen to be generated by the electrolysis unit based on T_{diff} and one or more of: the availability of electricity, the price of electricity, the location of electricity generation, the type of electricity generation, and the carbon footprint of electricity.

5. The system of claim 1, wherein the control unit adjusts the operation of the electrolysis unit to produce hydrogen during periods of excess renewable electricity supply.

6. The system of claim 1, wherein the control unit adjusts the operation of the electrolysis unit to maximize available incentives.

7. The system of claim 6, wherein the incentives come from one of the programs: US IRA hydrogen PTC, the UK RTFO, or the EU RFNBO or its successors and programs in other jurisdictions defining green hydrogen production with similar metrics.

8. The system of claim 1, wherein eFuels are produced from the hydrogen.

9. The system of claim 1, wherein the hydrogen is used in transportation, power, chemicals, power generation, plastics, or decarbonization.

10. The system of claim 1, wherein the control unit maximizes profit by calculating the net electricity cost as a function of T_{diff}, incentives, and the price of electricity.

11. The system of claim 1, further comprising an electricity storage unit configured to store purchased or generated electricity.

12. The system of claim 1, wherein the control unit over-contracts, or suggests over-contracting renewable power purchases based on net electricity cost thresholds.

13. A system for producing hydrogen using electrolysis, comprising:
a. an electrolysis unit configured to receive electricity from a power grid;
a data processing unit configured to determine a time correlation (T_{diff}) wherein T_{diff} is the difference in time between when renewable power is produced and when renewable power is used to generate hydrogen.
a. a control unit configured to select or suggest the electricity to be supplied to the electrolysis unit, based on the calculation of at least T_{diff}.
b. wherein T_{diff} is equal to or less than one hour, equal to or less than one day, equal to or less than one week, equal to or less than one month, equal to or less than one quarter, or equal to or less than one year.
c. A renewable power project that produces electricity

14. The system of claim 13, wherein the renewable power project is in the same region as the electrolysis unit.

15. The system of claim 13, wherein the difference in the commercial operations date of the renewable power project and the commercial operations date of the electrolysis unit is equal to or less than three years.

16. The system of claim 13, wherein the control unit selects the renewable power based on T_{diff} and one or more of: the availability of electricity, the price of electricity, the location of electricity generation, the type of electricity generation, and the carbon footprint of electricity.

17. The system of claim 13, wherein the control unit adjusts the operation of the electrolysis unit to produce hydrogen during periods of excess renewable electricity supply:

18. The system of claim 13, wherein the control unit selects the renewable power used by the electrolysis unit in order to maximize incentives.

19. The system of claim 18, wherein the incentives come from one of the programs: US IRA hydrogen PTC, the UK RTFO, or the EU RFNBO or its successors and programs in other jurisdictions defining green hydrogen production with similar metrics.

20. The system of claim 13, wherein eFuels are produced from the hydrogen.

21. The system of claim 13, wherein the hydrogen is used in transportation, power, chemicals, power generation, plastics, or decarbonization.

22. The system of claim 13, wherein the control unit maximizes profit by calculating the net electricity cost as a function of T_{diff} incentives and the price of electricity.

23. The system of claim 13, further comprising an electricity storage unit configured to store the purchased or generated electricity.

24. The system of claim 13, wherein the control unit over-contracts or suggests over-contracting renewable power purchases based on net electricity cost thresholds.

25. A system for producing time-correlated clean hydrogen, comprising:
an electrolysis unit, wherein the electrolysis unit is a Proton Exchange Membrane electrolysis unit, an Alkaline electrolysis unit, a Solid Oxide Electrolysis Cell unit or an Anion Exchange Membrane unit;
wherein the electrolysis unit is connected to a power grid or to a renewable energy generation unit or a battery storage unit that provides electricity to the electrolysis unit, wherein the power grid is a microgrid, a wide area synchronous grid or a super grid and the unit for renewable energy generation is a wind power generation unit, a solar power generation unit, a hydropower generation unit, a geothermal generation unit or a biomass power generation unit;
and wherein the electrolysis unit is further connected to a hydrogen conversion unit, wherein the hydrogen conversion unit produces diesel, SAF, naphtha, LPG, methanol, other hydrocarbon based chemicals, or ammonia.
and wherein there is a data processing unit that is connected to a control unit, and wherein the data processing unit operates the electrolyzer when T_{diff} is equal to or less than one year,
thereby providing a system for utilizing time-correlated renewable power.
